(19) United States
(12) Patent Application Publication
(10) Pub. No.: US 2013/0198693 A1
(43) Pub. Date: Aug. 1, 2013

(54) THREE-DIMENSIONAL ANIMATION TECHNOLOGY FOR DESCRIBING AND MANIPULATING PLANT GROWTH

(71) Applicants: Dow AgroSciences LLC, Indianapolis, IN (US); Seyet LLC, West Lafayette, IN (US)

(72) Inventors: Philip Jost, Carmel, IN (US); Stephen L. Gooding, West Lafayette, IN (US); Jon Kevan, Honolulu, HI (US); Rayda Krell, Ridgefield, CT (US)

(73) Assignees: Seyet LLC, West Lafayette, IN (US); Dow AgroSciences LLC, Indianapolis, IN (US)

(21) Appl. No.: 13/691,072

(22) Filed: Nov. 30, 2012

Related U.S. Application Data
(60) Provisional application No. 61/565,269, filed on Nov. 30, 2011.

(51) Int. Cl. G06F 3/0481

(52) U.S. Cl. CPC G06F 3/04815
USPC 715/848

(57) ABSTRACT

This disclosure concerns systems and methods for the prediction and physical three-dimensional representation of plant growth and development. In some embodiments, systems and/or methods of the disclosure may be used to represent the growth of a particular plant (e.g., a maize cultivar) under particular environmental conditions, and/or to represent the differences in growth characteristics between a particular plant and another plant.

### CROSS-REFERENCE TO RELATED APPLICATION

This application claims the benefit of U.S. Provisional Patent Application Ser. No. 61/565,269, filed Nov. 30, 2011, the disclosure of which is hereby incorporated herein in its entirety by this reference.

### FIELD OF THE DISCLOSURE

The present disclosure relates to plant growth and development. In particular, the disclosure relates to a three-dimensional representation of model plant growth and development, for example, over time.

### BACKGROUND

Typical learning about plant growth and development occurs only during the growing season or through the use of static media. However, when a grower or researcher is considering whether a particular plant or cultivar is suitable for an intended purpose, that person must extrapolate the performance of the plant or cultivar to the particular conditions under which it is to be grown according to that purpose. Different plants or cultivars may perform differently, for example, in different growing environments (e.g., having more or less light, water, and/or heat) or in the presence of pests.

Crop models may be used to predict crop development and yield under alternative scenarios. Such models may also be used to predict the specifics of crop growth and development for a particular growing season on the basis of inputs describing the season using relevant variables to growth and development of the plant. The use of models in such an approach may be used to anticipate unfavorable crop growth. See, e.g., Fraisse et al. (2001) Appl. Eng. Agric. 17(4):547-56.

In recent years, farmers and researchers have become interested in precision agriculture (or site-specific management) as a crop management system, which has resulted in the collection of geospatial data for crop plant performance. Although the collection of some geospatial data has become relatively easy, it is a difficult and unsolved problem to know how to most effectively use that data in making crop management decisions. Sudduth et al. (1998) “Integrating spatial data collection, modeling and analysis for precision agriculture,” In Proc. 1st Int. Cons on Geospatial Information in Agriculture and Forestry, Vol. II, Ann Arbor, Mich.: ERIM International, pp. 166-73. For example, although several researchers have used statistical analysis to attempt to relate crop yield to spatial factors. (See, e.g., Mallarino (1996) Agron. J. 88(3):377-81), crop plant growth is a function not only of spatial factors, but also of temporal variability; Mulla and Schepers (1997) “Key processes and properties for site-specific soil and crop management,” In The State of Site-Specific Management for Agriculture, Madison, Wis.: American Society of Agronomy.)

The art lacks a convenient method of representing the growth and/or development of particular plants under diverse conditions, such as different growing environments or in the presence of different geospatial and temporal factors. Also lacking is a convenient non-static tool for representing the growth characteristics of different plants (e.g., different varieties of the same species), for example, under particular growing environments. For example, previous corn growth models have lacked the capacity to simulate all components of plant growth.

### BRIEF SUMMARY OF THE DISCLOSURE

Described herein are systems and methods for utilizing field data to generate a three-dimensional representation of plant growth that may represent the growth and/or development characteristics of a particular plant species, cultivar, or variety, for example, over time. Thus, methods as described herein may be used to “grow” an anatomically correct, virtual, three-dimensional plant that represents the plant's expected growth and development under particular growing conditions. Systems and methods according to some embodiments may be utilized as a learning tool to enable better understanding of crop growth and development, for example, by comparing the performance of a particular plant under different actual growing conditions without actual planting and observation over an entire growing season. Systems and methods according to some embodiments may be useful in marketing plants and plant products as a method to demonstrate the activity of new traits and biotechnology, crop characteristics, application timings, and chemical (e.g., pesticide) use restrictions.

In some embodiments, a system for representing plant growth may comprise a database comprising at least one growth parameter determined for a plant of interest; a computer readable storage medium comprising the database; analytical programming for predicting plant growth; analytical programming for graphically representing the growth of the plant of interest in three-dimensions and over time; and an interactive user interface that displays the three-dimensional graphical representation of the growth of the plant of interest over time.

A method for utilizing such a system in some embodiments may comprise steps including, for example and without limitation, obtaining a value for the at least one growth parameter from the plant of interest (e.g., by collecting data from the plant of interest, or by converting data from the plant of interest into a format that is compatible with the analytical programming); inputting the value into the database; and generating a three-dimensional graphical representation of the growth of the plant of interest over time.

In some embodiments, a system for representing plant growth may comprise a database comprising at least one growth parameter determined for a plant of interest; a computer readable storage medium comprising the database; means for predicting plant growth; analytical programming for graphically representing the growth of the plant of interest in three-dimensions and over time; and an interactive user interface that displays the three-dimensional graphical representation of the growth of the plant of interest over time. Means for predicting plant growth include analytical programming for predicting plant growth (e.g., maize plant growth). Examples of means for predicting plant growth include the analytical programming described in Example 1.

Also described herein are methods of increasing consumer interest in a plant or plant product. In some embodiments, the method may comprise steps including, for example and without limitation, providing a system for representing plant growth; generating a three-dimensional graphical representation of the growth of a plant of interest over time; and utilizing the three-dimensional graphical representation to describe at least one favorable growth characteristic of the plant of interest to a consumer. In particular embodiments, a method according to the foregoing may thereby increase consumer interest in the plant of interest or a plant product produced from the plant of interest.

Additional embodiments relate to systems for representing the growth of a plant of interest comprising one or more growth-related traits of interest in a season-independent manner. In some embodiments, the system may comprise, for example and without limitation, a database comprising at least one growth parameter corresponding to the effect of each of the one or more growth-related traits on the growth of the plant; a computer readable storage medium comprising the database; analytical programming for predicting plant growth; analytical programming for graphically representing the growth of the plant of interest in three-dimensions and over time; and an interactive user interface that displays the three-dimensional graphical representation of the growth of the plant of interest over time, wherein inputting a value into the database for the at least one growth parameter allows the generation of a three-dimensional graphical representation of the predicted growth of the plant of interest over time in a season-independent manner.

In particular embodiments, a method for utilizing a system according to the invention may comprise steps including, for example and without limitation: obtaining at least one parameter reflecting an effect of an environmental factor on growth of a plant of interest; inputting at least one additional parameter reflecting an effect of an environmental factor on growth of a plant of interest into a database; and generating a three-dimensional graphical representation of the predicted growth of a plant of interest over time in the presence of an environmental factor. An environmental factor that has an effect on growth of a plant of interest may be, for example and without limitation, selected from a group comprising an herbicide, a pesticide, weed infiltration, heat, cold, drought, excessive water, low light, high salt, and low salt.

Thus, particular embodiments may relate to at least one plant of interest (or a plant product obtained from a plant of interest). A plant of interest may be an inbred plant variety of, for example and without limitation, any crop species (e.g., Zea mays). A plant of interest may be a genetically-modified plant. A plant of interest may comprise at least one plant growth-related trait of interest. In certain examples, a plant growth-related trait of interest is a trait of agricultural importance (e.g., a trait selected from a group comprising: herbicide tolerance; pesticide tolerance; weed tolerance; heat tolerance; cold tolerance; drought tolerance; excessive water tolerance; low light tolerance; high salt tolerance; and low salt tolerance).

Some embodiments may comprise more than one plant of interest, for example and without limitation, each plant can comprise an allelic variant of a plant growth-related trait of interest. In some of these embodiments, a system for representing the growth of a plant of interest may comprise a database including at least one growth parameter from a first and a second plant of interest; analytical programming for generating a three-dimensional graphical representation of the growth of a first and a second plant of interest over time; and a user interface that allows comparison of representations of the growth of the first and the second plant of interest. In particular embodiments, a system and/or method according to the invention may be used to compare representations of the growth of more than one plant of interest, for example and without limitation, by determining the effect of a plant growth-related trait of interest on the growth of the plants of interest (e.g., in the presence of a particular environmental factor).

The foregoing and other features will become more apparent from the following detailed description of several embodiments, which proceeds with reference to the accompanying figures.

### BRIEF DESCRIPTION OF THE FIGURES

FIG. 1 includes a photograph showing a corn plant at three stages of development.

FIGS. 2(a-b) include a chart showing the relationship between maize growth stages in an exemplary representation of maize plant growth. In the figure: “O” indicates formation; “X” indicates removal; “O-n” indicates that the leaf is emerging, but not fully grown; and “S2” indicates the beginning of a period of great elongation.

FIG. 3 includes animations representing different components of a growing maize plant predicted by exemplary analytical programming.

FIGS. 4(a-i) include exemplary analytical programming for predicting maize plant growth.

FIGS. 5(a-k) include screen shots showing a three-dimensional representation of maize plant growth, taken during the execution of exemplary predictive analytical programming program. Once executed, the exemplary programming produces a succession of such images that represent the growth and development of the corn plant over time. In this example, the program produces and displays a plurality of images for each growth day, thereby giving the viewer a more “lifelike” representation. FIGS. 5a-5e include screen shots of the representation during vegetative stages of growth. FIG. 5f includes a screen shot of the representation during growth stage VT. FIG. 5g includes a screen shot of the representation during growth stage R1. FIG. 5h includes a screen shot of the representation during growth stage R2. FIG. 5i includes a screen shot of the representation during growth stage R3. FIG. 5j includes a screen shot of the representation during growth stage R4. FIG. 5k includes a screen shot of the representation during growth stage R6.

FIG. 6 includes a pair of representations produced during separate executions of an exemplary predictive analytical programming program. In this example, a bar on the left side of a first observation window allows the viewer to focus on different close-up images of the growing plant. In the top representation, the focus is on the bottom of the growing plant. In the bottom representation, the focus is on the apex of the growing plant.

FIG. 7 includes a pair of representations produced during separate executions of an exemplary predictive analytical programming program. In this example, a bar located at the bottom of a second observation window allows the viewer to view images of the growing plant at different observation distances. In the top representation, the bar has been manipulated to “zoom out” to view an image of the growing plant at a distance. In the bottom representation, the bar has been manipulated to “zoom in” to view a close-up image of the growing plant.

FIG. 8 includes the “GUI Process;” a flow chart created to help define how the backend code (i.e., the analytical programming) is structured and how its elements are related. In particular examples, this flow chart acts as a guide for the construction of the code and how its elements are interconnected during development. The GUI Process provides a detailed example of one interface that may be presented to a user, and how the backend code will respond to user input. For example, this flow chart comprises a node (“Start Application WINDOW”) that defines the starting point of the program. Following the start, the backend code in this example checks to see if the user has run the program before. If the user has not run the program, then they are designated in this example as a “New User.” In this example, the “New User” is presented via the interface with an “Introduction WINDOW,” followed by a “Tutorial Window.” If the user has run the program, then they are designated in this example as a “Previous User.” In this example, if there is a “Previous User,” then the code goes directly to the “Course Navigation WINDOW,” where the user has several options presented via the interface for navigation. For example, here the user can choose to “Show Tutorial,” “Show Introduction,” navigate to the “Learn” section, or navigate to the “Explore” section.

FIG. 9 includes a graphical “mind map” that illustrates how the content of a user interface in particular examples may be structured and arranged for user navigation.

FIGS. 10(a-h) include representations of the user interface from an exemplary embodiment related to educating a user about corn plant development and growth. Included are an introductory step (FIG. 10a); a course navigation step (FIG. 10b); an option step where the user may select between several development and/or growth processes (FIG. 10c); an option step where the user may select between several different plant structures (FIG. 10d); a series of steps that explain root growth and development (FIG. 10e-g); and a step that explains the leaf vegetative structure (FIG. 10h).

### DETAILED DESCRIPTION

### I. Overview of Several Embodiments

Embodiments of the invention satisfy an emerging need for a tool that will allow those in the art to understand and describe the growth and development of the many and increasing number of plants and cultivars (e.g., genetically-engineered plant varieties) that are currently available for use, and also to describe activity of new traits and biotechnology to others. Thus, some embodiments may be useful as a training, learning, or marketing tool to assist in the development of particular plant resources. Some examples allow a three-dimensional representation of plant growth and development at any time of the year, and/or under any environmental conditions, through an interactive interface. Some examples serve as a universal platform to describe the activity and features of new traits and biotechnology, crop characteristics, application timings, and chemical use restrictions.

### II. Abbreviations

CERES Crop Environment Resource Synthesis

GDD growing degree days

GDU growing degree units

### III. Terms

Corn Belt: As used herein, the term “corn belt,” refers to a geographical region wherein more than half of the corn produced in the United States is grown. This region includes Iowa, Illinois, Indiana, Michigan, eastern Nebraska, eastern Kansas, southern Minnesota, parts of Missouri, and parts of South Dakota, North Dakota, Ohio, Wisconsin, Michigan, and Kentucky. Soil in the corn belt is deep, fertile, and high in organic matter.

Growing season: As used herein, a “growing season” refers to a period of the year when seasonal weather is favorable for growth. The “growing season” may be defined as the number of freeze-free days during the year, beginning with the last freezing temperature in the spring and ending with the first occurrence of freezing temperatures in the autumn.

The average spring planting date for maize within the corn belt may be closely related to the average date of the last spring freeze at the particular growing location. Adapted full-season hybrids at any location should be cropped so as to reach maturity under normal seasonal weather conditions by the average first autumn freeze. In portions of the corn belt, proper full-season hybrids are typically adapted to reach maturity during the period of the average frost-free season. For the most southern areas of the corn belt and beyond, full-season hybrids may be adapted to reach maturity in, for example, about five months. In such areas, the frost-free season may be much longer than the corn crop growing season. Therefore in such areas, the length and timing of the corn crop growing season is not determined by the length and timing of the frost-free season.

Phytomer: As used herein, the term “phytomer” refers to a plant structure including the node, plus the leaf, internode, and bud developing from it.

Plant: As used herein, the term “plant” may refer to an individual plant of a particular species or cultivar. Such an individual plant may be a real plant, as grown in a field or under controlled conditions, or a hypothetical plant grown under simulated conditions (e.g., conditions simulated to reflect actual field conditions).

Trait: As used herein, the term “trait” refers to a measurable characteristic of an individual. Certain traits may be useful in grouping or typing several individuals into a single cohort. The terms “trait” and “phenotype” are used interchangeably herein. Of particular interest in some embodiments of the invention are traits relating to plant growth, development, and/or morphology.

### IV. Three-Dimensional Representation of Plant Growth Over Time

In some embodiments, a method according to the invention may include the acquisition of relevant environmental data for plant growth and/or development, and may further include the use of such data to generate a three-dimensional representation of the growth and/or development of a specific plant (e.g., Z. mays), plant variety (e.g., a genetically-engineered plant variety), or cultivar under conditions defined by the data. Relevant data may be used to generate a three-dimensional representation by steps including input of the data into a database comprised within a computer readable storage medium, and operating on the data utilizing analytical programming for predicting plant growth. In particular embodiments, relevant data for plant growth and/or development may include, for example and without limitation, a growth parameter from a plant of interest (e.g., a plant-specific constant or variable in a function that, at least in part, describes the growth of the actual plant or part thereof); and an environmental parameter (e.g., a constant or variable in a function that, at least in part, describes the effect of an environmental factor on the growth of an actual plant or part thereof).

In some embodiments, a representation of plant growth and/or development is generated that refers to known stages of plant growth and/or development. For example, a representation may describe or display features of the represented plant as it enters defined stages of its growth. In particular embodiments, acquired relevant data may be used to generate multiple representations of the growth and/or development of several plants, for example, in order to visually represent differences between the agronomic performance of the several plants.

Stages in Plant Growth

Plant development includes a broad spectrum of processes, including for example and without limitation: formation of a complete embryo from a zygote; seed germination; elaboration of a mature vegetative plant; formation of reproductive organs; and responses to the plant's environment. Plant development encompasses the growth and differentiation of cells, tissues, organs, and organ systems, which microscopic processes are expressed in total as the changing morphology of the plant. The growth stages of a particular plant may vary in precise definition in comparison to other plants, but the growth stages of all plants generally include a vegetative, a reproductive, a senescence, and (in some examples) a dormancy stage.

In the vegetative stage of generalized plant growth, a multicellular embryo is first formed from a single-celled zygote (embryogenesis). Then, the plant seedling absorbs moisture and nutrients from inside its seed. When the plant has absorbed the seed foods and starts growing the root stem and shoot, it penetrates the seed's protective wall and begins apical growth. The root grows downwards, while the shoot grows upwards to access light and air. Upon emergence, leaves unfold and the roots continue to grow and elaborate. These processes continue until the plant seedling is fully developed, at which time it may be characterized by extensive roots, root hairs, and leaves.

Embryogenesis comprises four developmental processes. The first developmental process is the expression of apical-basal polarity in the zygote (i.e., the apical and basal ends of the zygote cell develop structural and biochemical differences). When the zygote divides, it typically divides asymmetrically, which results in a small apical cell and a large basal cell. The apical cell becomes the embryo, while the basal cell becomes a short-lived structure called a suspensor and the tip of the root system. The progeny of the apical cell grow and divide to form a spherical mass of cells, the globular-stage embryo. The second developmental process is differential growth within the globular embryo that gives rise to the “heart” stage embryo (i.e., organogenesis), wherein the progenitors of cotyledons, root, and stem may be recognized. The third developmental process is histogenesis, the process by which planes of cell divisions of cells within embryonic cotyledons, root, and stem lead these cells to acquire different shapes and form the precursors of different plant tissues. The fourth developmental process is the formation of apical meristems of the shoot and root systems at the apical and basal ends of the embryo.

After embryogenesis, the embryo desiccates and enters a period of dormancy, wherein further development is arrested. Embryo development resumes upon seed germination. If appropriate environmental cues are provided (e.g., light, water, and temperature), the desiccated seed will absorb water, and the embryo will resume growth. Some plants have specific requirements for germination. For example, temperate tree species may require several weeks of temperatures of 4° C. (or less) in order to germinate. Other species may require low light levels for germination. However typically, once germination is initiated, the embryo follows a single general pattern of development. For example, generally, the preformed embryonic root elongates first, forcing its way out of the seed coat and into the basal medium (e.g., soil). The embryonic stem (hypocotyl; usually found below the attachment of the cotyledons) subsequently elongates. Once the elongating hypocotyl has displaced the cotyledons to contact light, the cotyledons expand to provide a broad surface for photosynthesis.

Environmental factors are important for seedling development. For instance, germination in the dark generally results in developmental events that help the seedling push its way through the basal medium to contact light. The hypocotyl elongates quickly and maintains a “hook” near its tip that protects the cotyledons and shoot apical meristem region. Cotyledon expansion is suppressed so that they are not damaged as they are pulled through the soil. In contrast, if germination occurs in the light, the hypocotyl may hardly elongate may not form a hook, and the cotyledons may quickly expand.

After the enlargement of the root, hypocotyl, and cotyledons that is characteristic of embryonic development is completed, postembryonic development occurs. Postembryonic development occurs primarily in the apical meristems. The shoot apical meristem is the source of all the leaves and stems that will be formed during the development of the plant. The meristem itself is composed of a small population of cells (i.e., meristematic cells) that may perpetually grow and divide without ever maturing themselves. In this way, there is always a source of new cells at the tip of the shoot. The root tip contains a similar population of meristematic cells that gives rise to all root tissues. Both of these meristems are characterized by an indeterminate growth pattern that is influenced by environmental variables and a genetic component that may be unique to a particular plant variety. Such an indeterminate growth pattern is not finite, and may continue for a period that contributes to defining the development of the plant. The growth rate of plants is extremely variable; some mosses grow less than 0.001 millimeters per hour, while most trees grow at a rate of between 0.025 and 0.250 millimeters per hour. Some climbing species, such as kudzu, which do not need to produce thick supportive tissue, may grow at rates as high as about 12.5 millimeters per hour.

Apical meristems are involved in several distinct developmental processes. Regions below the meristems are sites of active growth, where new shoot and root tissue rapidly expands. The shoot apical meristem plays a role in organogenesis, the formation of new leaves and axillary buds in a precise spatial pattern. In contrast, the root apical meristem is not involved in organogenesis; lateral roots are initiated by pericycle cells, which are themselves usually several centimeters away from the meristem. The apical meristems also play a role in histogenesis by giving rise to cells that undergo distinct patterns of differentiation to form specialized tissue types of the shoot and root. While the embryo initially gives rise to the precursors of dermal, ground, and vascular tissues (protoderm, ground meristem, and procambium, respectively), these tissue precursors continue to be formed by the apical meristems and represent the first stages of tissue differentiation.

Plant tissues and organs differentiate from each other and from their precursors. For example in organogenesis, cotyledons, foliage leaves, sepals, and petals may all develop from similar precursors (i.e., the leaf primordia). As these organs mature, they become different from each other in size and shape, and in the development of distinctive cell types. For example, the epidermis tissue of petals is different from that of photosynthetic organs (e.g., cotyledons, foliage leaves, and sepals). The epidermis of photosynthetic organs is transparent to allow the penetration of light into internal tissues. In contrast, the epidermal cells of petals contain pigments. In some embodiments, a three-dimensional representation of plant growth may comprise color or other information to describe the differentiation of a tissue and/or organ of the plant.

The reproductive stage of plant growth may occur when the seedling has matured to produce a flower comprising male and/or female parts. The flower contains pollen, which may be transferred to the egg part of a flower (pollination) to result in new seeds (e.g., in a seed pod). In some embodiments, a three-dimensional representation of plant growth may comprise detailed information describing the flowering of a plant, and/or the process and result of pollination of the plant.

A third growth stage (senescence) occurs after new seeds or pods have been produced. Senescence may be accompanied by characteristic changes in plant appearance or morphology, some or all of which may be features of a three-dimensional representation of plant growth according to some embodiments. For example, a change in color, and subsequent shedding, of the leaves on certain deciduous trees accompany senescence in these trees.

The development of a plant may also comprise a dormancy stage. While dormant, a plant may experience extreme environmental signals (e.g., intense cold, such as during winter in some crop growing areas), and remain capable of later new growth. For example, a tree may reside in a dormant stage through winter until the emergence of new buds in spring. Such a cycle may repeat for years, until the tree eventually dies. Particular embodiments include a three-dimensional representation of plant growth over time comprising a dormancy stage.

Different plants may have one of several general seasonal growth patterns: annual plants live and reproduce within one growing season; biennial plants live for two growing seasons, and usually reproduce in the second year; and perennial plants live for multiple growing seasons and continue to reproduce once they are mature. These seasonal growth patterns may depend on climate and other environmental factors. For example, plants that are annual in alpine or temperate regions may be biennial or perennial in warmer regions. In some embodiments, a three-dimensional representation of plant growth over time may represent the growth of a plant for more than one growing season.

The particular genotype of a specific plant may discernibly affect its growth and development, and such genotype-specific effects may be represented in particular embodiments of the invention. For example, certain wheat genotypes may lead to maturation of the plant in less than about four months, whereas other wheat genotypes may require longer than five months to mature under the same environmental conditions. However, growth is also determined in part by environmental factors including, for example and without limitation: temperature; water; light; available nutrients; biotic factors (e.g., mycorrhizal fungi); and pests. Any change in the availability or extent of such external conditions may be reflected in the plant's growth. In particular embodiments, a three-dimensional representation of plant growth may represent genotype-specific and environment-specific effects on plant growth and morphology. For example, in certain embodiments, a three-dimensional representation of plant growth may be constructed for a first plant of interest, and a second three-dimensional representation of plant growth may be constructed for a reference plant, such that features of the growth and morphology of the first plant may be understood by comparison with those of the reference plant.

Environmental Factors Contributing to Plant Growth

In some embodiments, data capturing relevant environmental factors or signals may be acquired to produce a representation of plant growth and/or development that represents the influence of the environmental factors or signals on the growth and/or development of a plant. In particular embodiments, such data may include, for example and without limitation: temperature (e.g., as expressed in GDDs); soil characteristics; weather (e.g., frost and hail); flooding; moisture; pestilence; weed infiltration; biotic factors; and light availability.

Temperature

GDD: Growing-degree days (GDD) are a measure of heat accumulation that may be used by those in the art to predict plant growth and development rates, such as for example and without limitation, the date that a flower will bloom or a crop will reach maturity. GDD may be calculated using a summation of the mean daily temperature in a particular growing environment.

The GDD system is based on at least two assumptions: there is a value or base temperature below which plants do not grow or grow very slowly; and the rate of growth of a plant increases as temperature increases above the base temperature. Different plants have different characteristic base temperatures as may be used in the GDD representation of heat accumulation. For example, cool-season crops such as wheat, oats, and canning peas may have a base temperature of about 40° F., while warm-season crops such as corn and sorghum may have a higher base temperature of about 50° F.

GDD may be determined by subtracting the base temperature from the mean daily temperature. For example, the mean daily temperature in central Iowa when corn is planted may be about 56° F. Therefore, using a base temperature of 50° F. for corn, the contribution of temperature to corn growth at this time in central Iowa may be represented by 6 GDD (56° F.-50° F.). When the mean daily temperature is warmer, for example, 74° F., the contribution of temperature to corn growth at this time may be represented by 24 GDD (74° F.-50° F.). Thus, in terms of growing-degree days, the rate of corn growth under the warmer (74° F.) conditions would be four times the rate at planting (24/6).

Predicting Plant Growth

The importance of computers and analytical programming in agriculture has increased rapidly in recent years. Accordingly, approaches have been developed to reconstruct the three-dimensional geometric structure of plants. Moulia and Sinoquet (1993) “Three-dimensional digitizing systems for plant canopy geometrical structure: a review,” In: Crop structure and light microclimate: characterization and applications, Varlet-Grancher et al., Eds., Paris: INRA Editions, pp. 183-93; Ivanov et al. (1995) Agric. Forest Meteor. 75:85-102; Room et al. (1996) Trends Plant Sci. 1:33-8. There are also two general types of predictive methods used in agriculture: one employs regression equations to estimate yields; and another may be used to parameterize the growth and development processes of a plant. Stapper and Arkin (1980) Research Center Program and Model Documentation No. 80-2, Blackland Res. Center, Texas A & M University; Wright and Keener (1982) Agric. Sys. 9(3):181-97.

The characterization of biological and physical processes in canopy growth methods is usually based on the description of the geometric structure as a continuous medium, which allows the use of differential equations to describe mass and energy transfer between plants and the environment. Process-based methods may be used to predict plant metabolism and growth by computing volumetric variables. However, these methods have not been used to describe physiological processes at the level of individual plants, since typically only probabilistic descriptors have been used. L-system methods and similar approaches have been introduced to simulate the three-dimensional architecture of plants. See, e.g., Prusinkiewicz and Lindenmayer (1990) The algorithmic beauty of plants, New York: Springer-Verlag; Jaegger and de Reffye (1992) J. Biosci. 17:275-91; Kurth (1994) Growth Grammar Interpretter GROGRA 2.4. A software tool for the 3-dimensional interpretation of stochastic, sensitive growth grammars in the context of plant modelling. Introduction and reference manual, Göttingen: Forschungszentrum Waldökosysteme der Universität Göttingen, Berichte des Forschungszentrums Waldökosysteme der Universität Göttingen, Reihe B Bd. 38. However, the implementation of these L-system prediction methods has been static and, thus, does not capture important information relating to plant growth and development processes as they occur over time.

In embodiments, any known analytical programming for predicting the growth of an individual plant may be utilized in a method for producing a three-dimensional representation of plant growth. The particular analytical programming utilized therein is not important, so long as the method according to a particular embodiment utilizing the analytical programming is able to convey by representation one or more traits or features of interest in the subject plant, for example, in a particular growing environment. Thus, analytical programming for predicting plant growth includes, for example and without limitation, those known in the art and others that may be derived from specific application of more general mathematical formulae.

Specific examples of analytical programming that may be used in particular embodiments, or analytical programming that may be adapted for use in particular embodiments, include, for example and without limitation: 3D architectural methods (e.g., modular predictive programming); CUPID; process-based methods (see, e.g., Fournier and Andrieu (1998) Ann. Botany 81:233-50); L-system methods (e.g., GRAPHTAL); contextual L-system methods; CERES (e.g., CERES-Maize, CERES-Wheat, etc.); CORNF (see, e.g., Wright and Keener (1982) Agric. Sys. 9(3):181-97); HYBRID-MAIZE (available through the University of Nebraska-Lincoln); MODWht3 (Rickman et al. (1996) Agron. J. 88:176-85); and variations of the foregoing.

Particular analytical programming may take into account variables that relate to, for example and without limitation, environmental factors in a particular growing environment, and genetic attributes or traits of a particular plant. Data that is input into a particular analytical programming may include, for example and without limitation, climate variables (e.g., latitude, radiation, daily temperature, and precipitation); management variables (e.g., sowing date, plant density, and irrigation schedules); soil/site parameters (e.g., soil albedo and soil layer thickness); and crop genetic constants or variables.

CERES (CROP ENVIRONMENT RESOURCE SYNTHESIS): CERES methods are deterministic predictive methods that are designed to simulate plant growth, soil, water, temperature, and soil nitrogen dynamics at a field scale for one growing season. CERES methods may operate on a daily time step and compute state variables for each day of a year or growing season. Several related CERES methods exists, such as CERES-Wheat and CERES-Maize. CERES-Maize methods are discussed and reviewed in, for example, Jones and Kiniry (1986) CERES-Maize, a simulation model of maize growth and development, College Station: Texas A&M University Press; Tsuji et al. (1994) DSSAT v3, “User's Guide,” Honolulu, Hi.: Univ. Hawaii (CERES-3.1); and Fraisse et al. (2001) Appl. Eng. Agric. 17(4):547-56.

Using a CERES method or variant thereof, potential dry matter production may be calculated as a function of radiation, leaf area index, and reductions for stress factors. Available photosynthate may be initially partitioned to leaves and stems, and later for ear (for CERES-Maize) and grain growth. Any remaining photosynthate may be allocated to root growth. However, a CERES method may be modified so that if dry matter available for root growth is below a minimum threshold, grain, leaf, and stem allocations are reduced to provide dry matter to support the minimum level of root growth. Separate programming routines may calculate water balance, including for example, runoff, infiltration, and saturated and unsaturated water flow and drainage. Mineral nitrogen dynamics and nitrogen availability for crop uptake may also be calculated.

The output of a CERES method may include above-ground dry matter, nitrogen content, grain dry matter, nitrogen content, and summaries of water balance and soil mineral nitrogen. Phenological stages may be simulated, and growth rates may be calculated. Any and all of the foregoing outputs may be subjected to further analytical programming in particular embodiments to convert their values, and optionally additional variables and constants, into a three-dimensional representation of plant growth.

CERES methods have been used to simulate the growth and development of many disparate plant species, including wheat, maize, sorghum, pearl millet, and barley. CERES-Maize has been extensively tested on different soil types, for a range of climatic conditions, and with various corn hybrids. Hodges et al. (1987) Agric. For. Meteorol. 40:293-303; Carberry et al. (1989) Field Crops Res. 20(4):297-315; Cooter (1990) Climate Change 16(1):53-82; Jagtap et al. (1993) Agric. Syst. 41(2):215-29; Pang et al. (1998) J. Environ. Qual. 27(1):75-85. However, in typical applications of CERES methods, plant structure is described statistically, in terms of leaf area expansion, without describing the development of the stem. Thus, in some embodiments, CERES methods are used to supplement, or determine the value of parameters and/or inputs in, an architectural predictive method.

A CERES method may calculate the growth of a particular plant part using a routine that may be modified according to the discretion of the practitioner. For example, a CERES method may comprise a routine that calculates root growth (ROOTGR) from three factors: (1) a soil water deficit factor (SWDRY); (2) a factor describing mineral N availability (RNFAC); and (3) a root growth weighting factor (WR). Fraisse et al. (2001) Appl. Eng. Agric. 17(4):547-56. Such a CERES method may be modified be modifying the ROOTGR routine to include the calculation of a relative saturation factor (SWWET_{L}) for each soil layer (eq. 1).

SWWET_{L}=1.0−EXP(−100.0×(SAT_{L}−SW_{L})) (1)

where
SAT_{L}=saturated soil water content for layer L (cm³/cm³); and
SW_{L}=soil water content for layer L (cm³/cm³)

This exemplary modified CERES method may further replace the root growth-weighting factor with a root hospitality factor (RHFAC) that defines the ability of roots to penetrate and explore a soil layer. An additional factor, the hardpan factor (HPF), may be used to characterize a layer with additional restrictions on downward root development, including restrictive layers (e.g., a compaction pan or claypan), layers with the presence of rock fragments, or layers exhibiting aluminum toxicity. According to the foregoing modified CERES method, the rate of root depth increase in a given layer (RRD_{L}) is provided by eq. 2. Fraisse et al. (2001), supra.

RRD_{L}=0.2×min(SWDRY,SWWET,min(RHFAC,HPF)) (2)

MODULAR DESCRIPTIONS: In some embodiments, analytical programming for predicting the growth of an individual plant may employ “modules” that collectively describe the architecture of the growing plant. Such modules are generally selected to faithfully represent the botanical structure of the plant and to allow a faithful description of its ontogeny. For example, in particular embodiments, three modules may be defined with respect to the age and the topological position of a plant meristem from which they originate: (1) an apex module, denoting the apical meristematic region of the stalk, generating other lateral meristematic regions; (2) a leaf module, originating from a lateral primordium; and (3) an internode module, originating from a meristematic region of the same age as the leaf, but later separating from the leaf meristematic region as a consequence of intercalary growth. Modular description of plant development may focus on the description of growth of the aerial vegetative structure of a plant, during a particular developmental period. Morrison et al. (1994) Crop Sci. 34:1055-60. The overall structure of a modular representation may be based on general knowledge of leaf and stem expansion for the particular plant species or variety represented. See, e.g., Grant (1989) Agron. J. 81:451-7; Kiniry and Bonhomme (1991) “Predicting maize phenology.” In Predicting crop phenology, Hodges (Ed.) CRC Press, Boca Raton, Fla., pp. 115-132.

L-SYSTEMS: L-system methods that are currently available include graphical capabilities, and may be used in particular embodiments to predict the growth of a plant. L-systems employ “production rules” (acting on “modules,” which are structural units repeated in the global structure, e.g., apices, leaves, and internodes), to describe local processes (e.g., in a plant organ or meristem), and then to describe the architectural changes in the whole organism resulting from these local processes. Production rules may be used to describe a qualitative change occurring during the development of a plant.

For example, in the use of an L-system method, a plant may be represented as a string of modules that encodes the plant as an ordered succession of words, representing the modules, and brackets, indicating the beginning and end of ramifications. Such a bracketed-string notation allows coding of any structure with a one-dimensional topology (i.e., a ramified structure). Development of the plant may then be predicted according to a parallel rewriting process that transforms plant modules into new modules at each of a plurality of time steps. The rewriting process may replace each module in the string where a production rule applies with the computed result of the production rule.

Transformations defined by L-system production rules may therefore be quantitative. For instance, if Am is a module representing the apical meristem (the apex) the production rule:

Am→I[Axm][L]Am (3)

may describe the production by the apex of a growth unit consisting of an internode I, an axillary meristem Axm, and leaf L. In eq. (3), the symbols “[” and “]” denote the beginning and the end of a ramification, respectively.

Quantitative evolution of the modules may be described through evolution of parameters. For instance, the elongation of a leaf during a time step may be described through the production rule (eq. 4):

L(l)→L(l+dl) (4)

where l denotes the length of the leaf, and dl denotes the length increment.

Modules may have parameters corresponding to variables involved in physiological processes and others parameters to describe their geometric aspect. Moreover, any geometrical parameter of plant architecture, for example and without limitation: dimension and angle, may be associated with a module and manipulated by a production rule. Geometric representation may be based on programming that recognizes a set of reserved modules present within the string as shapes to draw. For example, predictive geometrical data generated by GRAPHTAL™ typically consists only of coordinates of points and polygons.

Connectivity relations between modules may be provided in contextual L-systems according to rules wherein a first module depends on one or more neighboring module(s). For example, a contextual L-system may be used to predict a transfer of information from an apex to a bud. In specific examples employing an L-system, the L-system method may explicitly describe the start, rate, and the end of the growth of one or more different modules constituting a plant.

The use of L-systems in describing plant growth has generally been limited to describing the emergence of plant shape and has been focused on the processes of ramifications, with a time step corresponding to the production of new modules. De Reffye et al. (1988) Comp. Graphics 22:151-8; Prusinkiewicz et al. (1997) “L-systems: from theory to visual models of plants,” In: Plants to ecosystems. Advances in computational life sciences series vol. 1, Michalewicz, Ed., Melbourne: CSIRO Publishing. Examples of the use of L-systems in plant biology include: Guzy (1995) A morphological-mechanistic plant model formalised in an object-oriented parametric L-system, Riverside: USDA-ARS Salinity Laboratory; Perttunen et al. (1996) Ann. Bot. 77:87-98; de Reffye et al. (1997) “Essai sur les relations entre l'architecture d'un arbre et la grosseur de ses axes végétatifs,” In: Modélisation de l'architecture des végeétaux, Bouchon et al., Eds., Paris: INRA Editions; Mech and Prusinkiewicz (1996) “Visual models of plants interacting with their environment,” In: Proceedings of SIGGRAPH '96 (New Orleans, La., Aug. 4-9, 1996), New York: ACM SIGGRAPH, pp. 397-410; and Fournier and Andrieu (1998) Ann. Bot. 81:233-50. General information regarding the use of L-systems to describe plant architecture may be found, for example, in Prusinkiewicz (2004) Curr. Opin. Plant Biol. 7:79-83.

In some embodiments, a three-dimensional representation of a plant may comprise a representation of a whole plant. In some embodiments, a three-dimensional representation of a plant may comprise representations of one or more plant parts or structures of interest. For example and without limitation, a three-dimensional representation of a plant may comprise representations of apical meristem, internode, intercalary meristem, leaf, stem, flower, root, and/or seed structures. A three-dimensional plant representation may be produced at a plurality of points in time to illustrate developmental processes including, for example and without limitation, emergence, vegetative growth, flowering, reproduction, and fruiting.

Predicting the structure of the apical meristem may include processes comprising one or more of: initiation of leaves and internodes; transition to the reproductive stage; elongation of leaves and sheath; parameterization of leaf elongation; final leaf size for leaf laminae; growth duration for leaf laminae; final size of leaf sheaths; growth duration for leaf sheaths; delay between initiation of primordial; and beginning of leaf elongation. A representation of predicted plant growth over time may be include changing the representation of a plant apex according to the successive initiation of phytomers, each consisting of an internode module and a leaf module. An axillary bud may also and alternatively be represented. The initiation of phytomers in the representation may be stopped when the apical meristem enters its reproductive stage and initiates the panicle.

Predicting the structure of internodes may include processes comprising one or more of: the growth rate of internodes; final size of internodes; and growth duration of internodes. The first four or five internodes, supporting the roots, remain very short. Significant elongation occurs only for higher internodes and starts after the apex has formed a tassel. Messiaen (1963), supra. Plant height, and thus internode length, is known to be significantly affected by population density through trophic and photomorphogenetic processes. Grant and Hesketh (1992) Biotronics 21:11-24. In some embodiments, analytical programming for predicting the structure of an internode may allow the generated predictive representation to account for, for example, quantitative differences between the growth of particular internodes, developmental changes associated with internode elongation in a particular species; and effects on internode length introduced by, e.g., plant population density.

The mechanism of internode elongation is similar in both monocots and dicots, though development is acropetal (the intercalary meristem is at the top of the internode) in dicots, and basipetal (the intercalary meristem is at the base of the internode) in monocots. See, e.g., Evans (1965) Br. Prodr. Ann. Bot. 29:205-17. Internodes emerge and elongate in a staggered fashion. As elongation activity in one internode decelerates, the elongation of the internodes above it accelerates, and an additional internode above them begins to elongate. Patrick (1972) Aust. J. Biol. Sci. 25:455-67 (in wheat, Triticum aestivum L. cv. Stewart). Young dicot internodes generally initially elongate uniformly over their length, followed by an increase in elongation, and a shift of the center of elongation towards the upper end of the growing internode. Sachs (1965) Annu. Rev. Plant Physiol. 16:73-97. As elongation decelerates, growth is concentrated very close to the upper node of the internode. In internodes of sunflower (Helianthus annuus L.), elongation activity began in the basal area and shifted progressively toward the upper end of the internode as it lengthened. Garrison (1973) Bot. Gaz. 134:246-55. Hypocotyls of Brassica caulorapa Pasq. and Phaseolus vulgaris L. exhibited the same pattern of development. Havis (1940) Am. J. Bot. 27:239-45; Klein and Weisel (1964) Bull. Torrey Bot. Club 91:217-24. Basipetal growth in monocotyledonous grasses is in the reverse direction. Martin (1988) Ukrains 'kii Botanichnii Zhurnal 45:35-9.

Testing Analytical Programming for Predicting Plant Growth

Particular examples include testing the performance of specific analytical programming for predicting plant growth in a method according to some embodiments (i.e., the accuracy with which a representation generated by such a method simulates the growth of an actual plant of the same species under, for example, the genetic and environmental constraints input into the analytical programming). Analytical programming for predicting plant growth may generally be tested according to methodology consisting of four basic steps. Keener et al. (1980)J. Appl. Meteor. 19:1245-53. The steps may include: examination of the basic assumptions of the analytical programming in order to assess their validity (for example, process-based methods typically assume a priority of partitioning photosynthate to different growing plant parts); sensitivity analysis of the analytical programming; reasonableness testing, e.g., in silico (to eliminate specific programming that does not give reasonable results when using realistic data); and rigorous testing of the programming (e.g., by comparing predictions obtained using specific analytical programming with actual observation of, for example, phenological events (e.g., emergence, anthesis, and blacklayer), leaf ligule appearance rates, dry matter accumulation, yield, yield components, and stress effects).

### V. Predicting Growth of Corn (Zea mays)

In some embodiments, a method of representing plant growth may be used to generate a three-dimensional representation of the growth of a corn plant, e.g., utilizing acquired relevant data that has been input into a database comprised within a computer readable storage medium, and operating on the data utilizing analytical programming for predicting plant growth. In particular embodiments, the acquired relevant data may include, for example and without limitation, a growth parameter derived from a specific corn variety or cultivar of interest (e.g., a genetically-modified corn plant) that reflects the presence or absence of a growth-related trait or phenotype in the specific variety or cultivar.

Corn is an annual plant, and typical corn varieties attain a height of between about 7 and about 10 feet at maturity, although particular varieties may have a maximum height of as little as about 3 feet, or as much as about 15 feet. Parts of a growing corn plant that may be represented in a representation of plant growth generated according to some embodiments include, but are not limited to: prop roots (strong roots that support the cornstalk); tassels (located at the top of a cornstalk and containing pollen-producing flowers); leaves (growing outward from the stalk and generally long and narrow in shape); ears (growing where leaves join the cornstalk); husks (leaves that protect the ear); kernels (located within the ear); corncobs (typically covered with 8, 10, 12, or more rows of kernels); and corn silks (threads running from each kernel over the row and protruding from the husk at the end of the ear; a silk is pollinated to produce a kernel of corn). The leaves of the plant are produced first, followed by the leaf sheaths, stalk, husks, ear shank, silks, cob, and finally grain.

The entire life cycle of a corn plant is typically between about 120 and about 150 days, depending on environmental and management factors. In some embodiments, a method of representing plant growth may be used to generate a three-dimensional representation of the growth of a corn plant over its entire life cycle. In other embodiments, a method may be used to generate a representation of the growth of a corn plant over one or more particular periods of interest in the life cycle of the plant. In still further embodiments, a method may be used to generate a representation of the growth of a corn plant over a period that includes an artificial period that extends beyond the life cycle of the actual plant.

Corn is a summer plant that is typically sown between April and May, with the exact date being dependent upon the particular growing environment and management decisions of the grower. Corn flowers between July and August. In early, July the male parts (the tassel) and female parts (ears) of the flower are formed. Between mid-July and mid-August, the tassel releases pollen, the ovules are fertilized, and the leaves complete their growth. From late August to early October, fertilized ovules grow larger to form kernels. A corn plant typically ripens by October, and may then be harvested until November. Grain maize is typically harvested when the moisture content is between 25% and 35%, while sweet corn is typically harvested when the moisture content about 70-72%. Silage maize is typically harvested when the entire plant has a dry matter content between 32% and 35%.

Different corn germplasms have dramatically different growth rates and features, which may be difficult to describe or understand without access to a pictorial or graphical aid. For example, the life cycle of a corn plant of a specific variety or cultivar may be from about 60 to 70 days (very early-maturing types, such as Gaspée), to about 10 or 11 months for late-maturing types grown in tropical regions. The height of the cornstalk may be from 30 to 40 cm for some corn varieties, up to more than 10 meters for others. Also, depending on the variety, one sown seed may produce from 1 to 14 stalks, and each stalk may produce only a few leaves or as many as about fifty leaves. Kernels on particular corn plants may display substantial differences, for example, in volume and color. Furthermore, the expanding use of genetic engineering and selective breeding programs in corn is rapidly producing an even larger number of new corn varieties with new and distinctive growth characteristics.

Corn Growth Stages

Typical corn plants develop 20 to 21 total leaves, silk about 65 days after emergence, and mature around 125 days after emergence. The length of time between each growth stage, however, depends upon the circumstances under which a particular plant is grown, in addition to the genetic attributes of the plant. For example, the lengths of specific time intervals after which a plant enters a subsequence growth stage vary among hybrids, and depend upon the growing environment, planting date, and location. Thus, an early-maturing hybrid may produce fewer leaves or progress through different growth stages more rapidly than a later-maturing hybrid.

Corn growth stages may be separated into two broad categories, vegetative (V) stages and reproductive (R) stages. Vegetative growth stages in corn are identified by the number of collars present on the corn plant. The leaf collar is a light-colored, collar-like “band” located at the base of an exposed leaf blade, near the spot where the leaf blade comes in contact with the stem of the plant. Leaves within the whorl, not fully expanded and with no visible leaf collar, are not included. According to the foregoing, a corn plant with 3 collars would be called a V3 plant; however, there may be 6 leaves showing on the plant including 3 within the whorl.

In addition to the foregoing designation as vegetative or reproductive, growth stages can be grouped into four major periods: seedling growth (stages VE and V1); vegetative growth (stages V2, V3 . . . Vn); flowering and fertilization (stages VT, R0, and R1); and grain filling and maturity (stages R2 to R6). The following description of specific corn growth stages is one of many exemplary descriptions; i.e., the exact timing of particular developmental events may not be the same for all varieties and/or in all growing environments. For example, the determination of kernel rows per ear may begin at stage V6, but may also begin in other examples in V5 or V7.

Seedling Growth (Stages Ve and V1).

VE: Stage VE begins approximately 7-10 days after planting, when the coleoptile emerges from the soil surface. Elongation of the coleoptile ceases above ground, and the first true leaves rupture from the coleoptile tip. Below ground, mesocotyl and coleoptile elongation takes place. Elongation of the mesocotyl ceases when the coleoptile emerges above soil surface. During VE, the growing point is below the soil surface, growth of the seminal root system (i.e., radicle and seminal roots) is completed (the seminal root system supplies water and nutrients to the developing seedling), and the nodal roots (secondary roots that arise from belowground nodes) are initiated.

V1: Stage V1 begins when the collar of the lowermost leaf is visible. During this stage, the nodal roots begin elongation.

Vegetative Growth (Stages V2, V3 . . . Vn).

Vn: Stage Vn begins when the collar of the nth leaf number is visible. The maximum value of “n” represents the final number of leaves, which is usually 16-23. The plant progress to the next stage, Vn+1, with the formation of every new leaf collar, even though lower numbered leaves may fall off as the plant approaches maturity.

V3: At stage V3, the growing point remains below the soil surface, as little stalk elongation has occurred. Lateral roots begin to grow from the nodal roots, and growth of the seminal root system has ceased. All leaves and ear shoots that the plant will produce are initiated at this stage.

V5: At stage V5, the uppermost ear and tassel is initiated. The growing point nears the soil surface at this stage as stalk internode elongation begins, and the tassel is differentiated.

V6: Stage V6 occurs 24-30 days after emergence, when the potential plant parts are developed; all plant parts are present at this stage. The growing point and tassel are above the soil surface at stage V6. The cornstalk begins a period of rapid elongation, and the determination of kernel rows per ear (strongly affected by genetics) begins. Ear shoot initiation has begun. Tillers (or “suckers”) emerge, degeneration and subsequent loss of lower leaves occurs, and the nodal root system is established as the main functional root system of the plant. By stage V6, a new leaf is emerging (and hence a new V-stage initiated) about every 3 days.

V 10: At V 10 growth stage, the cornstalk is in a rapid growth phase, and is accumulating dry matter as well as nutrients. The tassel has typically also begun rapid growth at this stage.

V12: At stage V12, typically occurring 42-46 days after emergence, the potential kernel rows have been determined; i.e., the number of kernel rows is set. The number of kernels per row is determined up to the week prior to silking. At this stage, the number of ovules (potential kernels) on each ear, as well as the size of each ear, is being determined (strongly affected by environmental factors). By stage V12, a new V-stage is being initiated about every 2 days. The brace root formation begins stabilizing the plant.

V18: At stage V18, typically occurring approximately 56 days after emergence, the potential kernels per row are determined. Ear development is rapid, and the upper ear shoot is developing faster than other shoots on the cornstalk. Silks are elongating, and brace roots are being formed from nodes above the soil surface to support the plant and to obtain water and nutrients from the layers of the upper soil surface during the reproductive stages.

Flowering and Fertilization (stages VT, R0, and R1).

VT (tasseling): The VT stage begins when the last branch of the tassel is visible and about 2-3 days before silks emerge from the husk. The plant is almost at its full height by the time it reaches VT.

R0: Anthesis (pollen shed), or male flowering, begins during stage R0, and lasts about 5-8 days for each individual plant. Pollen is typically shed in the morning or evening.

R1: At stage R1, typically occurring about 60-75 days after emergence (2 to 3 days after tasseling), the corn plant enters its first reproductive stage of development, silking. The beginning of this stage is marked by the visibility of silks outside the husks and the beginning of pollination. Pollination occurs when pollen grains contact the silks; a pollen grain grows down the silk and fertilizes the ovule in about 24 hours. Upon this fertilization, the ovule is a kernel. Silks grow about 1 to 1.5 inches per day, with silks elongating from the base of the ear to the tip of the ear until they are pollinated. Silk emergence takes about 2-5 days, and the silks turn brown once they are outside the husk. At stage R1, the plant has reached its maximum height.

Grain Filling and Maturity (Stages R2 to R6).

R2: The R2 (or blister) stage occurs between about 10 and about 14 days after silking. During the R2 stage, the kernels resemble blisters, because they are white and full of a clear fluid. The embryo can be seen within each kernel. Also at R2, the corncob is close to reaching its final size. The silks lose moisture and darken.

R3: The R3 (or milk) stage begins about 18-22 days after silking. Most of the kernels have grown out from the surrounding corncob material by this stage, and they begin to yellow, while the clear inner fluid in the kernels turns white and milky. Silks at this time are brown and dry or are becoming dry. Very little root growth occurs after stage R3.

R4: The R4 (or dough) stage begins about 24-28 days after silking. At this stage, the kernel has thickened to a white paste (dough) from its earlier milky consistency. The cob appears white when kernels are removed.

R5: The R5 (or dent) stage begins about 35-40 days after silking. If the corn variety is a dent type, nearly all kernels are drying at the top “denting” or have dried at the top “dented.” At around 48 days after silking, all the kernels should be fully dented. Drying kernels show a small, hard, white layer on top. A white line (known as the milk line or starch line) can be seen across the base of the kernel when viewed from the side shortly after denting, in both flint and dent types. The milk line progresses from the tip to the base of the kernel. When this line reaches the base (the 100-percent milk line), a black or brown layer forms where the kernel attaches to the cob (black layer). The corncob at R5 is dark red in color.

R6: The R6 stage occurs about 50-65 days after mid-silk (or about 130 days after emergence). At the R6 stage, the starch line has advanced completely to the kernel tip, and a brown or black layer is visible at the base of the grain. The husks and many of the leaves are no longer green, although the cornstalk may remain green. Black layer has occurred, indicating that the plant has attained physiological maturity.

Environmental Factors Affecting Corn Growth

Environmental factors that may impact the growth of a corn plant may be accounted for in a representation of plant growth in some embodiments and, thus, such a representation may display the effects of such environmental factors. Many factors other than genetic factors affect corn growth and development, especially early in the growing season, including for example and without limitation: conservation tillage (see, e.g., Imholte and Carter (1987) Agron. J. 79:746-51); soil texture; planting date; seed-zone soil moisture (see, e.g., Schneider and Gupta (1985) Soil Sci. Cos. Am. J. 49:415-22); seed-bed condition (see, e.g., Schneider and Gupta (1985, supra); seeding depth (see, e.g., Hunter and Kannenberg (1972) Can. J. Plant Sci. 52:252-6); drought stress; heat stress; pest damage; and pesticide damage. Unfavorable conditions in early growth stages may limit the size of the leaves, while in later stages, unfavorable conditions may reduce the number of silks produced, result in poor pollination of the ovules, and restrict the number of kernels that develop, or growth may stop prematurely and restrict the size of the kernels produced.

In some embodiments, analytical programming for predicting growth of a corn plant may reflect the effects of one or more environmental factors, for example, by calculating the contribution of the environmental factor at one or more growth stages of the plant. In particular embodiments, the contribution of one or more environmental factors may be introduced into the analytical programming as variables, and may be actual values determined in the field or greenhouse for corn plants, in general, or for a particular corn variety or cultivar.

Environmental and management factors include, for example and without limitation: fertility; drought; flooding; pest lodging; disease; weed infiltration; pesticide damage; and competition with neighboring plants may affect corn growth and development. Adverse soil moisture and temperature conditions in combination with nutrient deficiencies, diseases, insects, and weeds may interact to create many different kinds of crop stress.

Temperature

One environmental factor that may be reflected in analytical programming for predicting growth of a corn plant in some embodiments is heat. Acquired heat data may be measured at a single point in time and expressed as temperature or, alternatively, it may be measured over a period of time and be expressed as heat units (HUs) (or GDUs or GDDs). GDUs may be calculated using eq. 5:

GDU=[(Daily high+daily low)−50° F.]/2 (5)

Since growth of most corn varieties is greatly reduced when temperatures are greater than 86° F. or less than 50° F., a daily high limit of 86° F., and a daily low limit of 50° F. may be set. Accordingly, if the daily high temperature exceeds 86° F., the daily high temperature used in eq. 5 would be set at 86° F. Similarly, if the daily low temperature drops below 50° F., the daily low temperature used in eq. 5 would be set at 50° F. If the daily high temperature does not exceed 50° F., then no heat unit value is recorded.

A corn plant can typically survive brief exposures to adverse temperatures (e.g., from about 32° F. (0° C.) to more than about 112° F. (45° C.)). Typical corn plants grow over a more narrow temperature range (e.g., from about 41° F. (5° F.) to almost about 95° F. (35° C.)). Optimal daytime temperatures for growth of a particular corn plant may be between about 77° F. (25° C.) and about 91° F. (33° C.). Corn will typically germinate and grow slowly at about 50° F. (10° C.), with poor germination resulting from below-normal temperatures. High-temperatures during ear formation, reproduction, and grain fill is also normally detrimental to corn growth and development. For example, a corn plant may begin to show adverse growth effects when the air temperature exceeds 90° F. (32° C.) during the tasseling, silking, and grain fill stages.

Commercial corn hybrid maturity is often determined by heat units. “Early-season” hybrids generally reach maturity after 2100-2400 GDU (about 85 to 100 days), “mid-season” hybrids generally reach maturity after 2400-2800 GDU (about 101-130 days), and “full-season” hybrids generally reach maturity after 2900-3200 GDU (about 131-145 days).

Assuming constants for other environmental or management factors, such as moisture and pest or disease damage, the rate of plant growth for a corn plant may be directly related to temperature, such that the length of time when the plant attains different stages of growth will vary as the temperature varies. Corn plants increase in weight slowly early in the growing season. But, as the plant grows and more leaves are exposed to sunlight, the rate of dry matter accumulation increases. Leaves enlarge, become green, and increase in dry weight as they emerge from the whorl and are exposed to light.

The growing cycle of corn consists of vegetative, reproductive, and maturation phases, but there are more detailed stages of development within these phases. Different maturity classes require different GDU accumulations to reach these stages. The growing cycle and GDU requirement for different stages of a 2700 GDU hybrid are listed in Table 1. GDU accumulation varies during the growing season. The effects of seasonal temperatures on the response of corn with different GDU maturity requirements at different regions from north to south through the Corn Belt are listed in Table 2.

TABLE 1
Representative Growing Degree Unit Requirements
for Different Phenology Stages.

| Phase | Developmental Stage | GDU |
|---|---|---|
| Vegetative | V2 | 225 |
| | V4 | 350 |
| | V6 | 475 |
| | V8 | 600 |
| | V10 | 740 |
| | V12 | 850 |
| | V14 | 1000 |
| | V18 | 1150 |
| Reproductive | VT | 1200 |
| | R1 | 1300 |
| | R2 | 1650 |
| | R4 | 1900 |
| | R5 | 2200 |
| Maturation | R6 | 2400 |
| | Physiological maturity | 2600 |

TABLE 2
Average and range of GDUs for corn planted on May 1 in southern
WI (data from Lauer (1997) Field Crops 28:1-16)

| | GDU/ | Average total GDU | Range of total GDU |
|---|---|---|---|
| Date | day | accumulated | accumulated |
| June 30 | 20 | 900 | 800-1000 |
| July 31 | 22 | 1550 | 1450-1650 |
| August 31 | 23 | 2200 | 2100-2300 |
| September 30 | 13 | 2600 | 2500-2700 |

Low temperatures (e.g., frost) may adversely affect growth in a corn plant, and such effects may be represented in some embodiments. Even nighttime temperatures in the low to mid-30s (° F.) may result in frost damage to corn seedlings. Though temperatures may not drop below 32° F., frost may still develop on exposed corn leaves due to radiational cooling. When temperatures fall below 32° F., plant parts may experience damage from freezing directly. Frosted leaves of corn plants may turn greenish-black during the first 24 hours, and then slowly bleach to a straw color as it dries out. Further, as frosted leaf tissue in a whorl dries, the whorl may develop a constricted knot that restricts expansion of the undamaged whorl tissue later on. Such knotted corn plants typically resume normal growth as the expanding whorl tissue breaks these knots.

Late spring frost damage resulting from radiational cooling with temperatures in the mid- to upper-30s (° F.) may result in damage to the outer leaf surface, which may appear as what is commonly referred to as “silver leaf.” Silver leaf appears as a silvery or dull gray upper leaf surface. Such leaves generally do not die abruptly, as will severely frosted leaf tissue, and continued expansion of the whorl will not be restricted in any way. New leaves that expand from the whorl will be normal in appearance.

MOISTURE STRESS. Though stress may result from a large number of factors, a shortage of plant water is by far the most frequent and detrimental within the Corn Belt. Excess moisture may also be a stressor. Moisture effects, including drought and flooding, may be represented in some embodiments. The relative benefits of particular corn varieties bred or engineered to be more resistant or tolerant to these stresses may be taught or studied in some embodiments by generating and then inspecting and/or analyzing representations of plant growth for the particular corn variety and a reference variety under the stress condition.

Soil moisture availability is determined by the interaction of four factors: the amount of moisture present in the soil; characteristics of the soil profile; the moisture capacity of the crop; and the demand for water by the atmosphere (which is a function of the energy available (solar radiation), the movement of moisture away from the evaporating surface (wind), the dryness of the air (humidity), and the air temperature). For the moisture to be adequate, the available soil moisture must be more than sufficient to meet the atmospheric evaporative demand. For example, if the growing environment is characterized by windy, hot, and/or sunny days with low humidity, the evaporative demand is high, and a high amount of available soil moisture must be present in order to avoid stress. Conversely, if the growing environment is characterized by cloudy skies, high humidity, and cooler temperatures, the evaporative demand is low, and less moisture is needed to avoid stress.

In some soils, moisture stress may lead to a further nutrient stress. For example, shallow soil depths containing fertilizer is placed may be dry under moisture stress situations, thus lessening the availability of the fertilizer nutrients to the growing plant. Soil conditions that produce shallow plant root development also may lead to a nutrient stress situation, because the availability of fertilizer may also become limiting under such conditions.

Solar radiation may also be a related stressor that affects corn plant growth, in spite of its necessary role in photosynthesis. For example, high solar radiation is often associated with low rainfall and high evaporative demand in the Corn Belt, resulting in moisture stress that becomes a factor affecting corn growth and yield. Shaw and Newman, “Weather Stress in the Corn Crop,” in National Corn Handbook-18, Purdue University Cooperative Extension Service, West Lafayette, Ind. (available on the internet at www.ces.purdue.edu/extmedia/NCH/NCH-18.html). Moisture stress has been predicted in maize, where large reductions in internode length and plant height were predicted. Robertson (1994) Field Crops Res. 38:135-45.

Precipitation

A growing corn plant's demand for water increases as its leaf area increases, and reaches a maximum near the tasseling stage. The period of time shortly before pollination through grain fill, when the kernels begin to dent, is a critical period during which moisture may greatly affect growth of the plant.

Prior to V6, or when the growing point is near or below the soil surface, a corn plant may survive only between two and four days of flooded conditions. If temperatures are warm during flooding (greater than about 77° F.), plants may not survive even 24 hours. Cooler temperatures prolong survival. The oxygen supply in the soil will generally be depleted after about 48 hours of flooding. Without oxygen, the plant cannot perform necessary functions, such as for example, nutrient and water uptake and root growth. If the flooding condition persists for less than about 48 hours, crop injury should be limited.

Though a plant is more likely to survive flooding once the growing plant is above water level, if flooding may still have a long-term negative impact on plant growth. For example, excess moisture during the early vegetative stages retards corn root development. Flooding and ponding may also result in reduced growth through the loss of nitrogen through denitrification and leaching.

PEST DAMAGE. All parts of the corn plant are vulnerable to damage from pests, and pests may attack the plant during any and all stages of growth. Numerous insect pest species attack corn in the United States, including for example and without limitation: seed, root and lower stem feeders; stalk borers; leaf feeders; and ear feeders.

Particular pests that may damage corn plant, and thereby affect its growth include, for example and without limitation: fungi; nematodes; Seed Corn Maggot; seedcorn beetles; wireworms; white grubs; billbugs; chinch bug; black cutworm; corn root aphid; Western corn rootworm; Northern corn rootworm; Southern corn rootworm; European corn borer; Southwestern corn borer; Southern cornstalk borer; stalk borer; lesser cornstalk borer; corn leaf aphid; spider mites; thrips; dingy cutworm; armyworm; grasshoppers; corn flea beetle; stink bug; corn earworm; Western bean cutworm; Fall armyworm; variegated cutworm; and sap beetle. In some embodiments, analytical programming for predicting growth of a corn plant may reflect the growth effects of one or more of the aforementioned insect pests.

DISEASE DAMAGE. Disease stress factors may also affect the growth of a corn plant. Disease pathogens that may affect the growth of a corn plant include bacteria and viruses. The influence of other environmental factors (e.g., air and soil temperature, rainfall, dew, relative humidity, soil type, soil pH, soil fertility, and pests (e.g., insects or other living organisms that are disease vectors)) may affect the susceptibility and/or exposure of a corn plant to disease.

New hybrids developed by selective breeding and genetic engineering have successfully produced corn varieties that are resistant or more tolerant of specific diseases than wild-type varieties. Accordingly, in some embodiments, analytical programming for predicting growth of a corn plant may reflect the growth effects of one or more diseases. Further, the resistance or tolerance of particular corn varieties may be taught and/or studied by generating a representation of corn plant growth that reflects the growth effect of the one or more disease(s) in a wild-type corn variety, and a representation that reflects the lesser or non-existent effect of the same disease(s) in a corn variety of interest.

Resistant varieties often vary in their relative degree of resistance with respect to specific diseases, and those with adequate resistance to one disease may or may not possess adequate resistance to another. Currently, no variety is resistant to all diseases, and such universal resistance is a theoretical goal rather than an expectation for future varieties. Some varieties may be specifically resistant to a disease; i.e., they are highly-resistant to that disease. This type of resistance may be controlled by a single gene or allelic mutation. Other varieties may not be highly-resistant to a disease, but may still have some resistance. This “horizontal resistance” or “field resistance” may be polygenic; i.e., the resistance is controlled by several genes. Polygenic resistance may be expressed in different ways. For example, a plant with polygenic resistance may form a thicker stalk rind to support itself, even though its pith tissue is completely decomposed by stalk rot. Also, lesions caused by a pathogen may not develop until later in the growing season, thus lessening the damage done, or a pathogen may cause fewer or smaller lesions on a leaf of the plant than would be caused by the same pathogen in susceptible plants.

Some varieties may be tolerant to a disease rather than resistant; they will continue to grow normally or almost normally, even though they become diseased. Tolerant varieties grow better in the presence of a disease pathogen than do hybrids with no resistance. Disease tolerance (also termed “general” or “nonspecific” resistance) is often polygenic. In some embodiments, analytical programming for predicting growth of a corn plant may reflect the growth effect (or lack thereof) of a disease on a corn plant comprising either allelic or polygenic resistance or tolerance to the disease.

ABIOTIC FACTORS. Abiotic factors include, for example and without limitation: herbicide injury; nutrient deficiency; nutrient excess; soil pH; soil compaction; and weather-induced injury. Abiotic factors may also be reflected in analytical programming for predicting growth of a corn plant in some embodiments.

Stress During Various Corn Growth Stages

In general, the impact of environmental stresses on yield varies with the development of the corn plant (Table 3). For example, flooding while the growing point is below ground (prior to V6) may greatly affect the growth of the plant (and hence the representation of a hypothetical plant subjected to such flooding according to particular embodiments), but frost or hail during this early period may have little or no effect. Thus, a representation of corn growth generated by a method according to some embodiments may comprise analytical programming for predicting plant growth that allows for representation of the effects of one or more environmental or management stress factors in a growth stage-dependent manner. In particular embodiments, effects of environmental or management stress factors on plant growth may be taught or studied by comparison of a representation of a plant subjected to the stress factor and a representation of a reference plant.

TABLE 3
Impact of environmental factors during corn development
on grain yield (from Lauer (1997) Field Crops 28: 1-16).

| | Yield impact at corn development stage (%) | | | | | | | | |
|---|---|---|---|---|---|---|---|---|---|
| Factor | VE | V6 | V12 | | V18 | | R1 | | R6 |
| Frost (<28 F.) | 0 | 100 | 100 | | 100 | | 100 | | 0 |
| Hail | 0 | 53 (max %) | 81 | (max %) | 100 | (max %) | 100 | (max %) | 0 |
| Drought/Heat | NA | NA | 3 | (%/day) | 4 | (%/day) | 7 | (%/day) | 0 |

| | | | | | | |
|---|---|---|---|---|---|---|
| Flooding (<48 hrs) | severe | 0 | 0 | 0 | 0 | 0 |

Planting to Emergence. Environmental factors of particular significance in the period from planting to seedling emergence include, for example, soil temperature (cold), soil moisture, soil aeration conditions, and interactions of the foregoing. Optimum germination and emergence occur when air and soil temperatures reach 68° F.-77° F., which may be higher than the average temperature at the time of planting. Cooler temperatures may not impose a stress on the seedling, but may delay its emergence. Even frost and freezing temperatures may not cause a stress situation during preemergence. However, the combination of wet weather and cold temperatures following planting may favor development and activity of soil pathogens that may produce disease stress in a seedling.

Early Vegetative Growth. Shortly after emergence, the corn plant shifts from dependence on food stored in the seed to that available in the soil. If the top few inches of soil contain low moisture when the growing plant is small, early growth effects may be seen. However, moderate moisture stress during this period may actually have an advantageous effect on growth, as such stress may increase early root growth, which may be beneficial under future low-moisture conditions. Excess moisture in the early vegetative stages may retard early-season root development, and may also lead to aeration and/or nutrition problems.

Dry matter production in corn plants is greatest when average daily soil temperature at the 4-inch (10-cm) soil depth is about 80° F. Lower soil temperatures (such as are typically found in many corn growing environments) may lead to low-temperature stress effects. Frost and freezing temperatures after the growing point has emerged above the soil surface may destroy a corn plant completely. Conversely, if the growing point is below the soil surface, there is seldom permanent injury, because the growing point is unlikely to freeze.

The effects of environmental stress factors at early stages of corn growth may depend on the particular growth stage during which the plant experiences the stress. For example, the effects of environmental factors on corn growth during the V3 stage may include, without limitation: an increase in the time between leaf stages, increase in the total number of leaves formed, delayed tassel formation, and/or reduced nutrient uptake in response to cold soil temperatures; damage by pesticides such as 2,4-D or dicamba; and damage by atrazine once the plant is more than about 12 inches tall.

Late Vegetative Growth. Effects of weather stress factors are generally more significant in the late vegetative growth stages (i.e., from about V6 to silking). If temperatures during the late vegetative stages are above about 72° F.-75° F. (which is considered optimal for corn growth), or if the plant is subjected to moisture stress, vegetative growth may be reduced. Smaller corn plants are typically further stunted by these factors during these stages, while larger plants may also be affected, but to a lesser degree.

For example, at stage V6, corn plants are increasingly vulnerable to above-ground damage. Nutrient deficiencies (e.g., low nitrogen) at this growth stage may also inhibit the growth of the plant. Insect pests may damage V6 plants, and so may most ALS-inhibitor herbicides. During the V7 and V8 growth stages, senescence of lower leaves may occur if the plant is stressed. At stage V12, soil moisture and nutrient availability are increasingly important to maintaining maximum growth in the plant.

Flowering and Fertilization. The stages wherein tasseling, silking, and pollination occur are in general critical stages in corn development for any type of environmental stress factor to occur. Temperature stress conditions may occur under conditions of high atmospheric moisture demand (e.g., where the mean temperature is above about 77° F., and/or the maximum temperature is above about 95° F.). Moisture, nutrient, pest, or disease stress during these stages may also affect plant growth.

Plants at the VT/R1 stages are most vulnerable to moisture stress and leaf loss. Moisture stress or nutrient deficiency may result in poor pollination and seed set, with the largest yield reduction occurring with stress at silking. Hot or dry weather conditions are more likely than wet weather to interfere with pollination. Dry weather may slow the growth of silks, resulting in failure of silks to emerge in time to receive pollen. Silks may also dry out rapidly and thus not contain the moisture necessary to support germination. Also, growth responses to previously-applied fertilizer may be seen at R1. Nutrient concentrations in the plant are highly correlated with final grain yield as nitrogen and phosphorous uptake are rapid.

Grain Filling. Early in the grain filling period, any kind of severe crop stress may affect plant development, for example, by significantly reducing the final grain yield, with the reduction becoming less as the plants approach complete physiological maturity. The environmental stress factor that has the greatest effect on yields during grain-filling is frost or freezing temperatures before the plant reaches maturity.

Effects of particular environmental or management stress factor occurring during grain filling that may be represented in specific embodiments include, for example and without limitation: darkening of silks due to hot or dry conditions during the R2 growth stage; cessation of kernel development, starting at the top of the ear, due to any stress during the R3 growth stage (the effects of stress at R3 are not as severe as at R1, and the effects of such stress become less as kernels mature); a reduction in the depth (but rarely the number) of kernels due to stresses at stage(s) R4 and/or R5; “chaffy” ears due to unfavorable growing conditions or nutrient deficiencies at R4; and premature black layer formation due to frost may before the R6 stage. Frost has no effect on kernel size/weight once the plant has reached the R6 stage. However, lodging from disease or pests may still inflict visible damage on the growing plant.

Analytical Programming for Predicting the Growth of a Maize Plant In some embodiments, analytical programming for predicting the growth of an individual plant may be utilized to produce a three-dimensional representation of a growing maize plant. Any analytical programming for predicting plant growth known in the art, and others that may be derived from specific application of more general mathematical functions, may be employed in particular examples.

Values selected for variables or parameters in the analytical programming may be specific to the description of the growth and geometric structure of a maize plant. For example, the values selected for variables or parameters in the analytical programming may be specific to the description of the growth and geometric structure of a particular variety or cultivar of maize. Thus, genotype-dependent variables and/or parameters corresponding to a particular maize cultivar to be represented may be selected for use in the analytical programming. In some embodiments, the analytical programming itself (e.g., production rules) may be selected to correspond to a particular maize plant. Information regarding the growth and development of maize is readily available to those of skill in the art. Such available information may be used in particular embodiments to supply the value or identity of variables, parameters, and/or analytical programming routines, for example, to supplement acquired information regarding the growth and/or development of a particular maize plant. Specific growth processes in maize may be genotype-dependent (see, e.g., Yamaguchi (1974), Soil Sci. Plant Nutr. 20:287-304; Robertson (1994) Field Crops Res. 38:135-45), and some exemplary representations of growing maize illustrate these differences between maize genotypes.

Following germination, elongation of the maize mesocotyl elevates the coleoptile towards the soil surface. The mesocotyl is the tubular, white, stemlike tissue connecting the seed and the base of the coleoptile. Continued expansion of leaves inside the coleoptile eventually ruptures the coleoptile tip, allowing the first true leaf to emerge. If mesocotyl elongation has elevated the coleoptile tip to the soil surface, emergence of the first true leaves typically occurs above the soil surface. However, one or more of the following factors may lead to premature splitting of the coleoptile, thereby allowing the leaves to emerge underground: exposure to light at deep soil depths; injury from certain herbicides, particularly under stressful environmental conditions; surface crusting, cloddy seedbeds, rocky seedbeds, planter furrow compaction, or otherwise dense surface soil that physically restrict mesocotyl elongation and coleoptile penetration; and cold temperature injury.

As with all of corn growth and development, germination and emergence are dependent on temperature. Corn typically requires from 100 to 120 GDD (growing degree days) to emerge. And under warm soil conditions, the period from planting of maize to its emergence may be from about 5 to about 7 days. Under cold soil conditions, emergence may take up to four weeks. Subsequent development of the nodal root system may also be limited by exposure to high temperatures and dry surface soils. In some embodiments, a three-dimensional graphical representation of the growth of the plant of interest over time may account for the effects of soil temperature on germination and/or emergence.

Technically, the elongating mesocotyl is the first internode of the stem. In growing maize, the first four or five internodes (which support the roots) remain relatively short. Significant internode elongation occurs only for higher internodes, beginning after the apex has formed a tassel. Messiaen (1963), supra. Plant height, and thus internode length, is also known to be significantly affected by population density through trophic and photomorphogenetic processes. Grant and Hesketh (1992) Biotronics 21:11-24; but see Tetio-Kagho and Gardner (1988) Agron. J. 80:930-5 (maize height insensitive to plant population in the range 0.8 to 15.4 plants m⁻²). Some embodiments may account for these processes. Alternatively, parameterization may be based on data corresponding to a usual agronomic density (e.g., about 8 plants m⁻²).

The beginning of internode elongation in maize is related to the development of the associated leaf Sharman (1942) Ann. Botany 6:246-82; Hesketh et al. (1988) Biotronics 17:69-77; Grant and Hesketh (1992), supra; and Robertson (1994) Fields Crops Res. 38:135-45. Thus, an internode may begin its elongation approximately when the sheath has reached 60% of its final length. This means that 5 to 10 cm of the sheath typically remains to elongate, which is close to the end of phase two in leaf elongation. Morrison et al. (1994), supra. Thus, in some examples, internode elongation may be represented as immediately following leaf elongation.

Because internode elongation of maize begins only after tassel initiation, the apex in early growth stages is typically only a few centimeters above the soil and is strongly affected by soil temperature. Soil temperature in a developing maize field may be as much as 20° C. higher than air temperature monitored by a standard meteorological station. Cellier et al. (1993) Agric. Forest Meteor. 63:35-54. Thus, while in some examples standard meteorological data or soil temperature may be input into analytical programming, in other examples temperatures may be adjusted to more accurately predict maize growth rate, for example, during early stages of development. Apex temperature during early growth stages may also be calculated by an energy balance model. When internodes begin to elongate, apex temperature approaches air temperature. Thus, in some examples, apex temperature may be set to be equal to air temperature after the first internodes have elongated. Water stress also may affect maize internode length/plant height. NeSrnith and Ritchie (1992) Field Crops Res. 28:251-6. In some examples, the effects of water stress are accounted for in the analytical programming utilized to generate a three-dimensional maize representation.

Maize internodes develop at different rates and exhibit variations in structure. From one maize plant to another (of the same variety or cultivar), analogous specific internodes typically develop similarly, but internodes within a plant may not. Maize has two phases of vegetative shoot development. During a first juvenile phase, internode elongation is reduced, and a tight rosette of leaves emerges from the nodes. During transition to a second adult phase and initiation of reproduction, a caulescent-type shoot develops. Poethig (1990) Science 250:923-30; Sachs (1965) Annu. Rev. Plant Physiol. 16:73-97. Internodal growth originates from the intercalary meristem positioned at the base of each grass internode. More detailed information regarding the growth of internodes, may be found, for example, in Sachs (1965) Ann. Rev. Plant Physiol. 16:73-97. Information specific to maize may be found in, for example, Morrison et al. (1994), supra; Jung (2003) Phytochemistry 63:543-9; and Robertson (1994), supra. Information regarding the growth of individual maize leaves, sheaths, and internodes may be found in, for example, Sharmon (1942) Ann. Bot. 6:245-82; Ben Haj Salah and Tardieu (1996) J. Exp. Bot. 47:1689-98; and Hesketh et al. (1988) Biotronics 17:69-77.

In some embodiments, development processes specific to maize may be represented. For example, the growth of an ear on a maize plant and/or the determination of ear size in a maize plant may be illustrated in particular examples. Ear shoots are initiated at multiple internodes very early in the development of a maize plant. Ear size determination of the uppermost ear typically begins by the time a corn plant is several feet in height, and is finished between about 10 and 14 days prior to silk emergence. Other maize-specific process that may be included in a three-dimensional representation of maize growth include, for example and without limitation: silking; tasseling; determination of kernels/ear; maize pollen shed; ear shoot development; ear size determination; determination of rows/ear; determination of kernels/row. These and further growth and development processes in maize may be influenced by genotype and/or environmental factors, which may be accounted for in analytical programming utilized to generate a three-dimensional representation.

### VI. Representing Predicted Plant Growth

In embodiments, a three-dimensional representation of plant growth over time makes it possible to simulate the visual observation of the architecture of a growing and developing plant in the environment during a growing season. Thus, a three-dimensional plant representation may simulate the interface between the plants and their environment. Representations of plant growth and/or development generated by methods according to specific embodiments may be reduced to a physical fomiat (e.g., a “screenshot” of a visual representation over time, and a computer readable medium comprising a file able to be read by a processor to produce a three-dimensional animation of growth over time), and a physical representation may be produced.

In some examples, a three-dimensional representation of plant growth comprises simple geometric shapes (e.g., lines, cylinders, circles, spheres, and triangles) that roughly correspond to the architecture of specific plant parts. Such a three-dimensional representation may be produced in specific examples by mapping the output of analytical programming for predicting plant growth (e.g., parameterized as a function of genotype and/or environmental factors) onto the simple shapes in a graphics software program.

For example, production rules associated with a physiological process in an L-system method may predict the length of internodes, sheaths, and blades. In such an example, the dimensions and orientation of plant parts may be defined geometrically (e.g., internodes may be defined by cylinders, with a diameter decreasing from the bottom to top of the plant, and leaf blades may be defined by triangles). The lengths predicted by the L-system method may then be mapped onto the specific plant part geometry, thereby generating a three-dimensional representation.

Alternatively, the dimensions and orientations of plant parts may be defined by more comprehensive methods, for example and without limitation, those provided and suggested by Prévot et al. (1991) Agronomie 11:491-503. In this work, the shape of a leaf developed on a plane surface was described by a relation between leaf width and position on the midrib. The parameterization of the shape of a fully developed leaf proposed by Prévot et al. (1991), supra, is defined by:

w/W=−2.50(u/L)²+1.84u/L±0.66 (6)

where u is the distance to the ligule and L the total length of the lamina; w is the width at point u and W is the maximum width of the lamina. This parameterization corresponds to a shape factor of 0.748 between leaf area Y and leaf dimensions: Y=7.48 W L.

The first five leaves of maize plants lie in a single plane, whose azimuth is randomly distributed within a field. Girardin (1992) Eur. J. Agron. 1:91-7. For upper leaves, azimuth generally differs from that of this initial plane, with a distribution depending on the initial orientation of the plane and on the rank of the leaves considered. Drouet and Moulia (1996) “Spatial re-orientation between successive leaves in maize,” In: Aspects of Applied Biology 46, Modelling in Applied Biology: Spatial Aspects (25-27 Jun., 1996, Brunel University, United Kingdom), White et al., eds., Wellesbourne: The Association of Applied Biologists, pp. 135-8.

In some embodiments, a representation of predicted plant growth may include information that is not directly related to the agricultural purpose of the plant (e.g., color). For example and without limitation, some corn hybrids may develop “purpling” in the leaves, due to the build-up of anthocyanin. Such purpling may also appear in the silks, anthers, or coleoptile tip of the corn plant. Purpling can be caused in susceptible hybrids by a number of factors, including low temperatures (Hybrids with anthocyanin-producing genes may purple more with daytime temperatures in the 60s or greater and evening temperatures in the 40s or lower. The purpling generally disappears as temperatures warm); excess photosynthetic sugars in the leaves (restricted root development and abundant plant sugars produced by photosynthesis may result in purpling. Similarly, it can be caused by leaf injury that traps sugars in leaf tissue); and nutrient deficiency (phosphorous deficiency, in particular, may cause purpling. Cold soil inhibits root development and may aggravate this condition). Although purpling, in itself, does not cause yield loss, the underlying cause of purpling may cause such loss.

Further, corn plants may exhibit “twisted whorls.” In these plants, the whorls may become tightly twisted and may be bent over. Such whorls typically do not unfurl on a timely basis. Twisted whorls may be caused by herbicide damage, or more often a period of good growing conditions that immediately follows poor conditions (particularly in certain hybrids, where after a change to better conditions new leaves deep in the whorl are not able to emerge because the upper whorls don't unfurl). Like purpling, twisting of the whorls does not contribute to reduced yield.

Other examples of information that may be included in a representation of plant growth include, for example and without limitation, tassels exhibiting partial ears; ear declination (e.g., premature declination); red corn plants; stunted ear (or “Beer Can Syndrome”); and kernels sprouting on the ear.

The following examples are provided to illustrate certain particular features and/or embodiments. The examples should not be construed to limit the disclosure to the particular features or embodiments exemplified.

### EXAMPLES

### Example 1

### Analytical Programming for Predicting Plant Growth

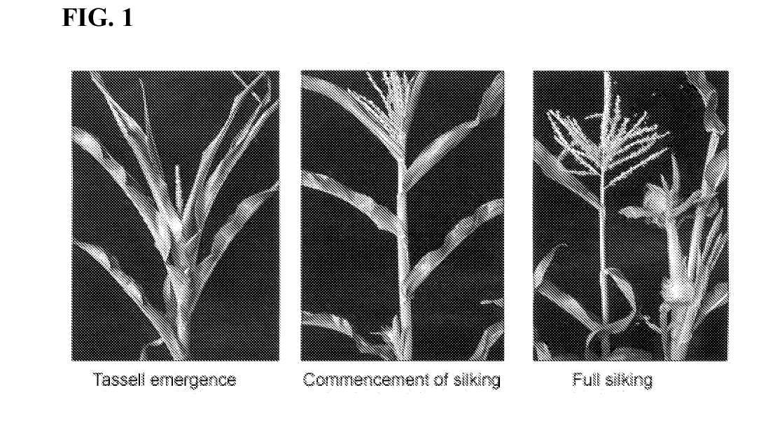

Maize growth as a function of time was predicted by compiling growth parameters for corn and using analytical programming and variables that were constructed by critically examining field growth data. Variables from existing data (e.g., height of plant at a particular day) were identified and compiled in an .XML file. The analytical programming was constructed to predict corn growth, beginning with root growth and progressing through harvest. The program was constructed to predict and generate representations of all the intermediate stages of corn growth (for example, those depicted in FIG. 1). No description or list existed of the variables needed to accurately model growth, so decisions regarding the necessary variables and values therefore were made.

All of the sources consulted contained missing data and information that were necessary to provide a visual representation of the growth of the corn plants described therein. For example, previous models with internodes did not have information on the length of the leaf sheath, and the growth of the leaf is separate from the growth of the internode. Thus, data was necessarily gathered from multiple sources that described the growth of different plants under different conditions. Nonetheless, even the combination of available sources lacked necessary data. Once all the data available was assembled, calculations were performed to provide estimates of the missing data.

A particularly difficult aspect of developing the prediction was determining the specific times at which different components of the plant grow. For example, the number of leaves that should be visible at a particular time, as well as the specific times at which: a particular leaf emerges and becomes visible; particular internodes elongate; and particular leaves wilt, were all determined. Other details that were not apparent from available data included the length of a leaf upon its initial visibility, and the length of the leaf when it is fully mature. While some of these aspects of corn growth are not necessary to answer specific scientific questions posed in the published literature, they are necessary to provide an anatomically and visually accurate depiction of a simulated corn plant at multiple points in its development. The difficulty of constructing a functioning analytical program using the available information was highlighted by the fact that the first program that was designed to predict corn growth did not accurately predict growth.

In the analytical programming for predicting corn growth, the day after planting at which each different growth stages occurs was designated according to average values, where the values were rounded up or down to avoid the occurrence of two growth stages on the same day. Table 4. Some individual values were also omitted from the average, so as to prevent the occurrence of a later growth stage at a time prior to an earlier growth stage.

TABLE 4
Average days after planting at which
specific corn growth stages occur.

| Plant stage | Days after planting |
|---|---|
| VE | 9 |
| V1 | 14 |
| V2 | 15 |
| V3 | 24 |
| V4 | 28 |
| V5 | 29 |
| V6 | 34 |
| V7 | 35 |
| V8 | 39 |
| V9 | 42 |
| V10 | 45 |
| V11 | 44 |
| V12 | 49 |
| V13 | 50 |
| V14 | 55 |
| V15 | 59 |
| V16 | 64 |
| V17 | 66 |
| V18 | 68 |
| V19 | 70 |
| V20 | 72 |
| VT | 71 |
| R1 | 76 |
| R2 | 87 |
| R3 | 96 |
| R4 | 102 |
| R5 | 113 |
| R6 | 134 |

The growth of corn internodes was simulated according to the values set forth in Table 5. Further, several observations regarding internode growth and development were modeled, including: (1) internodes emerge and elongate in a staggered fashion-deceleration of elongation in a first internode is accompanied by accelerated elongation in the three internodes above the first internode; (2) cessation of elongation in a first internode is accompanied by initiation of elongation in the internode that is four nodes above the first internode; (3) the rate of internode growth is uniform between days 1-3; (4) the most rapid internode growth occurs between days 5-9; (5) at day 10, elongation is not detectable; (6) internodes do not have a constant rate of growth-growth begins slowly, reaches a peak during mid- to late development, and then slows; (7) internodes associated with ear growth are shorter than those without ears; (8) most of the corn plant's height is comprised in internodes 8-12; (9) internodes 8-12 elongate at the fastest rate; (10) leaf elongation was assumed to follow internode elongation; (11) the area of each leaf increases for leaves until the leaf below the ear leaf; and (12) leaf area decreases for each leaf above the ear leaf on the stalk. See Morrison et al. (1994) Crop Sci. 34:1055-60; see also Fournier and Andrieu (1998) Ann. Botany 81:233-50.

TABLE 5
Stem and internode growth parameters.

| | Final stem | Internode | Total days | Final |
|---|---|---|---|---|
| Internode | diameter | elongation | of | length |
| # | (cm) | (mm/day) | elongation | (mm) |
| 1 | 2.3 | | | |
| 2 | 2.3 | | | |
| 3 | 2.3 | | | |
| 4 | 2.3 | | | |
| 5 | 2.3 | | | |
| 6 | 2.3 | | | |
| 7 | 2.3 | 6 | 9.7 | 100 |
| 8 | 1.94 | 9.3 | 10 | 137 |
| 9 | 1.77 | 9.5 | 9.7 | 135 |
| 10 | 1.6 | 9.2 | 10.5 | 136 |
| 11 | 1.43 | 9.6 | 11 | 134 |
| 12 | 1.26 | 8.6 | 12 | 133 |
| 13 | 1.09 | 8 | 13 | 125 |
| 14 | 0.92 | 6.5 | 12 | 115 |
| 15 | 0.75 | 8.4 | 10 | 123 |
| 16 | 0.58 | | | 110 |
| 17 | 0.41 | | | 85 |
| 18 | 0.24 | | | 82 |
| 19 | 0.07 | | | |

The total elongation was estimated from the median height of V1 plants. The elongation start and end days were estimated based on a growth of 9.55 mm/day. The elongation start day was designated to be approximately 9 days after planting, because VE was designated to occur approximately 9 days after planting. The start date of node elongation was staggered, based on the observation that node 4 nodes above will start growth when the node 4 nodes below ceases elongation. The number of days of elongation was rounded to the nearest whole number, based on an approximate rate of growth of 9.55 cm/day. Thus, for some nodes, the actual rate of growth will be faster.

The days at which internode elongation was determined to start and end are listed in Table 6. The elongation of internodes was also defined, and calculations were performed to estimate the height of represented plants from the elongation.

In some cases, the calculated elongation parameters were adjusted to obtain specific desired results. For example, the elongation end day for node 5 was designated to be day 16 (instead of day 15), so that it would grow for a longer period of time than the preceding node. With regard to node 13, the rate of internode elongation was assumed to be 7 mm/day. The elongation end day for node 13 was designated such that this node would not stop growing before node 12. The rate of internode elongation was assumed to be 6.5 mm/day for node 14, and 8.4 mm/day for node 15.

TABLE 6
Internode elongation information.

| | | Elon- | Elon- | Start | End |
|---|---|---|---|---|---|
| | | gation | gation | Day | Day |
| | | Start | End | “Off- | “Off- |
| Node | Stage | Day | Day | set” | set” |
| 1 | VE-V1 | 1 | 6 | 10 | 15 |
| 2 | V1-V2 | 3 | 7 | 12 | 16 |
| 3 | V2-V3 | 4 | 9 | 13 | 18 |
| 4 | V3-V4 | 5 | 15 | 14 | 24 |
| 5 | V4-V5 | 6 | 16 | 15 | 25 |
| 6 | V5-V6 | 7 | 22 | 16 | 31 |
| 7 | V6-V7 | 9 | 27 | 18 | 36 |
| 8 | V7-V8 | 15 | 33 | 24 | 42 |
| 9 | V8-V9 | 16 | 30 | 25 | 39 |
| 10 | V9-V10 | 22 | 36 | 31 | 45 |
| 11 | V10-V11 | 27 | 41 | 36 | 50 |
| 12 | V11-V12 | 33 | 47 | 42 | 56 |
| 13 | V12-V13 | 30 | 48 | 39 | 57 |
| 14 | V13-V14 | 36 | 54 | 45 | 63 |
| 15 | V14-V15 | 41 | 56 | 50 | 65 |
| 16 | V15-V16 | 47 | 58 | 56 | 67 |
| 17 | V16-V17 | 48 | 74 | 57 | 83 |
| 18 | V17-V18 | 54 | 75 | 63 | 84 |
| 19 | V18-V19 | 56 | 76 | 65 | 85 |
| Tassel | | | | | |
| | | | | Leaf- | Start- |
| | Total | Total | Final | Stem | Length |
| | Elon- | Plant | Node | Start- | Descrip- |
| Node | gation | Height | Length | Length | tion* |
| 1 | 6.35 | 6.35 | 0 | 2 | |
| | cm | cm | | | |
| 2 | 4.27 | 10.62 | 0 | 6.35 | |
| 3 | 4.62 | 15.24 | 0 | 10.62 | |
| 4 | 10.16 | 25.4 | 0 | 15.24 | |
| 5 | 8.89 | 34.29 | 0 | 25.4 | |
| 6 | 13.97 | 48.26 | 2.5 | 34.29 | |
| 7 | 17.78 | 66.04 | 7 | 17.78 | 24.53 |
| 8 | 17.78 | 83.82 | 12 | 17.78 | 20.3 |
| 9 | 13.5 | 97.32 | 16 | 13.5 | 20.3 |
| 10 | 13.6 | 110.92 | 18 | 13.6 | 20.05 |
| 11 | 13.4 | 124.32 | 17 | 13.4 | 19.55 |
| 12 | 13.3 | 137.62 | 19 | 13.3 | 18.25 |
| 13 | 12.5 | 150.12 | 19 | 12.5 | 17.65 |
| 14 | 11.5 | 161.62 | 18 | 11.5 | 17.34 |
| 15 | 12.3 | 173.92 | 16 | 12.3 | 22.83 |
| 16 | 10.08 | 184 | 17 | 10.08 | 34.875 |
| 17 | 25.5 | 209.5 | 16.5 | 25.5 | 28.125 |
| 18 | 18.75 | 228.25 | 16 | 18.75 | 18.75 |
| 19 | 18.75 | 247 | 15 | 18.75 | 4 |
| Tassel | | | 30 | | |
| Sum of | | | 239 | | |
| Node | | | | | |
| Lengths** | | | | | |

*The start length for the leaves without internode elongation is static. The start for the others is based on following elongation length + ( 1/2 of the following leafnode)
**Used as a reference for testing the final height of the internodes after growth by comparison

Table 7 contains information that was used to establish the length of a leaf sheath in relation to the internodes that the sheath will cover. For example, leaf 6 is associated with node 6. Thus, the sheath of leaf 6 is designated as having a length that covers ½ of node 7. The information in Table 8 was used to provide for adjustment a baseline for plant height, measured from the leaf canopy.

TABLE 7
Leaf sheath length information.

| Leaf | Node | Nodes sheath covers | Description |
|---|---|---|---|
| 1 | 1 | | |
| 2 | 2 | | |
| 3 | 3 | | |
| 4 | 4 | 6.00 | |
| 5 | 5 | 6.50 | |
| 6 | 6 | 7.50 | covers to ½ of 7 |
| 7 | 7 | 8.50 | |
| 8 | 8 | 9.50 | |
| 9 | 9 | 10.50 | |
| 10 | 10 | 11.50 | |
| 11 | 11 | 12.50 | |
| 12 | 12 | 13.50 | |
| 13 | 13 | | |
| 14 | 14 | | |
| 15 | 15 | | |
| 16 | 16 | | |
| 17 | 17 | | |
| 18 | 18 | | |
| 19 | 19 | | |

TABLE 8
Plant height.

| Corn growth stage | Plant height (cm) |
|---|---|
| V1 | 5.08-7.62 |
| V2 | 7.62-12.7 |
| V3 | 10.16-15.24 |
| V3 | 20.32 |
| V4 | 15.24-25.4 |
| V4 | 30.48 |
| V5 | 30.48-38.1 |
| V5 | 20 |
| V6 | 35.56-60.96 |
| V6 | 30.48 |
| V7 | 55.88-76.2 |
| V8 | 76.2-91.44 |
| V15 | 160 |
| V16 | 184 |
| V17 | 204 |
| V17 | 215 |
| V19 | 249 |
| V19 | 247 |
| V20 | 237 |

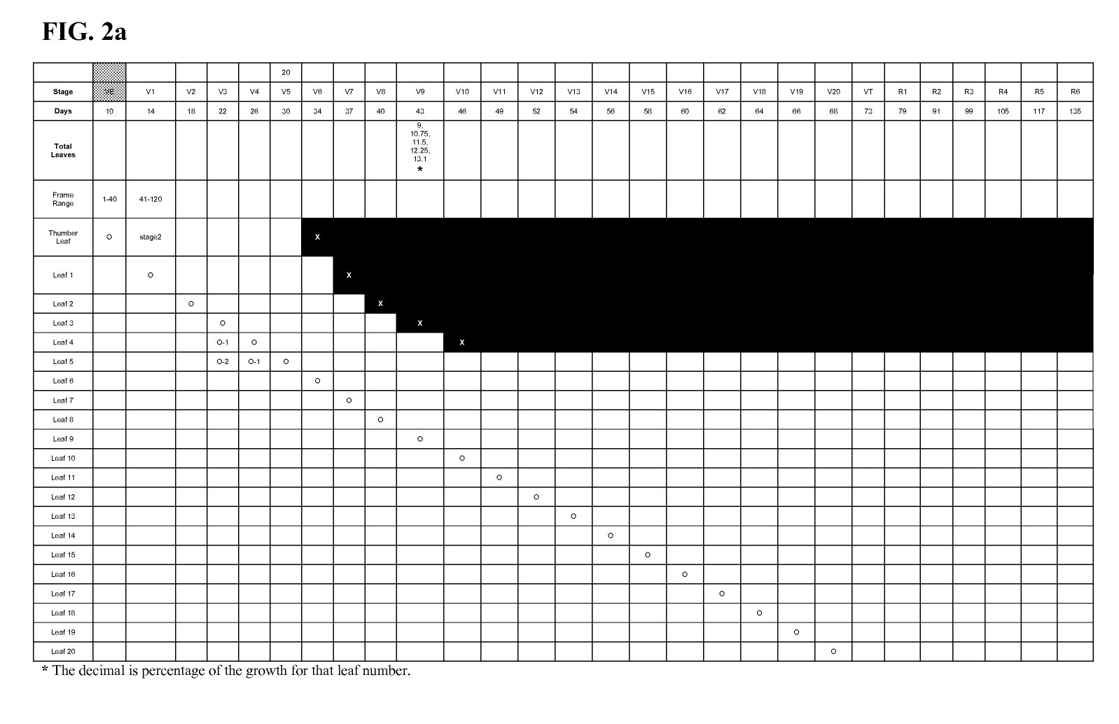

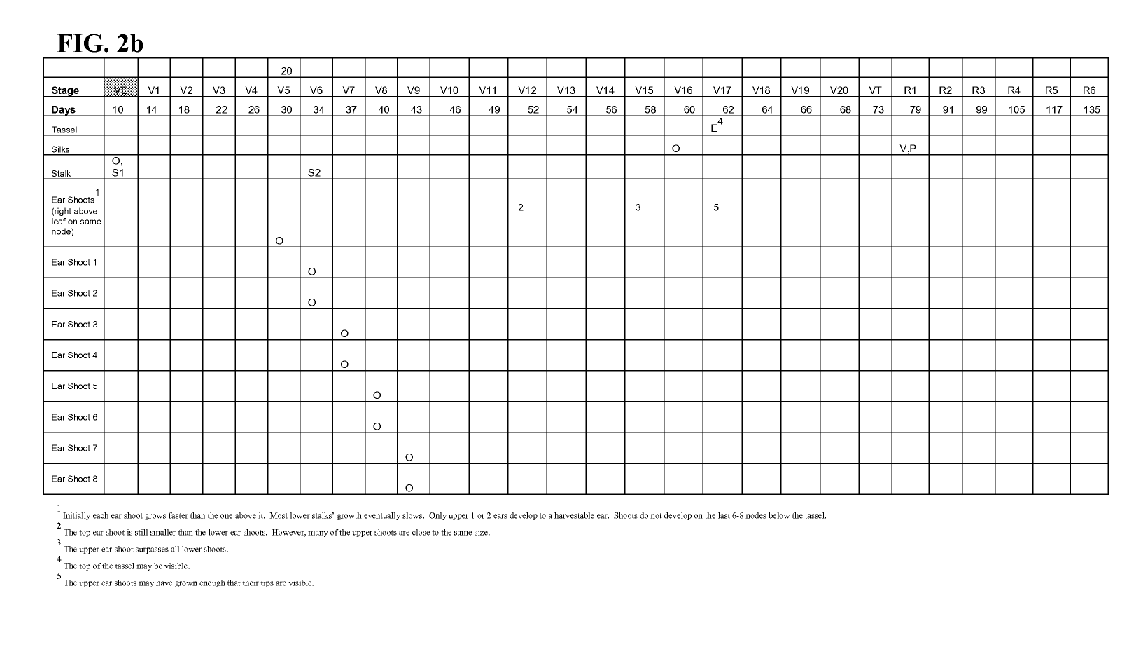

Relationships between corn growth stages were derived. FIG. 2. The information in Table 9 was used to precisely designate growth parameters, including when leaf collars are visible. This information includes the results of calculations based on when a leaf should begin to grow (as opposed to when it is visible). This information was used in the analytical programming for predicting growth to generate the leaf components and represent their growth patterns.

TABLE 9
Growth values
a.

| | Days after | Days after | Days after Seeding Avg. | | | 40-50% of Leaf |
|---|---|---|---|---|---|---|
| Stage | Seeding Range1 | Seeding Range2 | (Collar Visible) | End Day | Days/Stage | Visible |
| Seed to | | | | 7 | 7.5 | |
| emergence | | | | | | |
| VE | | | | | 3 | |
| V1 | 10 | 17 | 14 | | 3 | 2 |
| V2 | 13 | 20 | 17 | 9 | 3 | 3 |
| V3 | 16 | 23 | 20 | | 3 | 4 |
| V4 | 19 | 26 | 23 | 24 | 3 | 5-6 |
| V5 | 22 | 29 | 26 | | 3 | 7 |
| V6 | 25 | 32 | 29 | 37 | 3 | 8 |
| V7 | 28 | 35 | 32 | | 3 | 9-10 |
| Seed to | | | | 7 | 7.5 | |
| emergence | | | | | | |
| V8 | 31 | 38 | 35 | 47 | 3 | 11 |
| V9 | 34 | 41 | 38 | | 3 | 12 |
| V10 | 37 | 44 | 41 | 56 | 3 | 13 |
| V11 | 40 | 47 | 44 | | 3 | 14 |
| V12 | 43 | 50 | 47 | 65 | 3 | 15 |
| V13 | 46 | 53 | 50 | | 3 | 16 |
| V14 | 49 | 56 | 53 | 67 | 3 | 17 |
| V15 | 51 | 58 | 55 | | 2 | 18 |
| V16 | 53 | 60 | 57 | 73 | 2 | |
| V17 | 55 | 62 | 59 | | 2 | |
| V18 | 57 | 64 | 61 | 78 | 2 | |
| V19 | 59 | 66 | 63 | | 2 | |
| VT | 65 | 72 | 69 | | 4 | |

b.

| | Start Day | Start Day | | End Day | Collar Visible | Collar Visible |
|---|---|---|---|---|---|---|
| | (factoring | (not factoring | | (adjusted for | Day (factoring | Day (not factoring |
| Stage | leaf visibility) | leaf visibility) | End Day | visibility) | leaf visibility) | leaf visibility) |
| Seed to | | 0 | 7 | 7 | | |
| emergence | | | | | | |
| VE | | 4 | 7 | 7 | | |
| V1 | | 12 | 15 | 15 | 7.5 | 13.5 |
| V2 | 12 | 14 | 20 | 22 | 17 | 16.75 |
| V3 | 14 | 17 | 23 | 26 | 20 | 19.75 |
| V4 | 17 | 20 | 26 | 29 | 23 | 22.75 |
| V5 | 20 | 24 | 29 | 32 | 26 | 26.25 |
| V6 | 20 | 27 | 32 | 38 | 29 | 29.25 |
| V7 | 24 | 30 | 35 | 40 | 32 | 32.25 |
| V8 | 27 | 33 | 38 | 43 | 35 | 35.25 |
| V9 | 30 | 36 | 41 | 46 | 38 | 38.25 |
| V10 | 30 | 39 | 44 | 52 | 41 | 41.25 |
| V11 | 33 | 42 | 47 | 55 | 44 | 44.25 |
| Seed to | | 0 | 7 | 7 | | |
| emergence | | | | | | |
| V12 | 36 | 45 | 50 | 58 | 47 | 47.25 |
| V13 | 39 | 48 | 53 | 61 | 50 | 50.25 |
| V14 | 42 | 51 | 56 | 64 | 53 | 53.25 |
| V15 | 45 | 53.5 | 57 | 65 | 55 | 55 |
| V16 | 48 | 55.5 | 59 | 66 | 57 | 57 |
| V17 | 51 | 57.5 | 61 | 67 | 59 | 59 |
| V18 | 51 | 59.5 | 63 | 71 | 61 | 61 |
| V19 | 53.5 | 61.5 | 65 | 73 | 63.25 | 63 |
| VT | | 66.5 | 71 | 70.5 | | |

The silking component of growth was represented in the analytical programming for predicting growth with the parameters of: appearance at day 52 (there is one silk/embryo, or 1,000 in total, though less than half become harvested kernels. Silks are not visible at this point. Their growth is fast at first but slows quickly towards the end); visualization at day 73 (R1 starts as soon as the silk can be seen leaving the husk. The silk grows rapidly at this point, but slows down quickly over 5 days); and pollination at day 79 (The silk stops growing shortly after pollination. For this example, we considered growth to stop immediately upon pollination).

The stalk component of growth was represented in the analytical programming for predicting growth with separate parameters for different stages of growth. For example, growth below the soil and growth above the ground were separate stages, but these growth stages were driven according to similar predictive programming over time. The growth stage VE (and those following) were dependent upon growth processes below the soil. The growth of roots below the soil continued even after the VE stage, and roots also became visible above the soil (i.e., brace roots). For the purpose of allowing the generation of an accurate representation of plant growth, the visibility of the stalk in the representation was separate from the actual stalk length when the plant is above the soil. The analytical programming predicted that the stalk would first be represented above ground at growth stage V6. V6 was predicted to begin on day 20, and to end on day 38.

Leaf growth was predicted according to the lengths set forth in Table 10, with a leaf width of 3.5 cm.

TABLE 10
Leaf lengths.

| Leaf no. | Leaf length (cm) |
|---|---|
| 1 | 5 |
| 2 | 10 |
| 3 | 20 |
| 4 | 27 |
| 5 | 38 |
| 6 | 50 |
| 7 | 60 |
| 8 | 70 |
| 9 | 80 |
| 10 | 85 |
| 11 | 80 |
| 12 | 78 |
| 13 | 70 |
| 14 | 60 |
| 15 | 55 |

The code structure of the analytical programming comprised three primary components: Initialization; SpawnComponent; and Controller. The initialization program was the hub of the application backend. All data was controlled by this program, which managed the loading and creation of the application, along with the generation of animated plant components. The SpawnComponent program evaluated the data loaded from an .xml file containing corn growth parameters. The .xml file was formatted as an Extensible Markup Language (XML). This markup language was used to create structure, and store and define data through a set of rules that encodes the file in a format that is easily modified and readable during the program initialization. Calculations were performed to convert data into a format that is compatible with the system. Each component of the plant had a controller program attached, which managed and controlled the growth of the component as directed by the initialization program.

Rather than creating dynamically-generated polygon meshes to represent plant components, predefined predictive programs were created. This system provided precise control over the appearance of each component, and improved application performance.

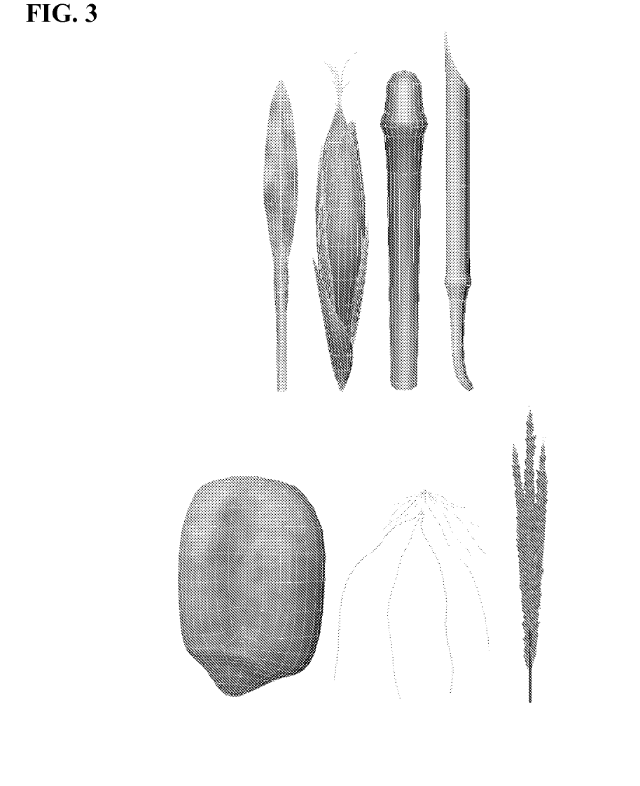

The programs created to predict corn growth predicted attributes of the following plant components: internode; ear; leaf; seed; root; earshoot; and tassel. FIG. 3 shows several such predicted component structures. Each component was predicted in varying stages that are representative of maturity over time. For example, the corn leaf has a specific predictive program during each of its emergence, opening, curling, and wilting. The first predicted component to appear was set as the base, which was morphed sequentially into each following model at the proper stage. This process created an animation of, for example, a leaf growing over time.

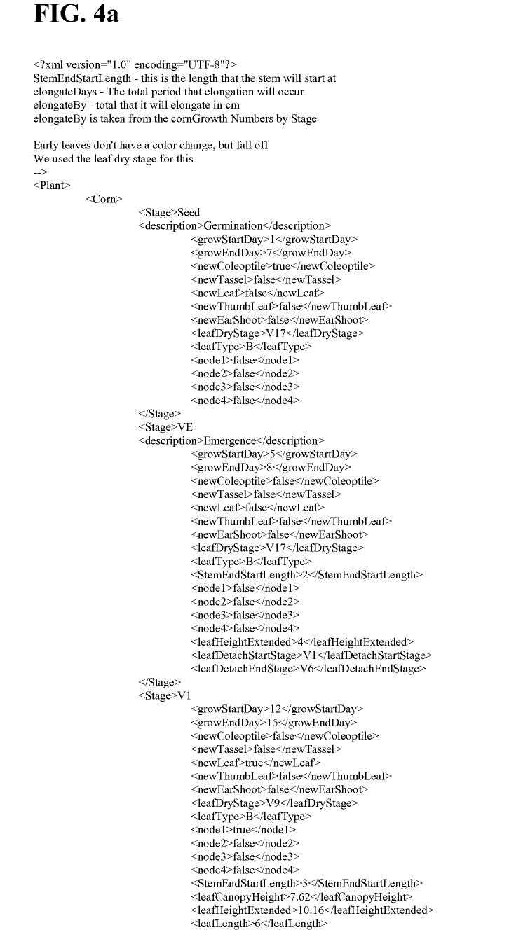

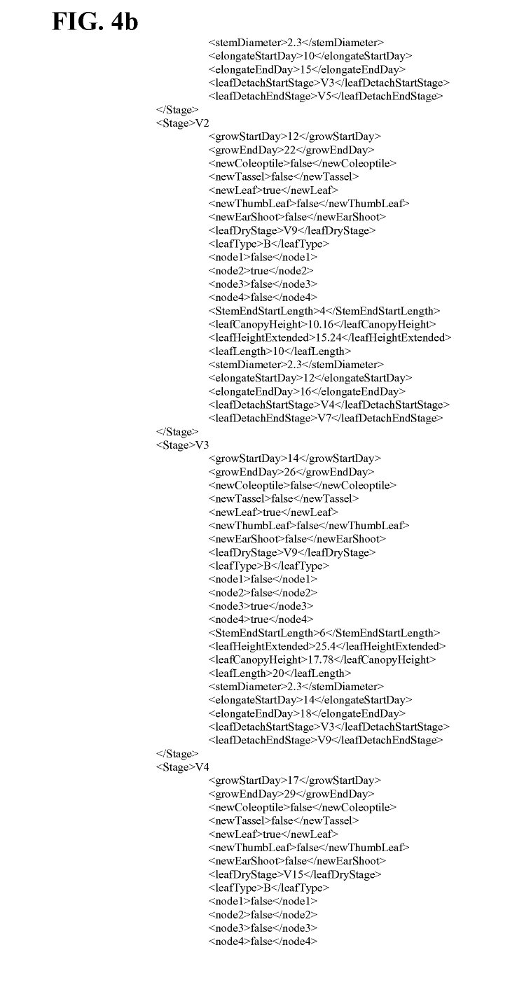

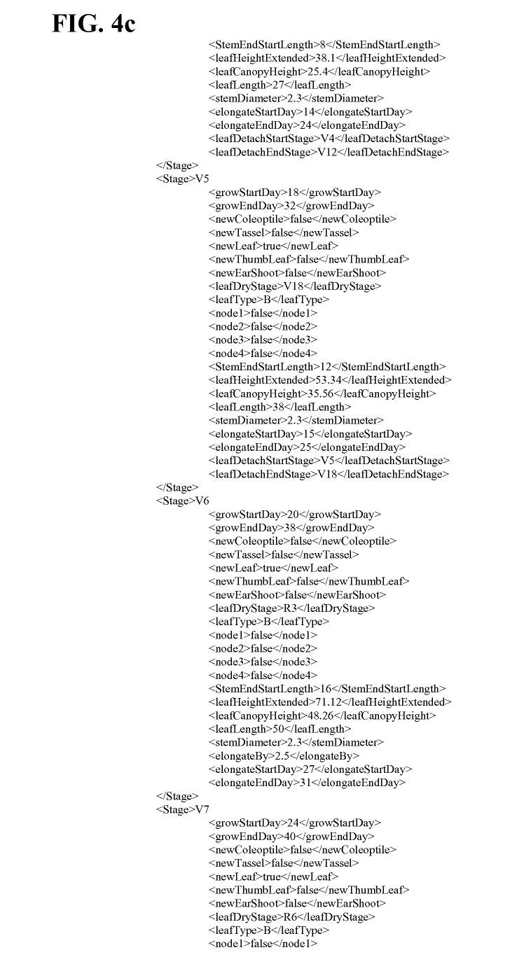

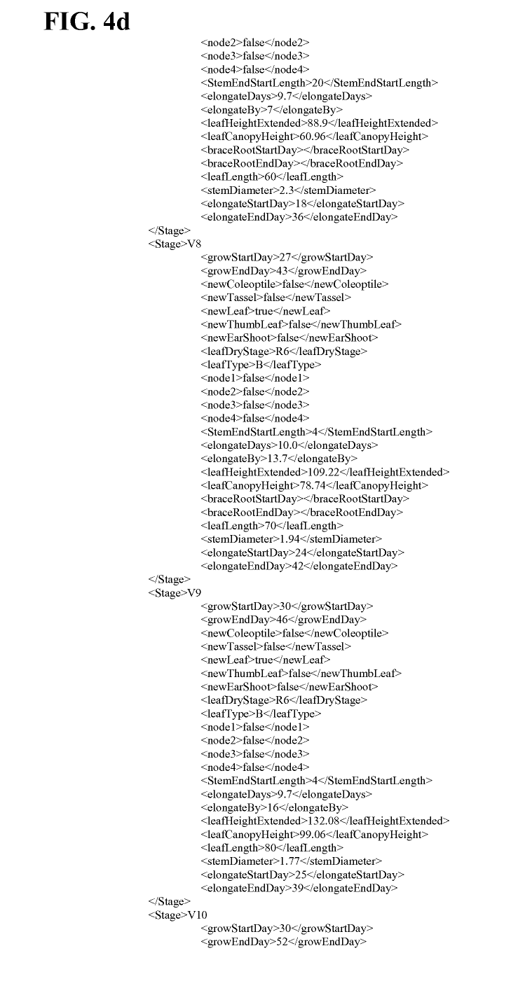

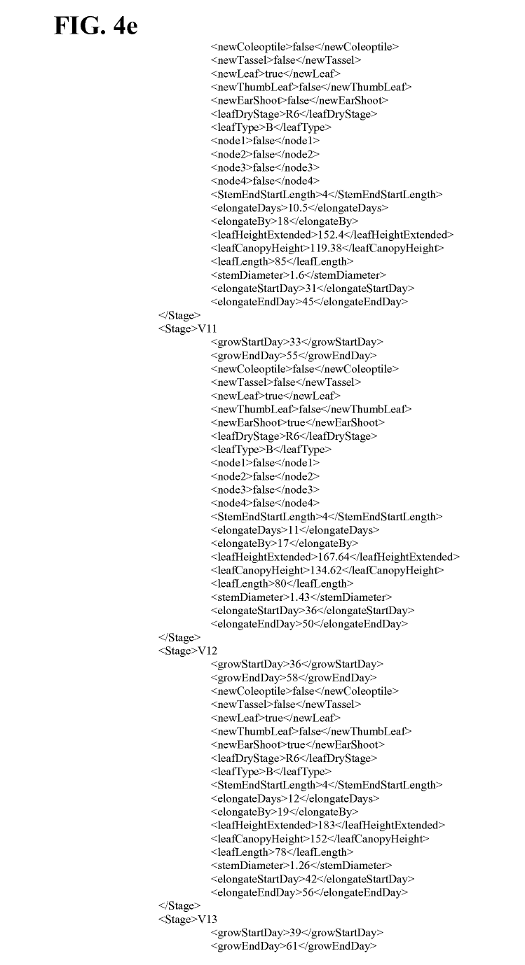

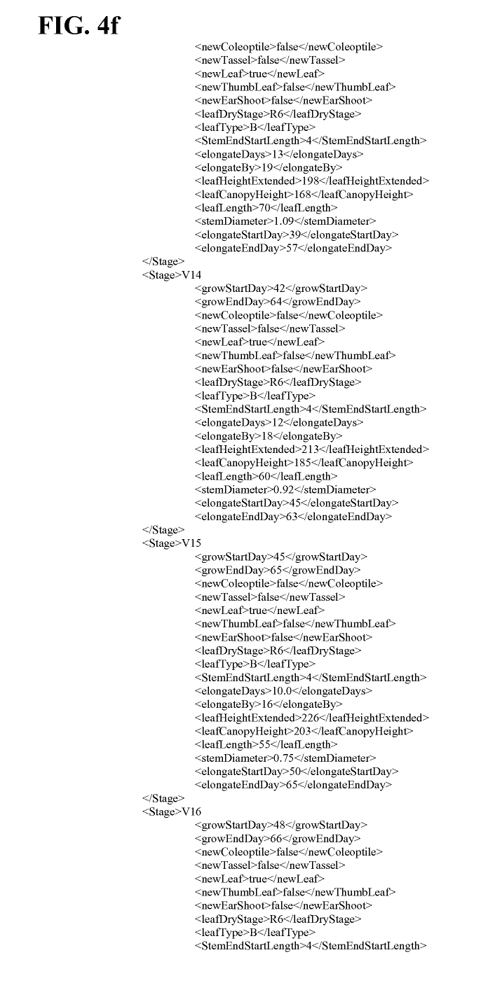

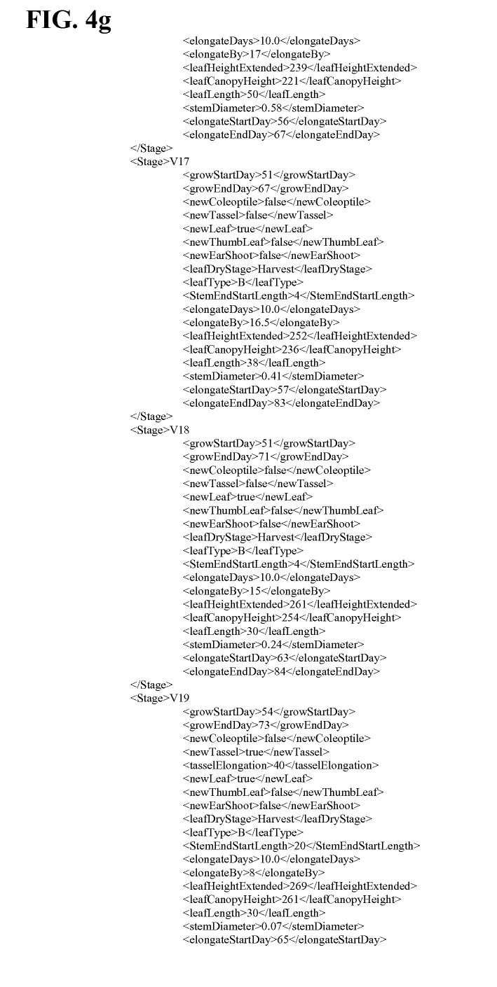

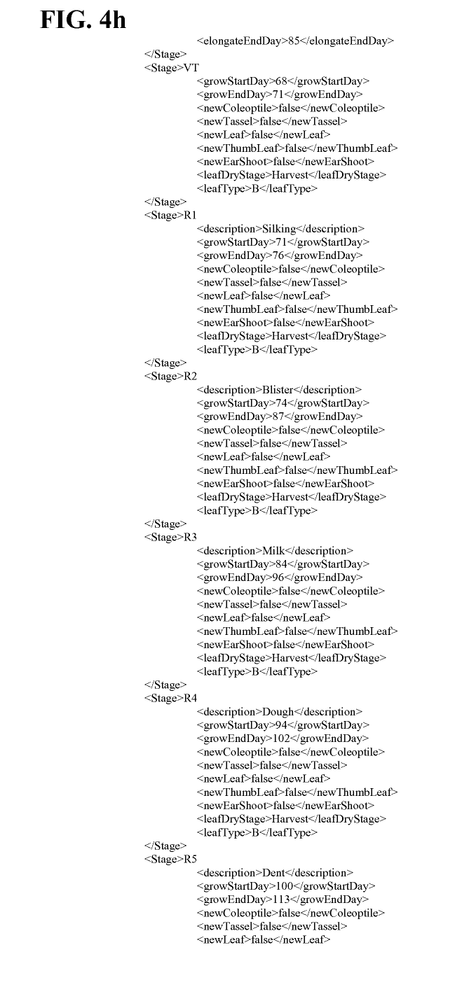

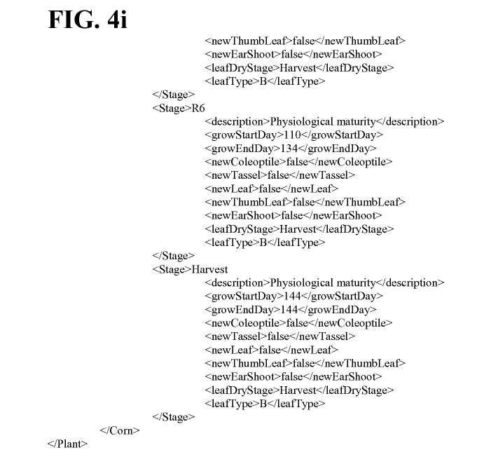

Analytical programming designed according to the foregoing included the file described in FIG. 4. This file was loaded at runtime on a computer workstation.

### Example 2

### Representation of Plant Growth Over Time

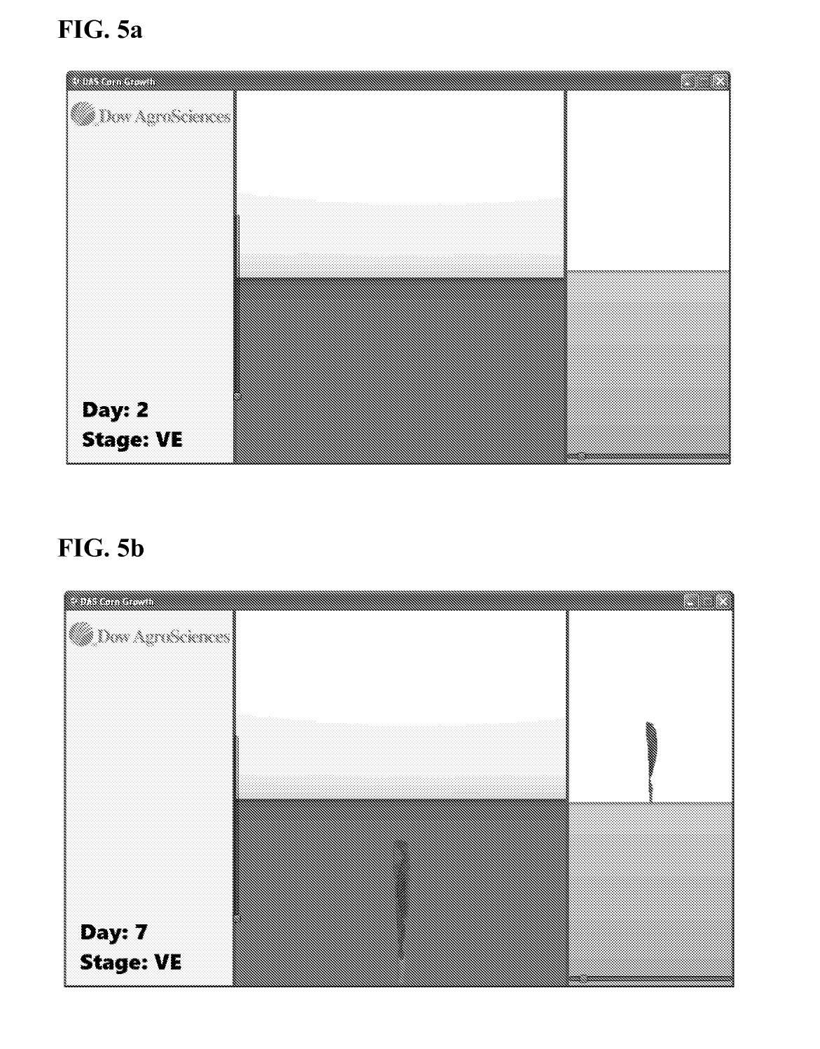

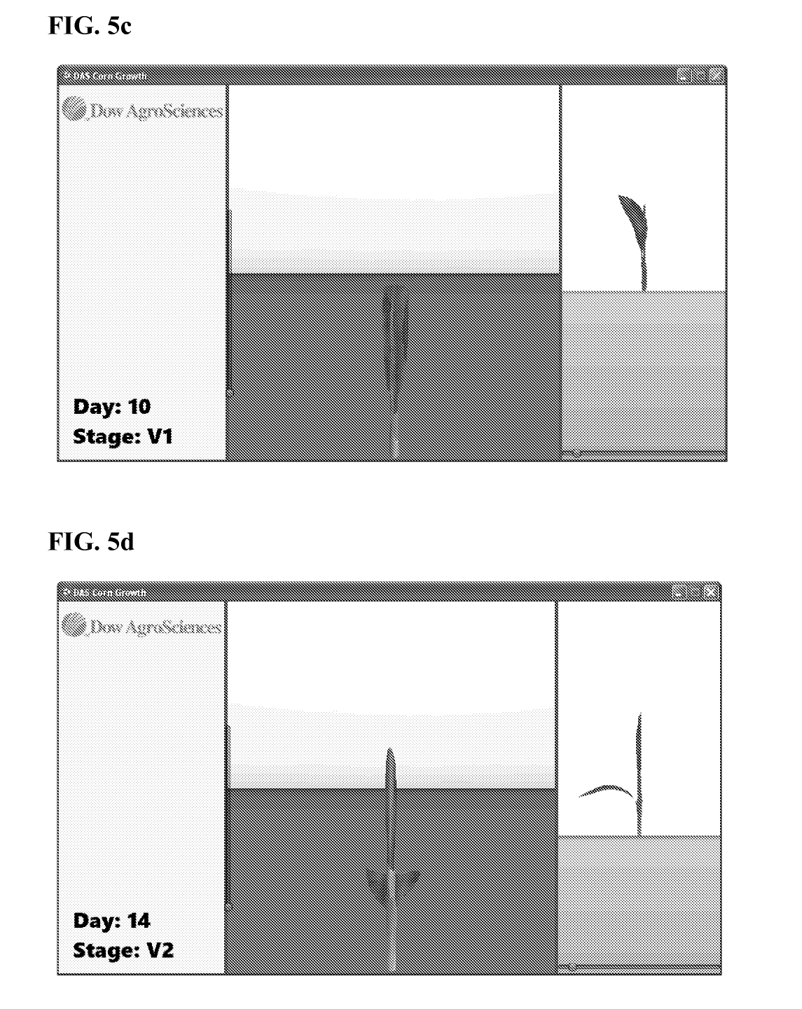

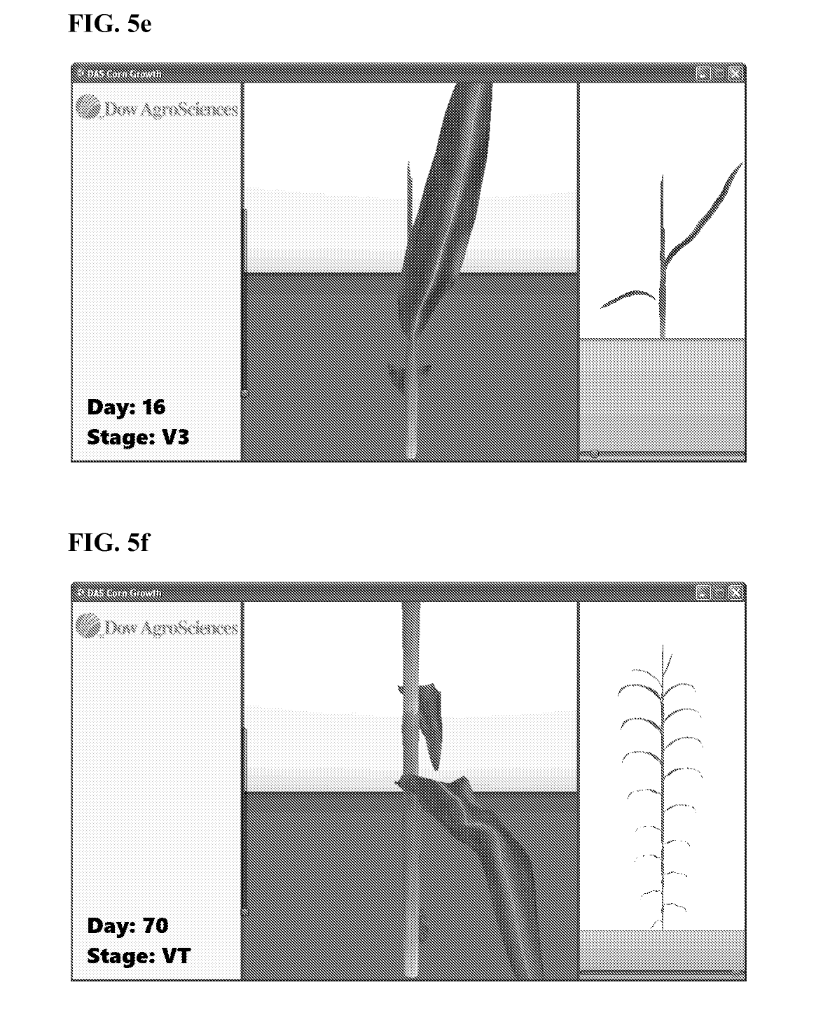

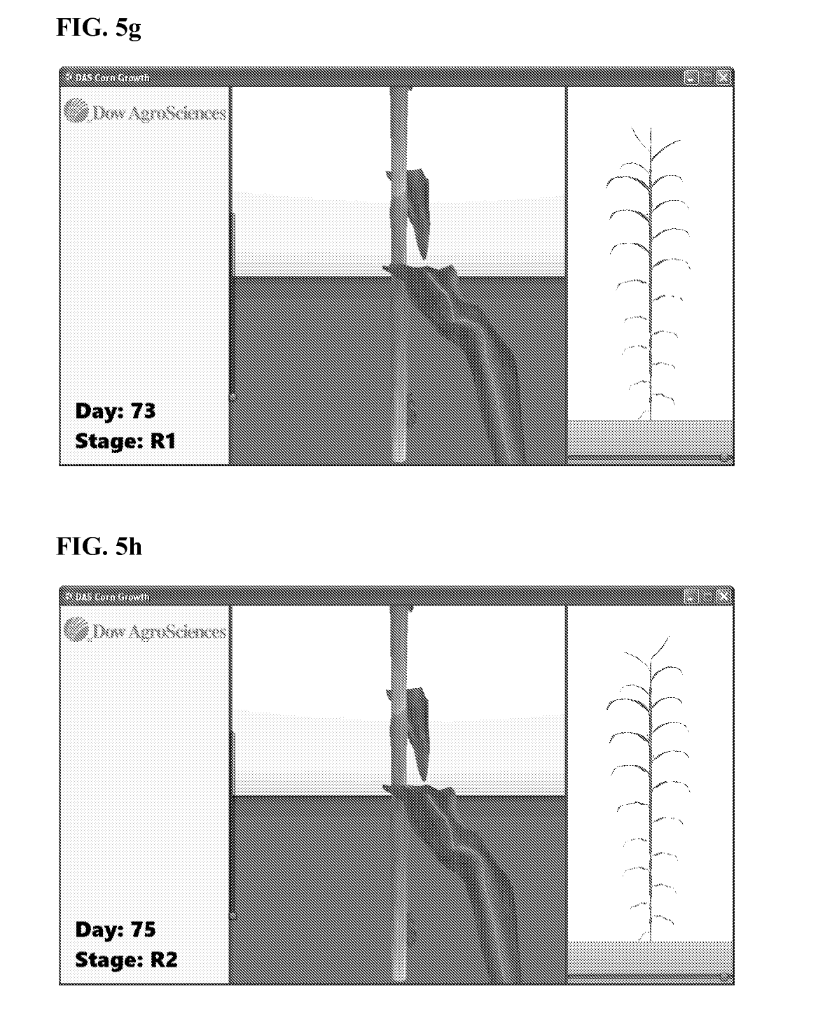

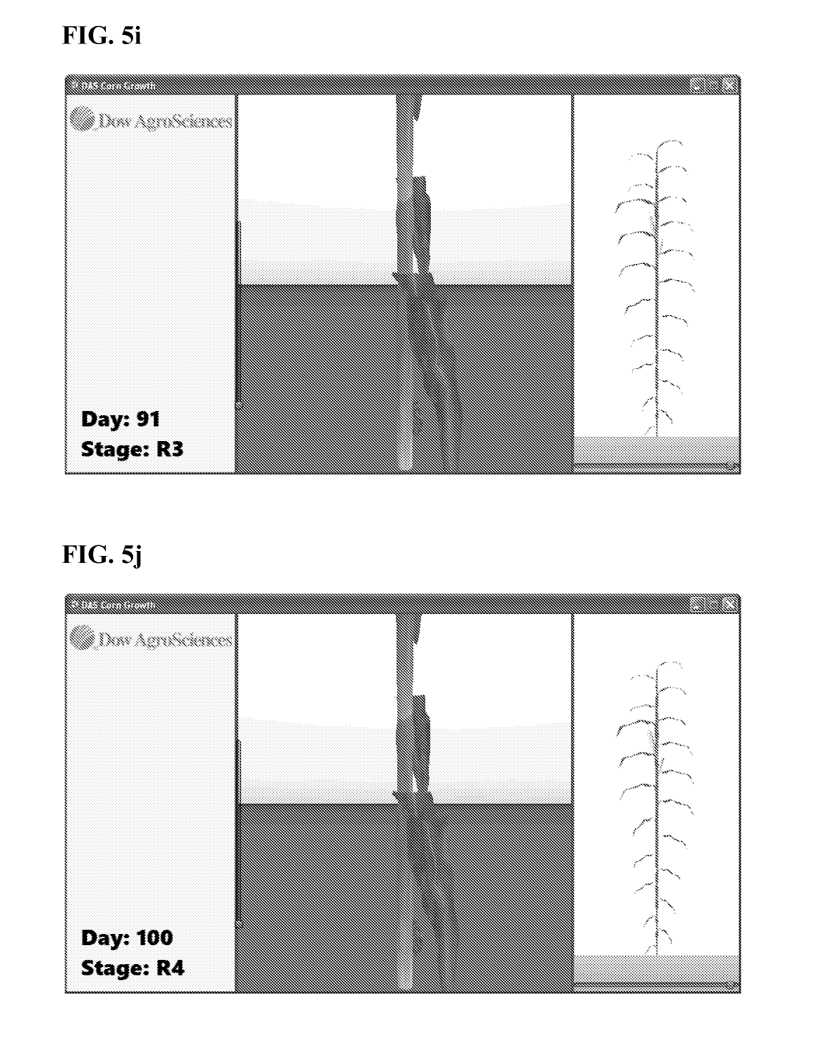

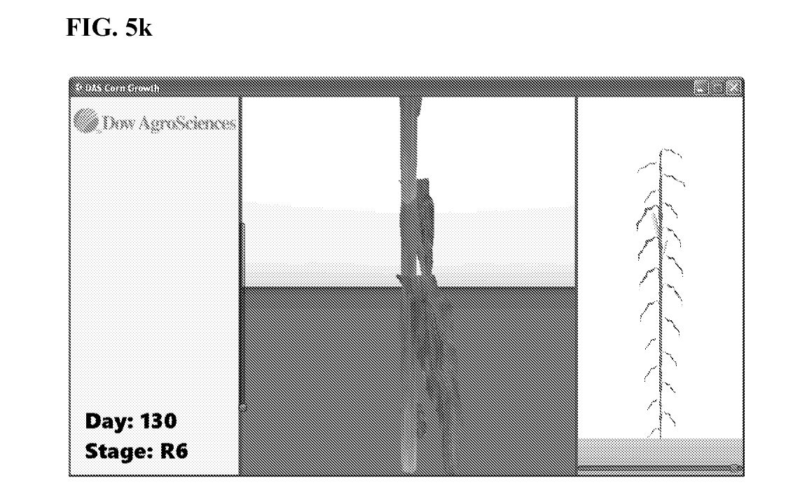

The growth of a corn plant, predicted as set forth in Example 1 (for example, using the analytical programming described in FIG. 4) was represented by a displayed computer animation representing a “growing” anatomically correct virtual three-dimensional maize plant. FIG. 5. The computer animation program was developed inside a real-time hardware rendering game engine (i.e., unity3d.com), and was demonstrated to operate on web browsers (i.e., Internet Explorer™, Safari™, Google™ Chrome, and Mozilla™ Firefox), as well as operating systems: Microsoft™ Windows, Mac OS™, and Linux™. It was also adaptable to Adobe™ Flash, Microsoft Xbox™, Sony Playstation™ 3, Nintendo™ Wii, IOS™, Windows™ Phone, and Android™

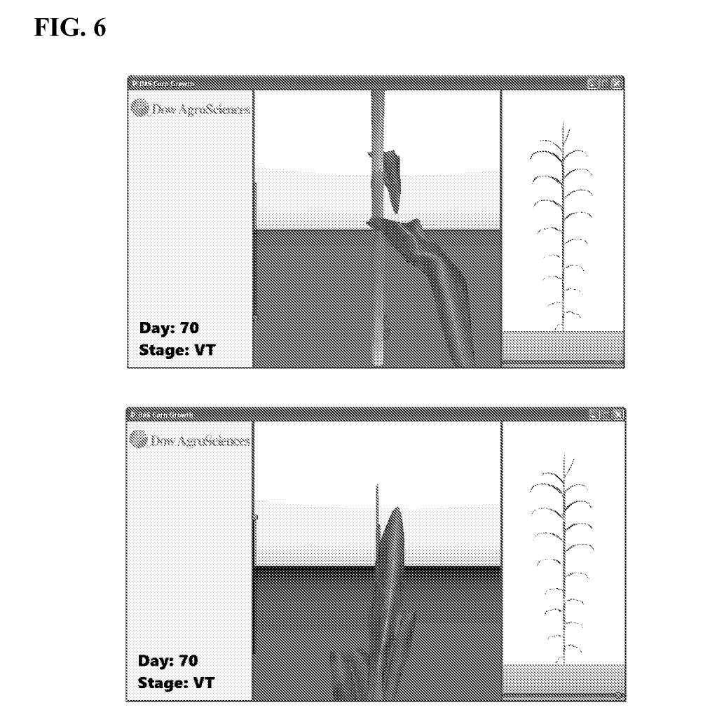

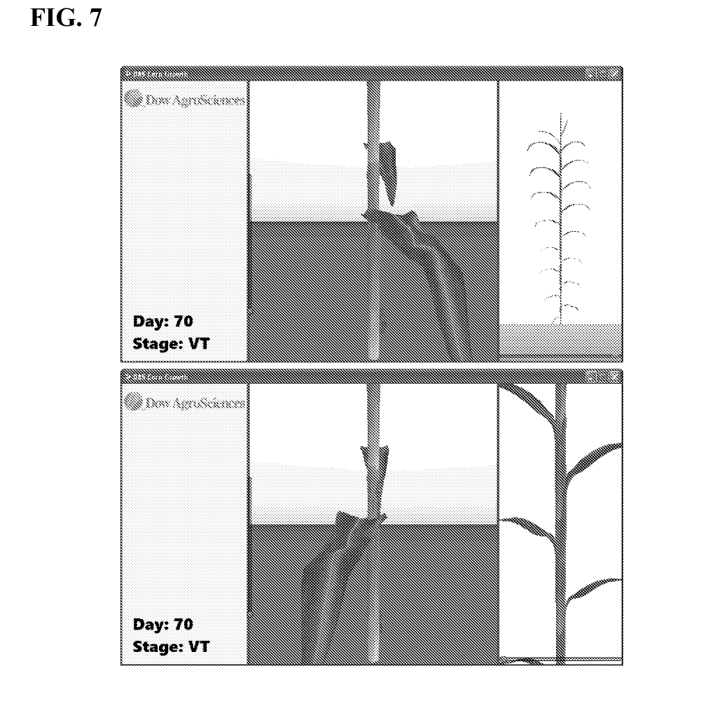

The displayed computer animation contained the functionality of allowing the user to focus on specific regions and/or structures on the plant animation (FIG. 6), and to observe the animation from different distance perspectives (FIG. 7).

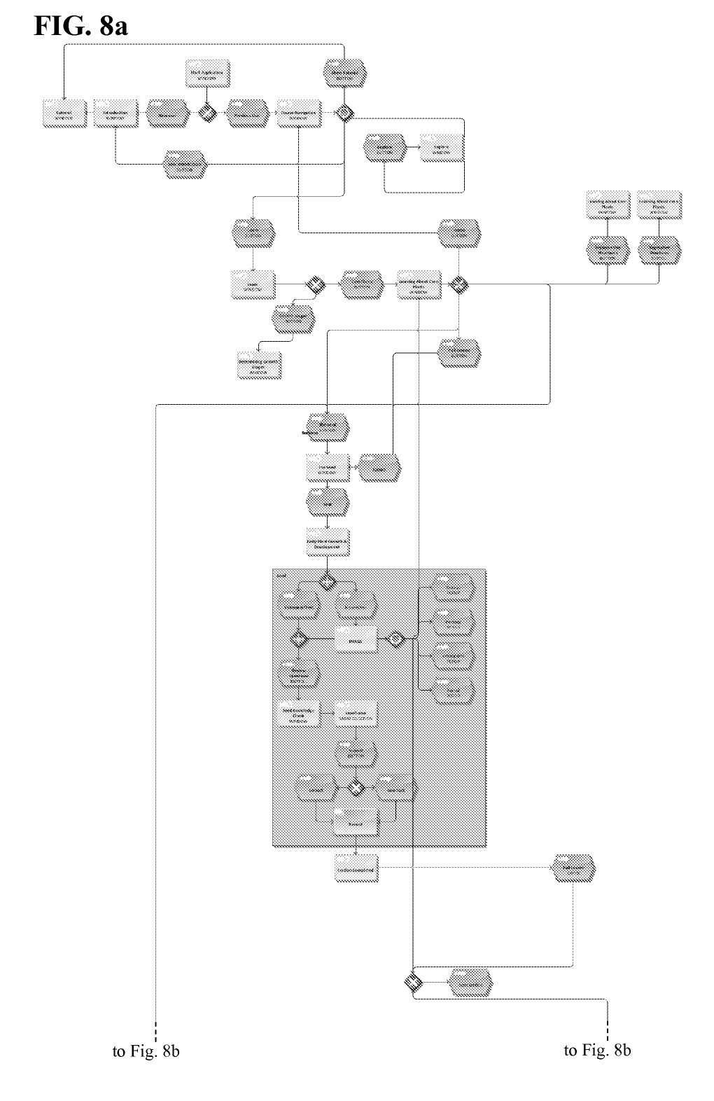

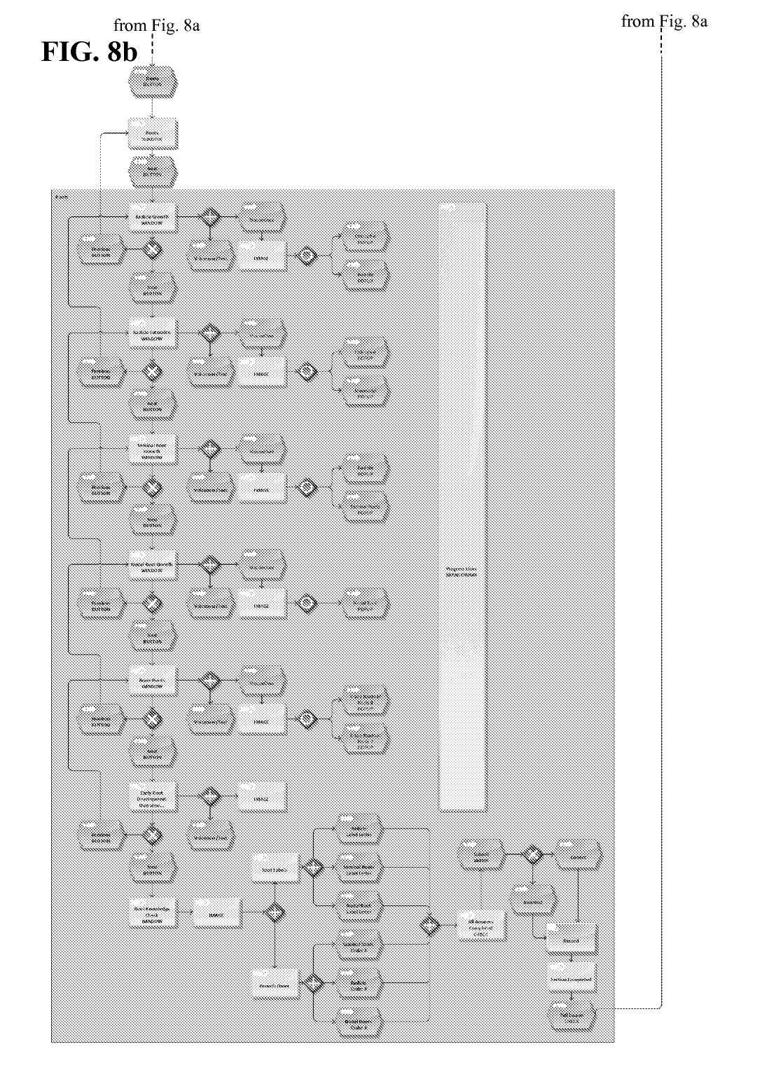

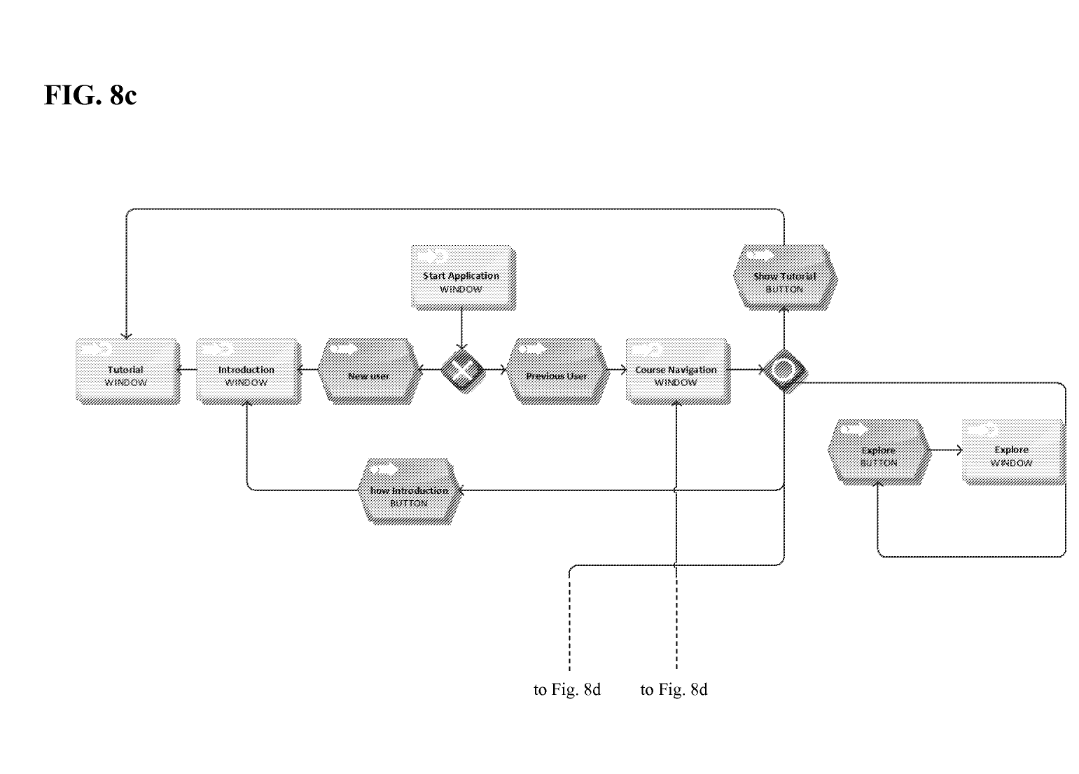

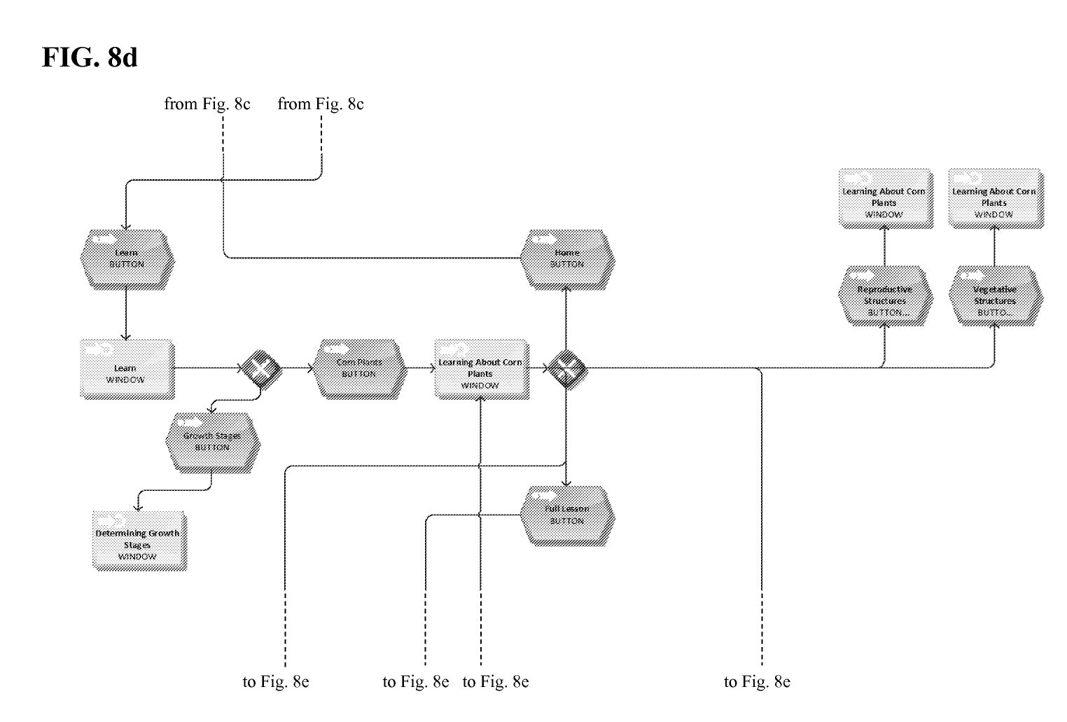

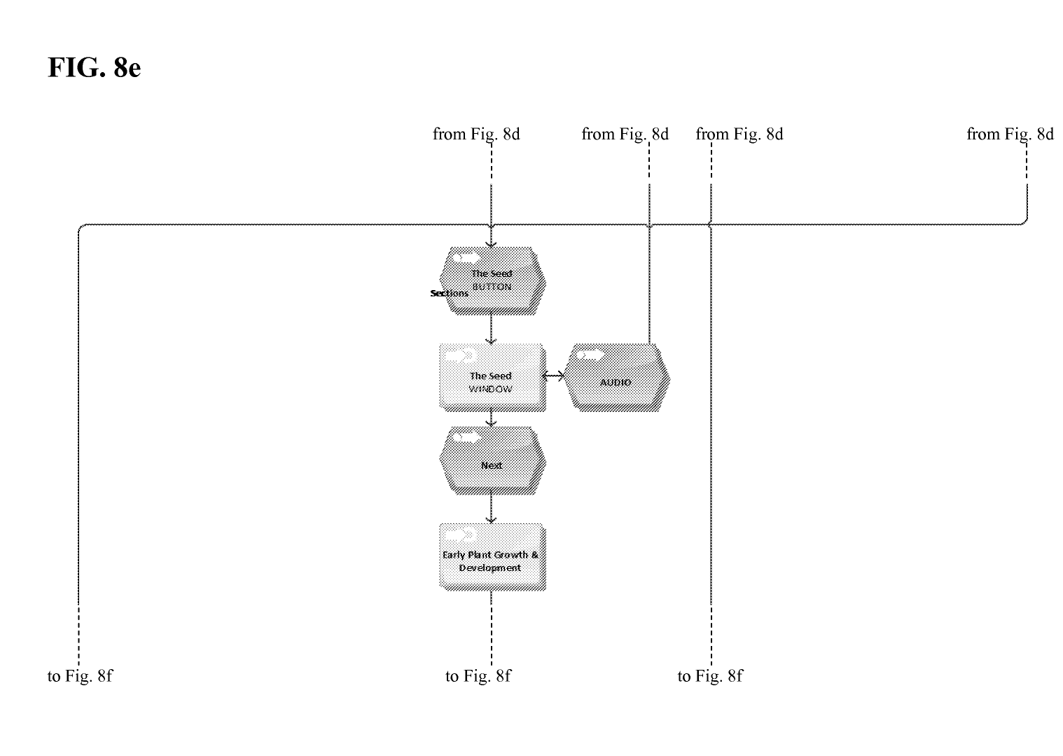

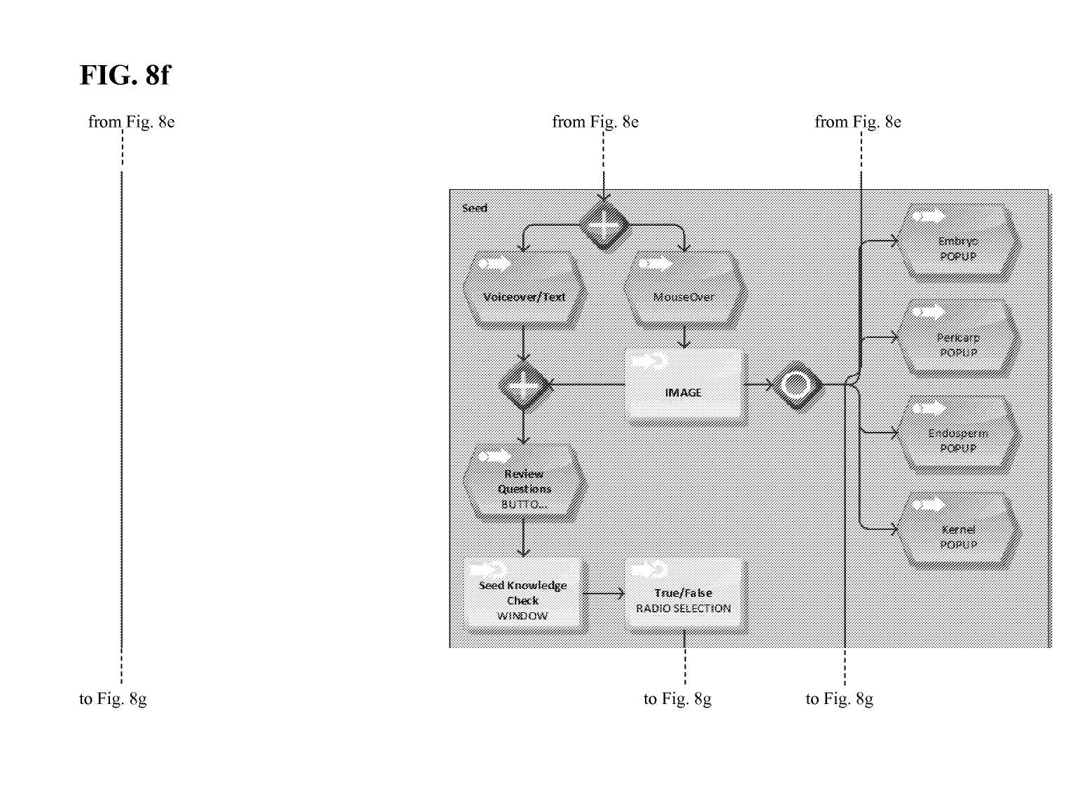

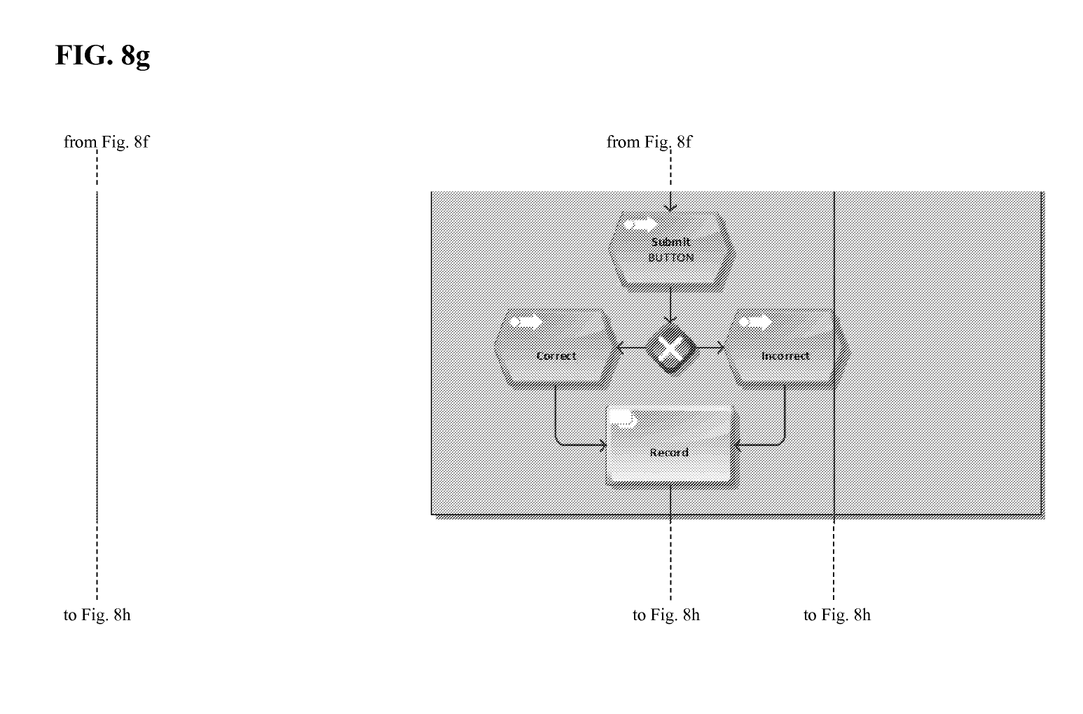

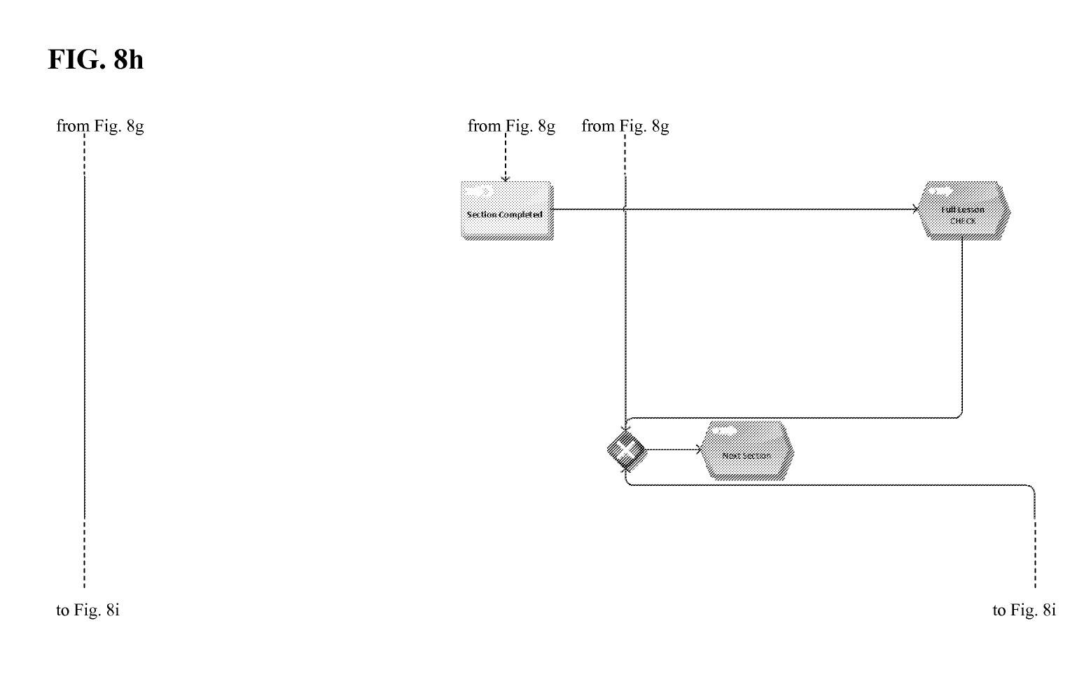

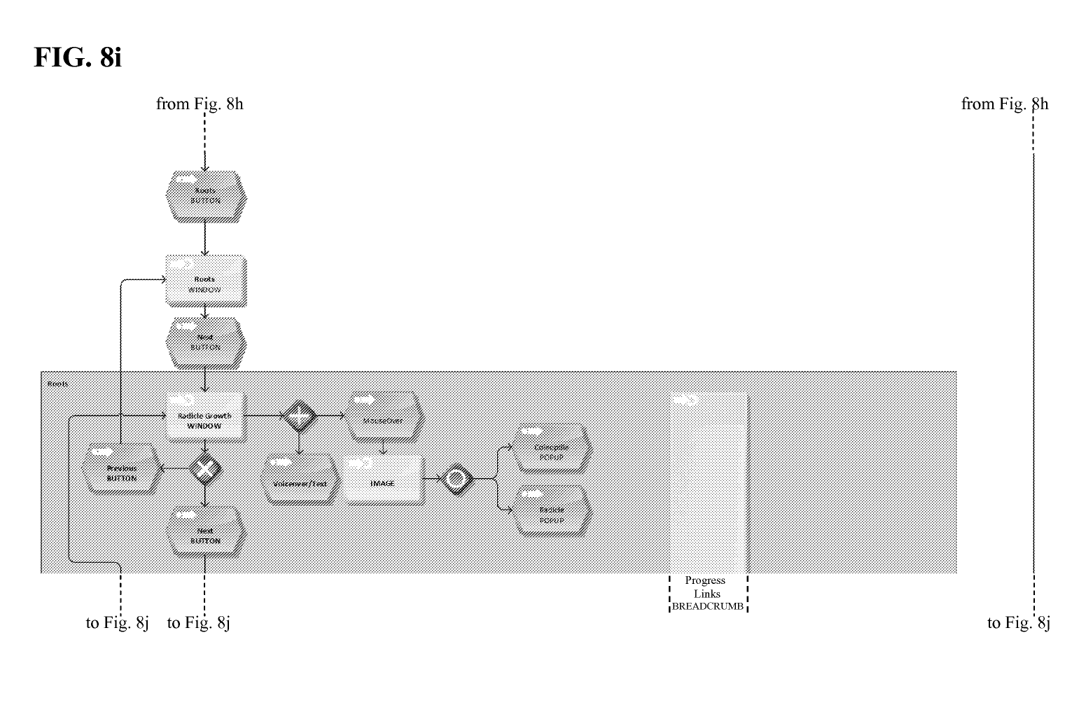

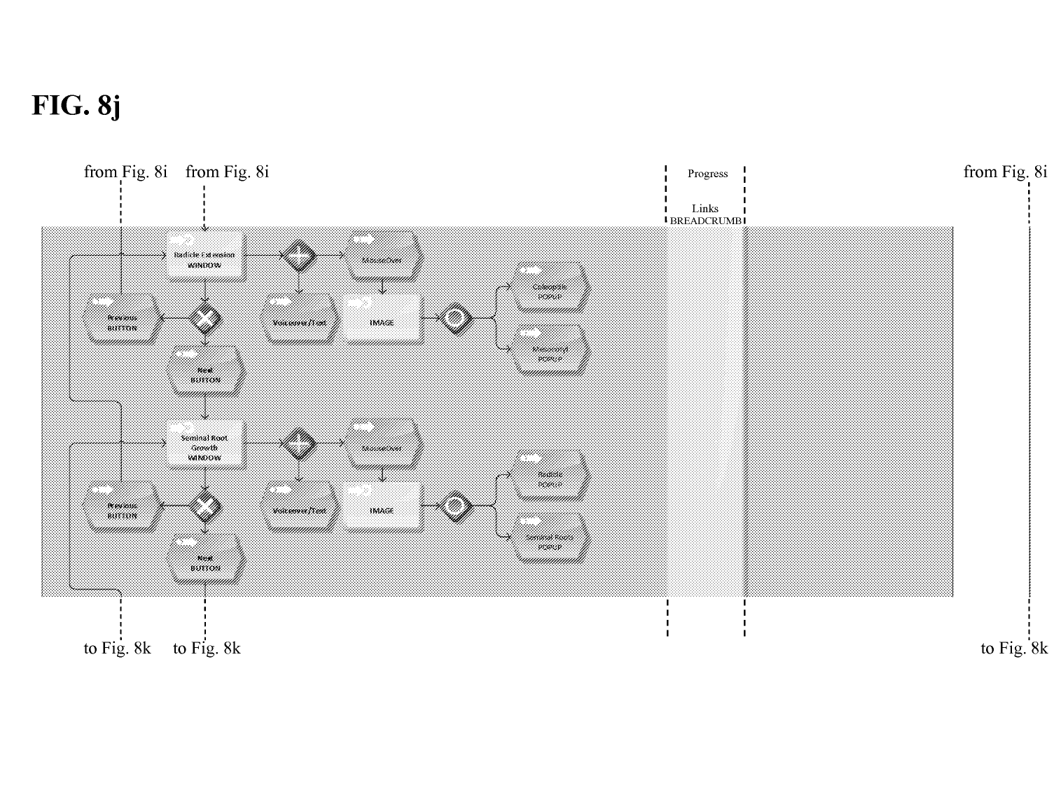

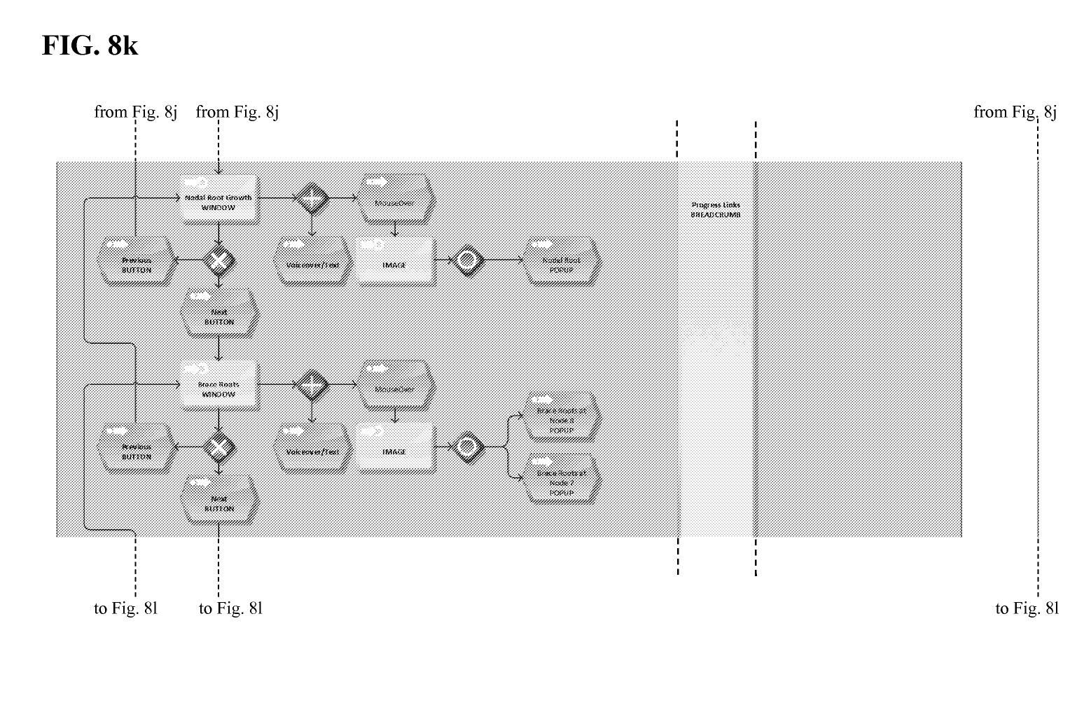

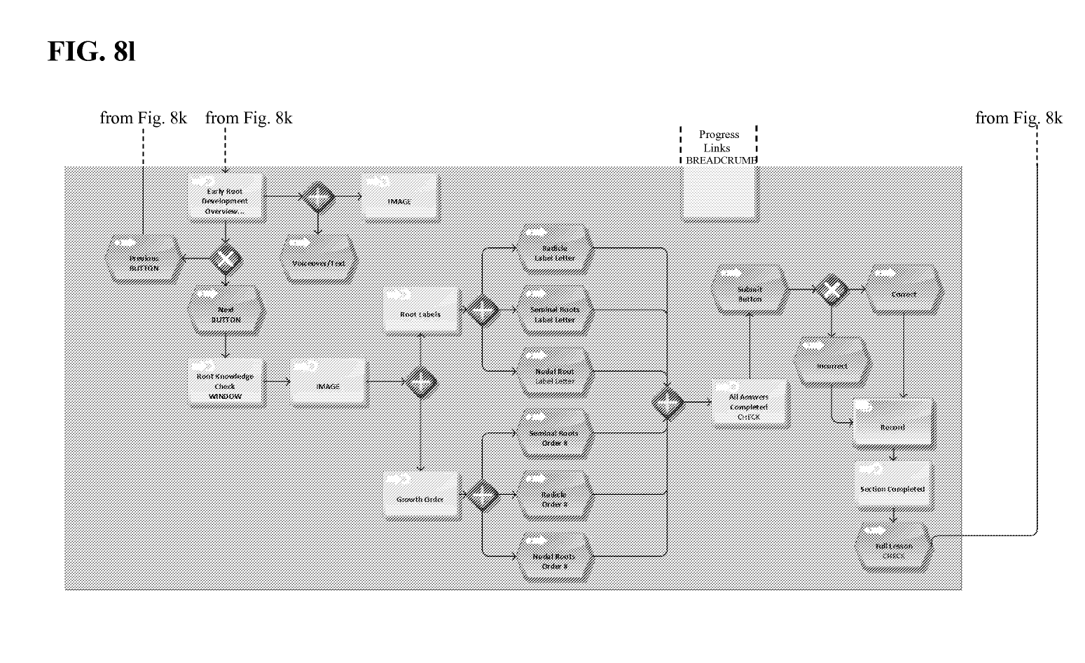

The animation program was included in a program designed to educate users about specific features and processes of corn development. FIG. 8 provides a flow chart that maps the interaction with the graphical user interface for the educational program.

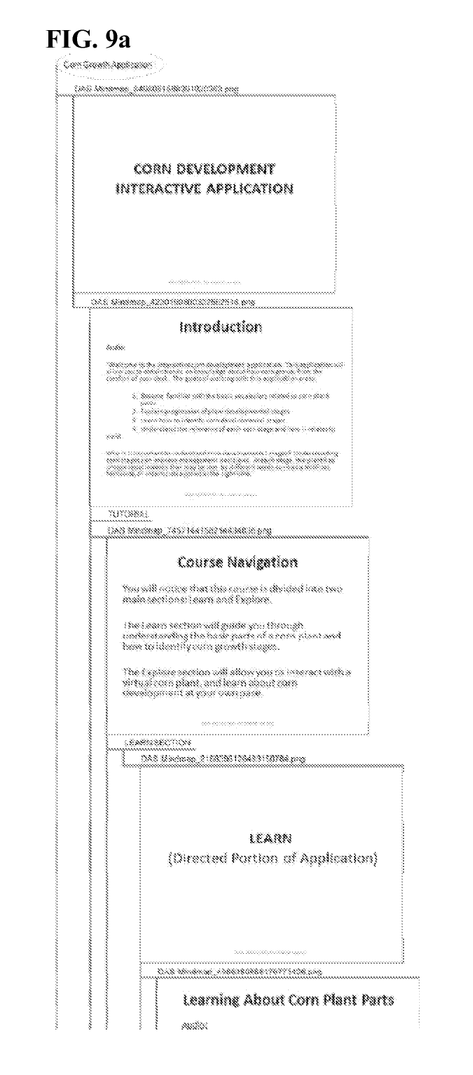

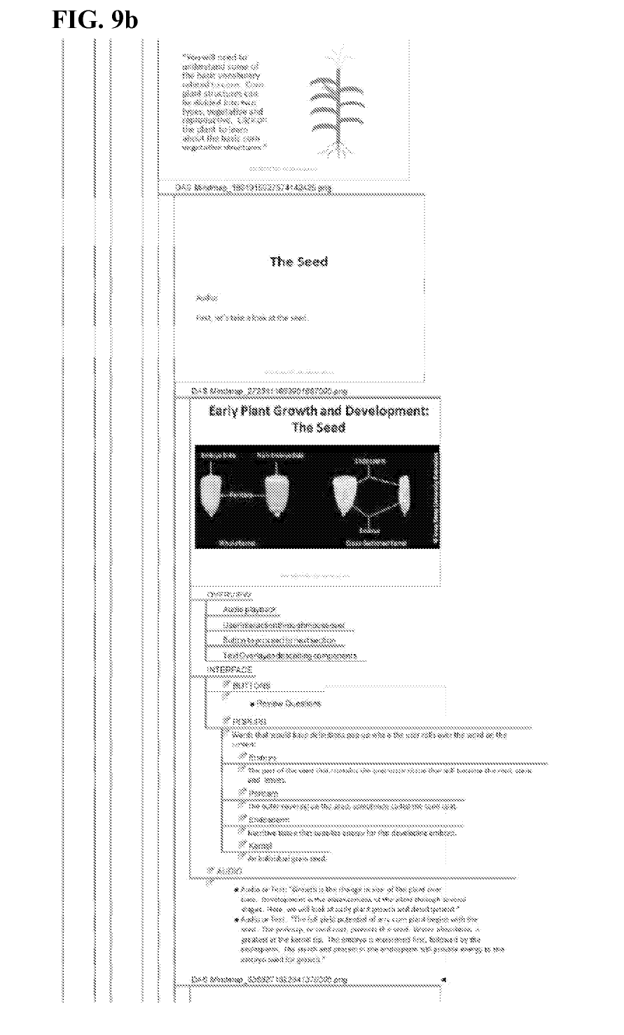

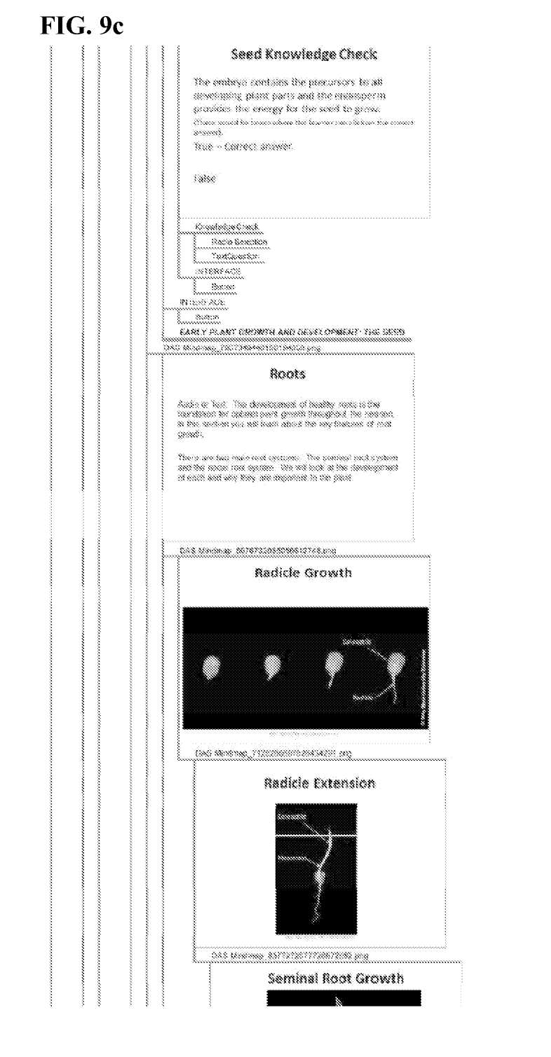

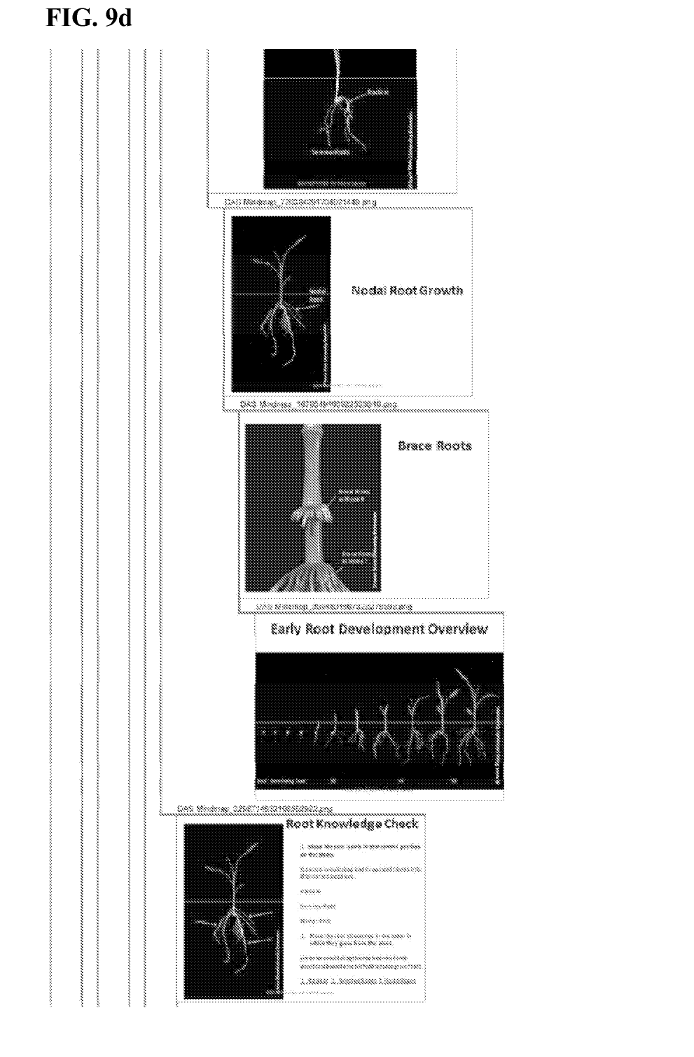

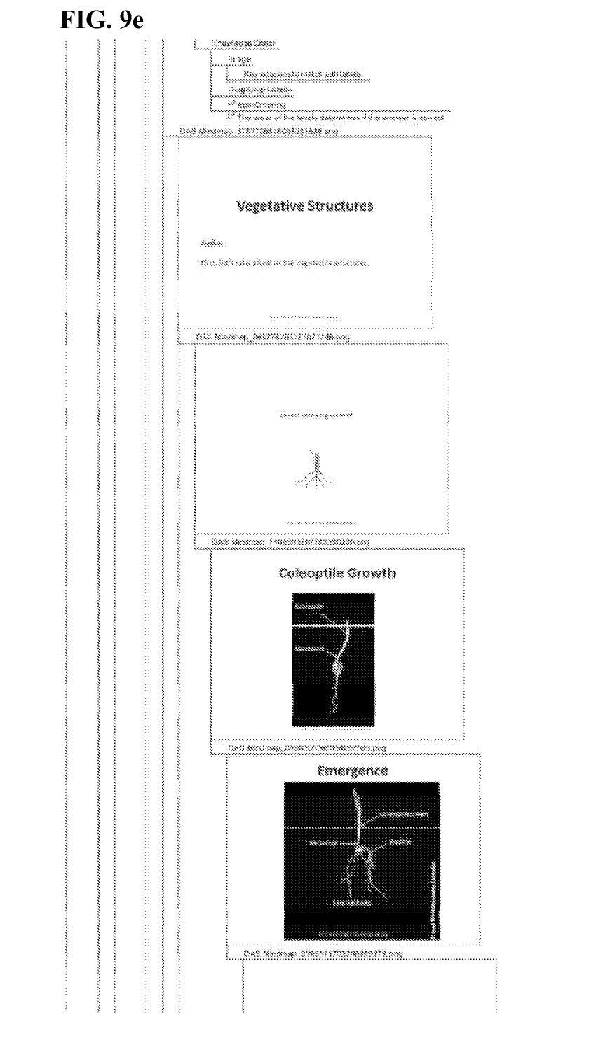

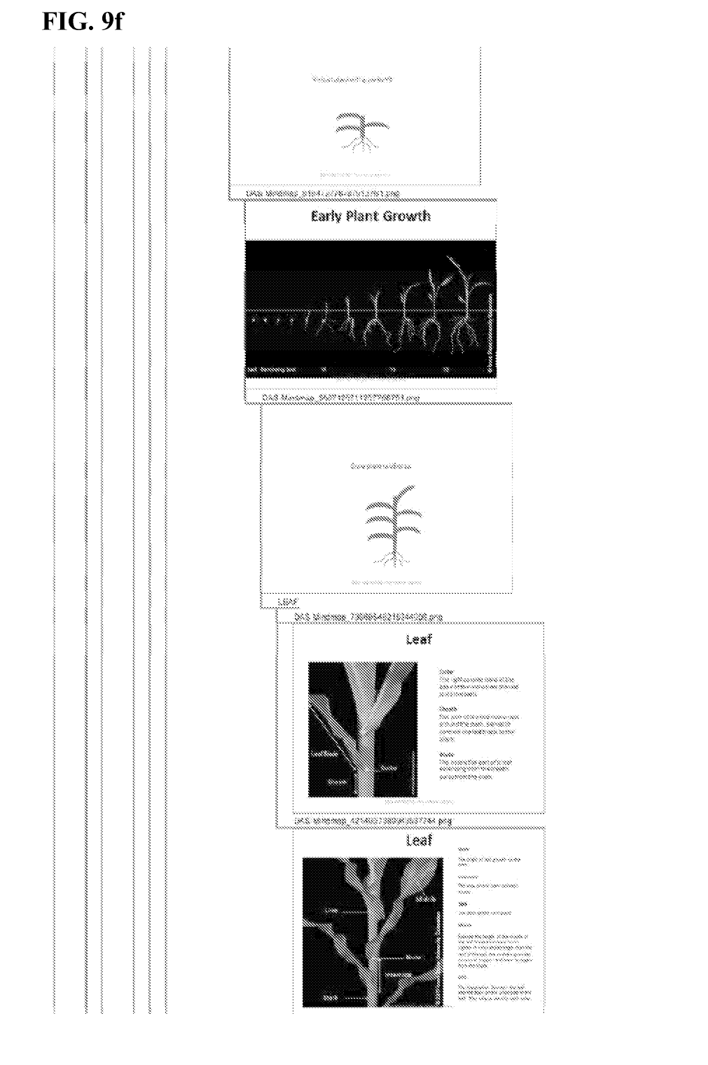

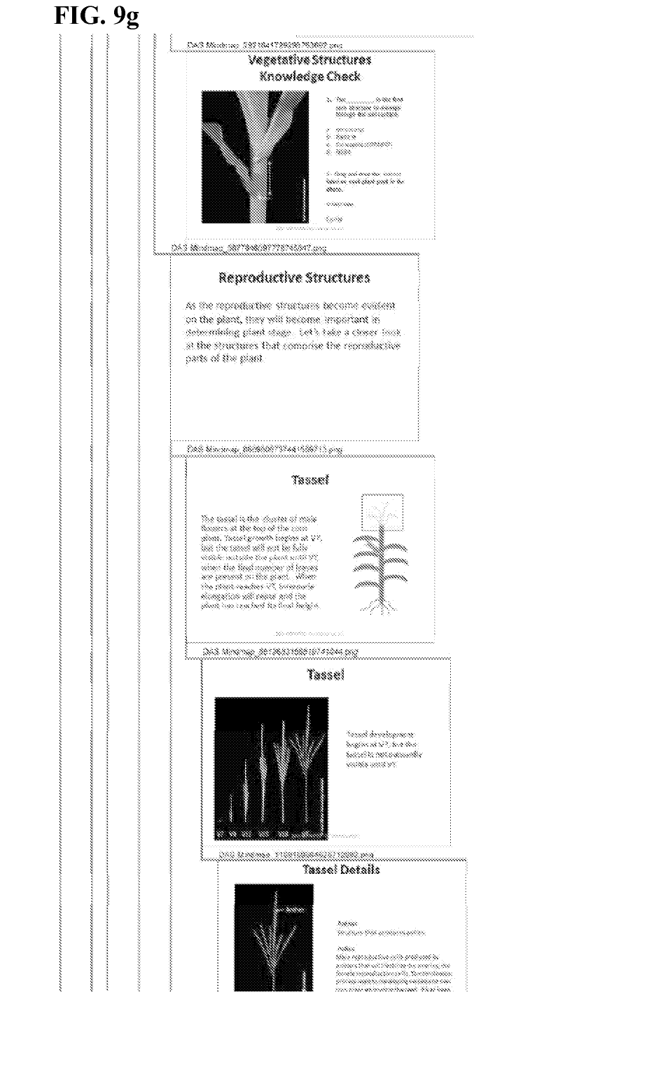

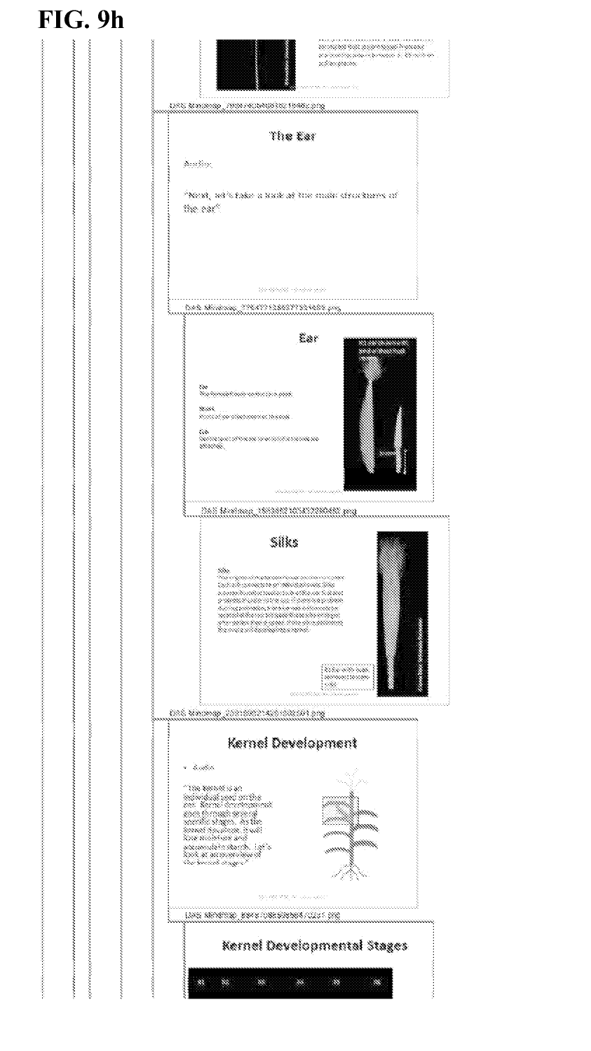

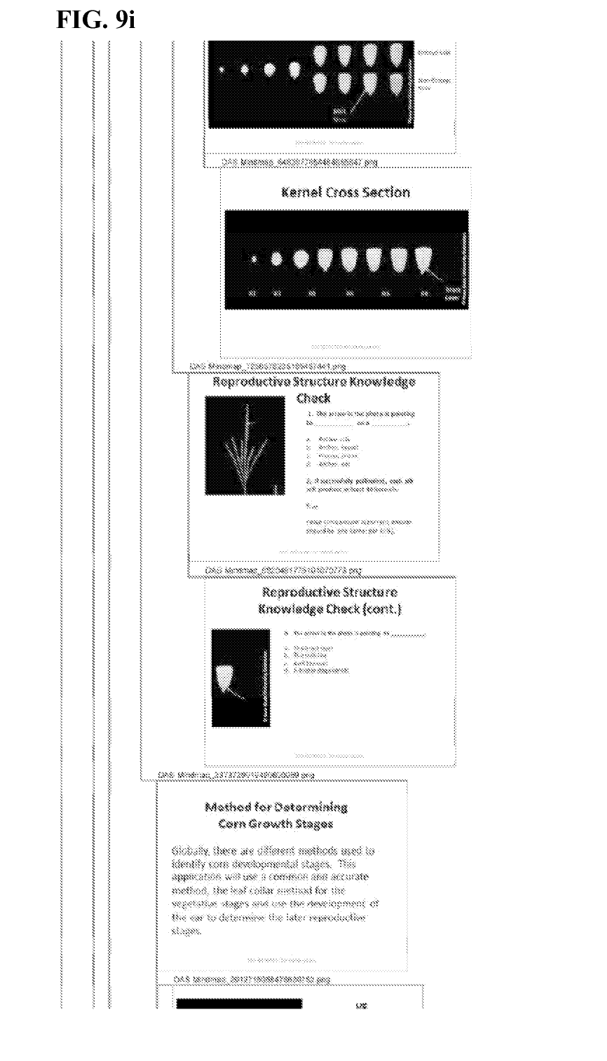

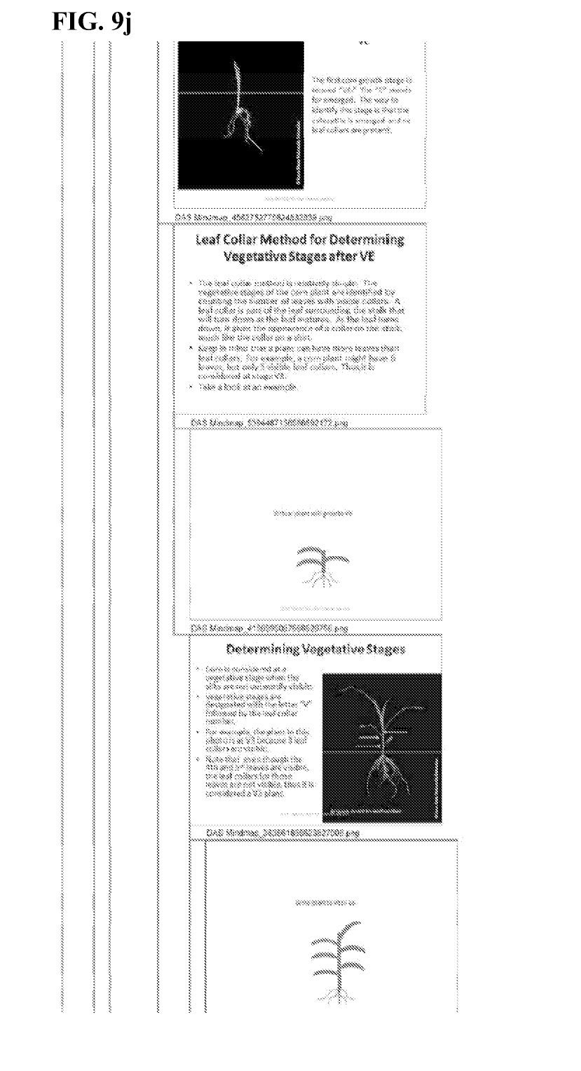

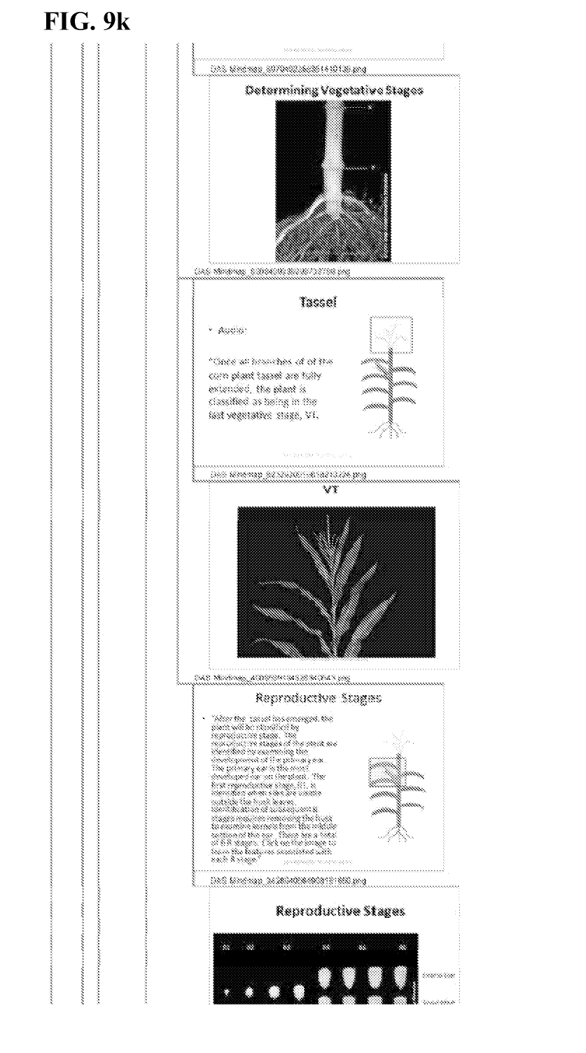

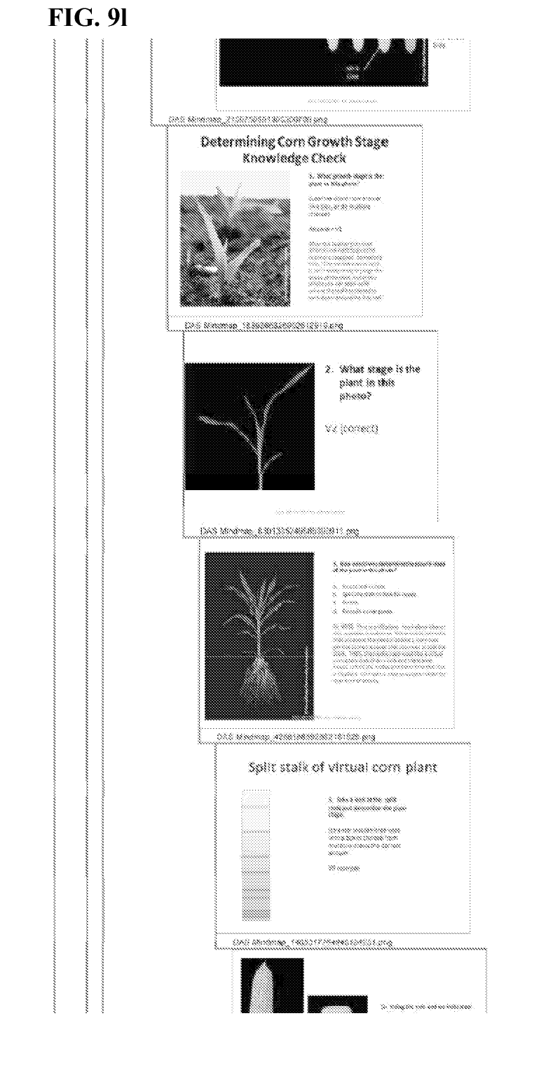

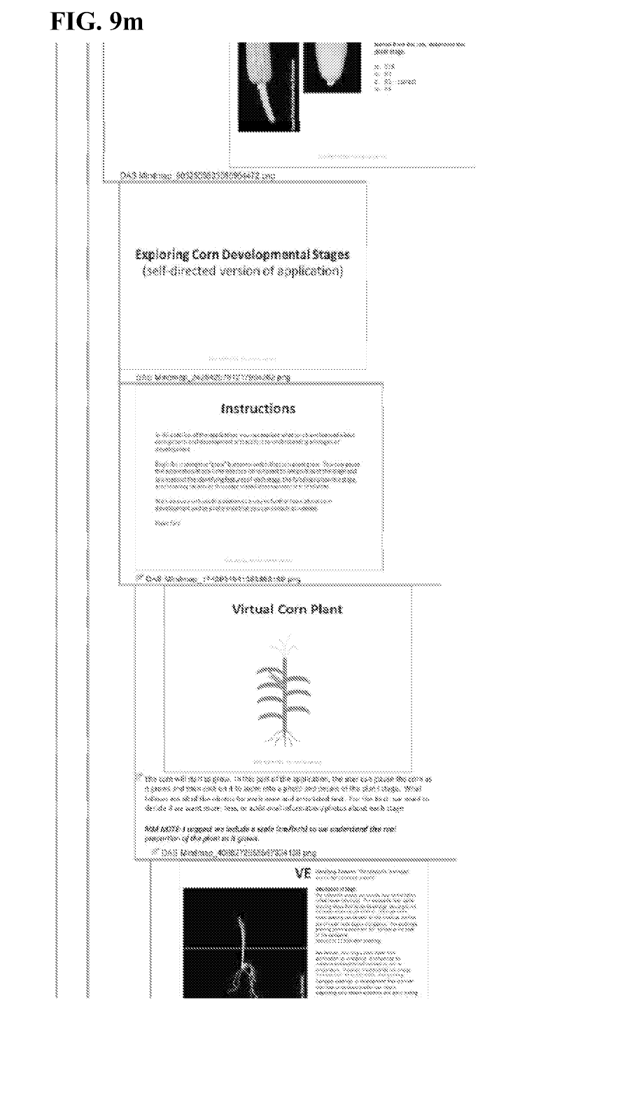

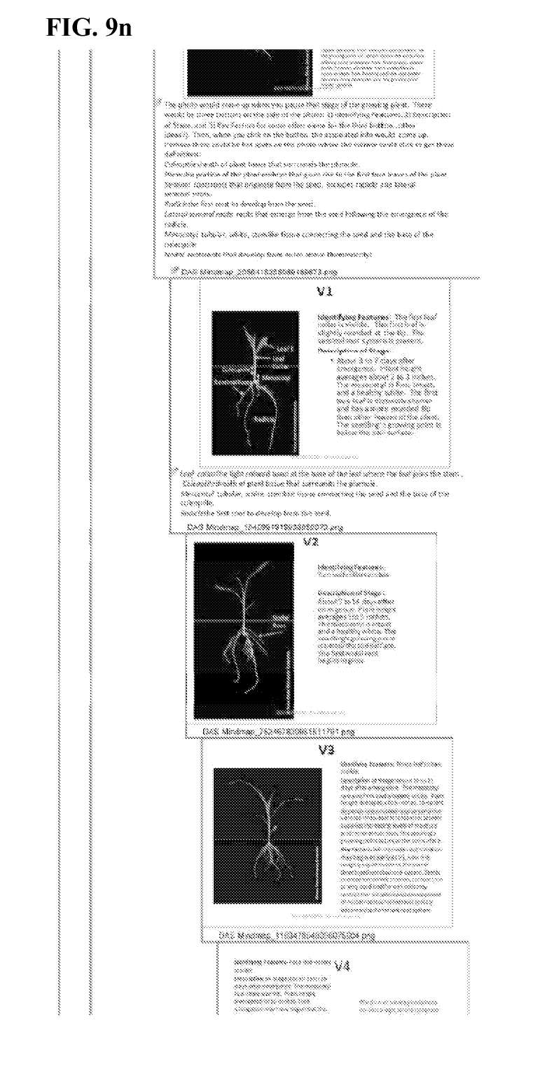

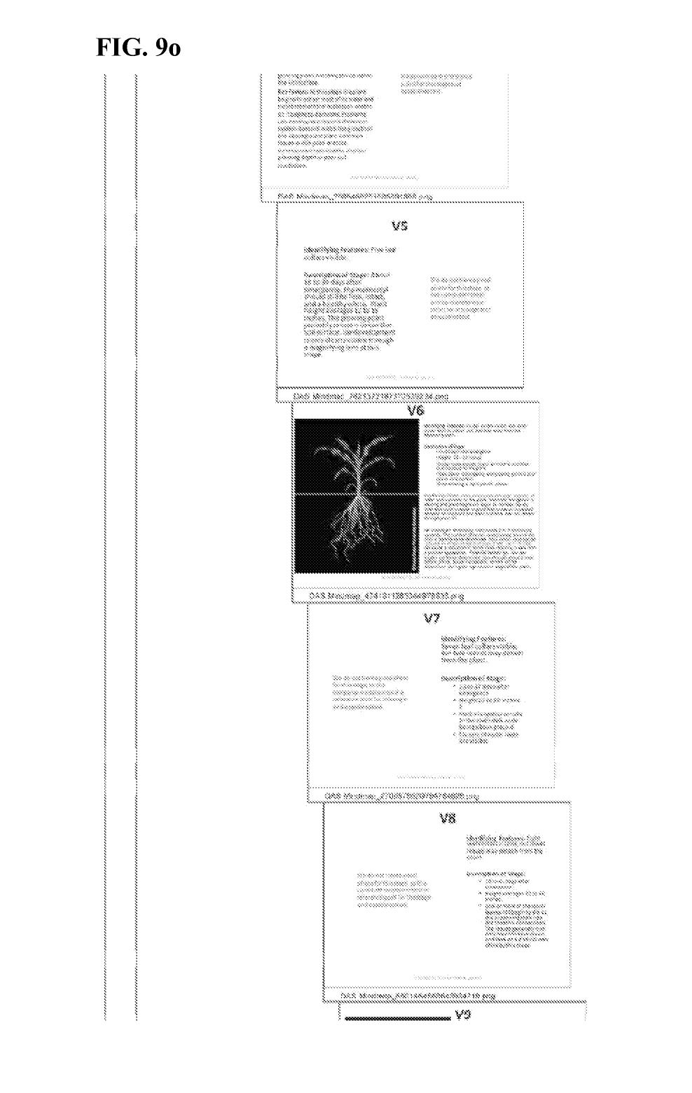

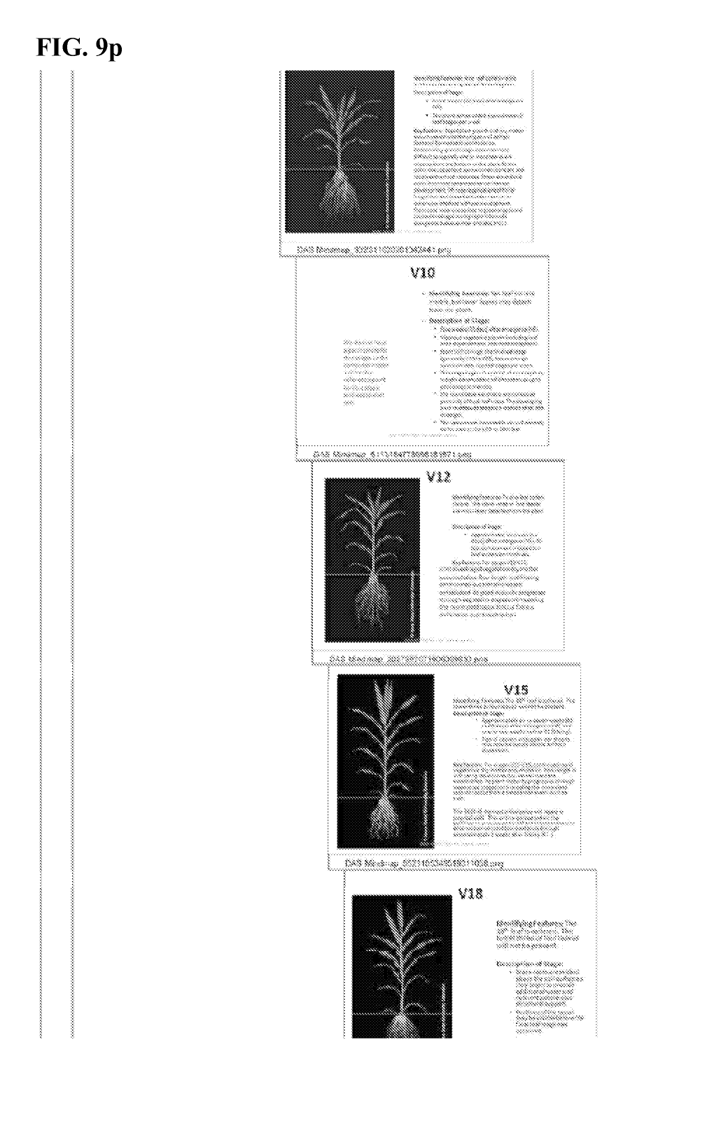

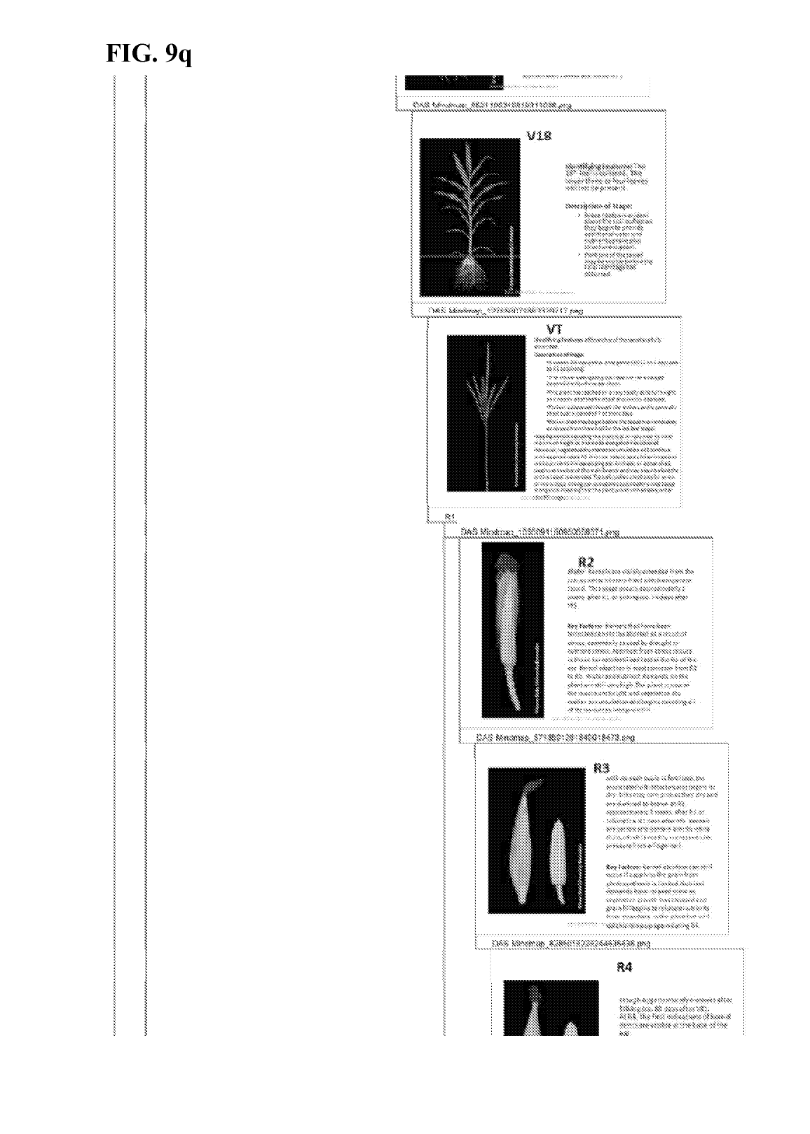

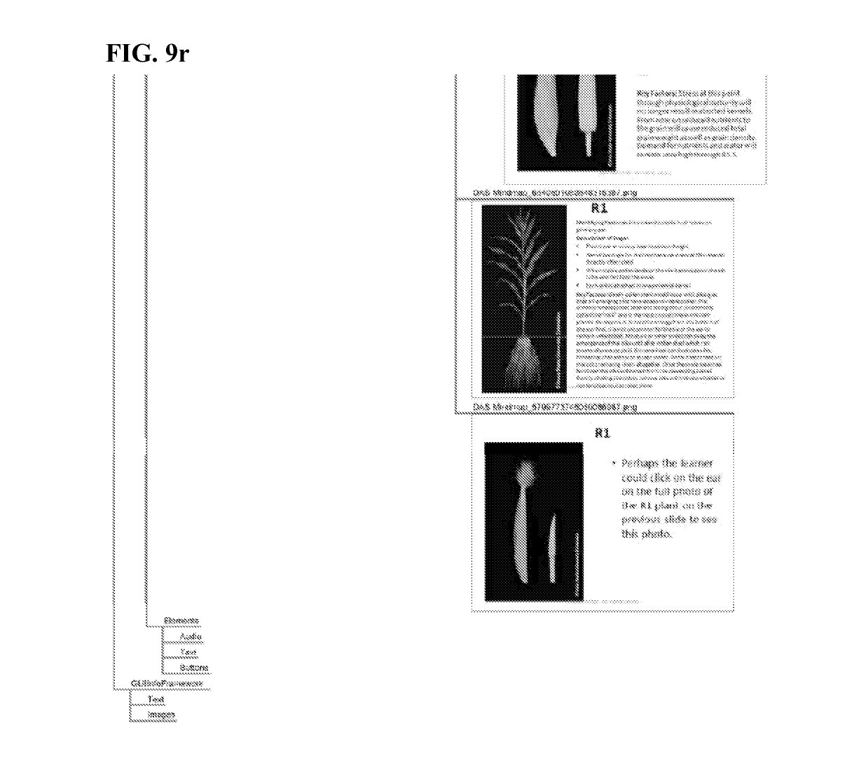

The graphical “mind map” provided in FIG. 9 is a linear format of specific information and images related to different sections of the learning module. The images are representative of the content of the different sections, but not the actual layout of the graphical user interface. The linear format of FIG. 9 does not represent the organization of the content as it was presented to users. Rather, the mind map provides an overview of how the content was structured for navigation, and how the content was arranged within each module.

The specific information and images for each module were extracted and placed in the mind map to visualize the flow of information within the Learning Module (Module 1) and the Exploratory Module (Module 2). After launching the program, users were presented with a screen where one of the two modules can be selected.

The Learning Module was comprised of a directed or guided learning experience for a user. This Module was mostly linear in flow (providing user selection of various sections), and the users were presented with informational content, along with knowledge checks (i.e., quizzes) throughout each section of the Module.

The Exploratory Module was a self-directed component of the program where users explored and interacted with the program interface to influence and generate representations of corn growth. Users selected a given stage of growth, and were immediately presented with additional multimedia information specific to that stage of growth. A representation of a plant could be viewed, and the growth could be shown as an anatomically correct virtual three-dimensional plant, animated over time. During the playback of the animation, users were presented with new information as different growth stages were approached. The content displayed was defined by the relationships mapped out in the mind map.

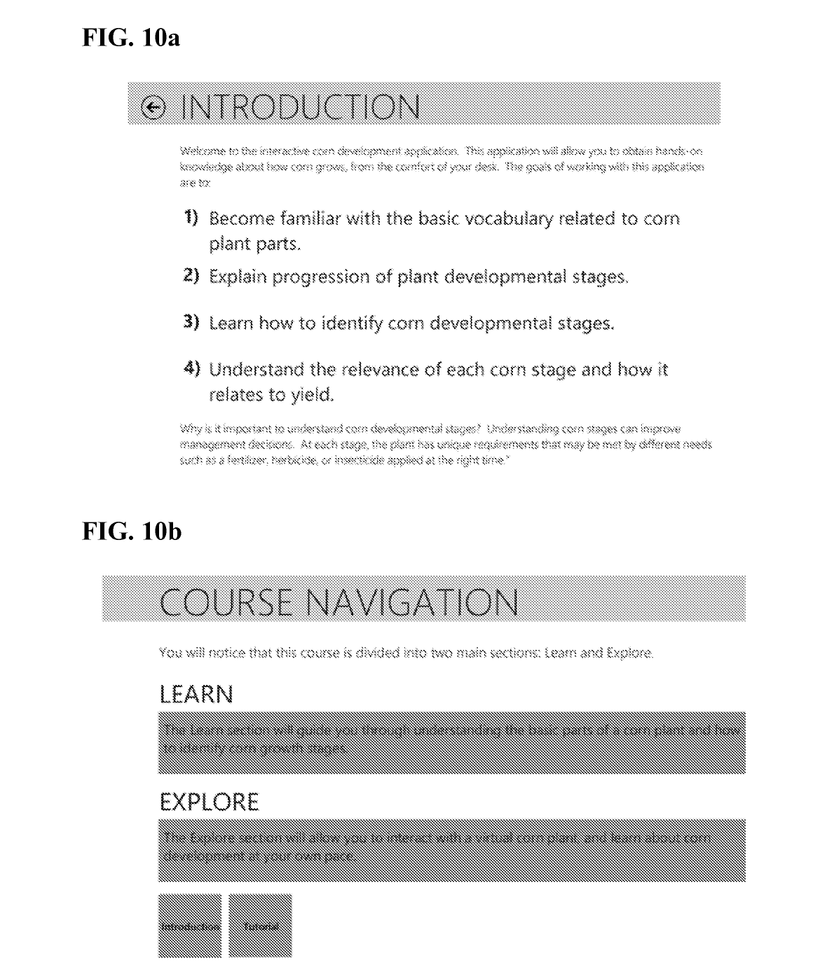

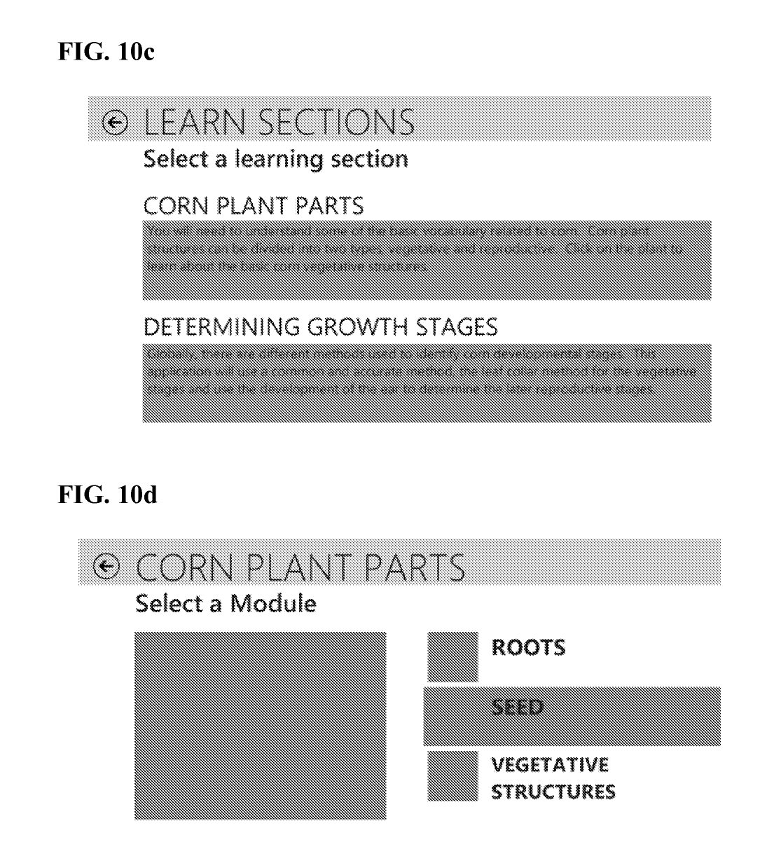

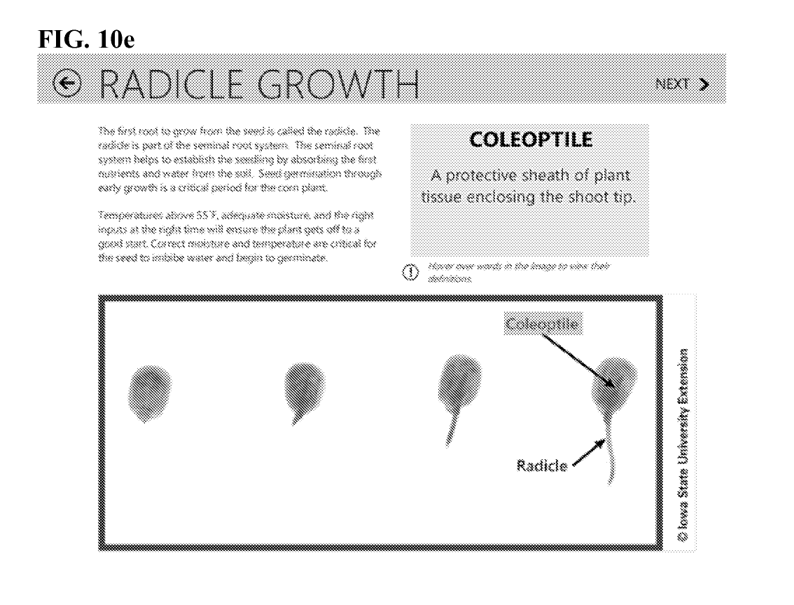

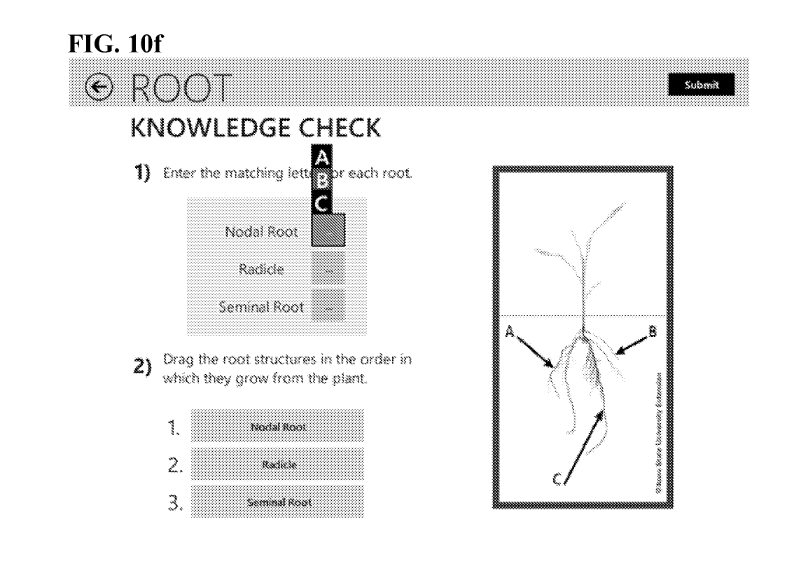

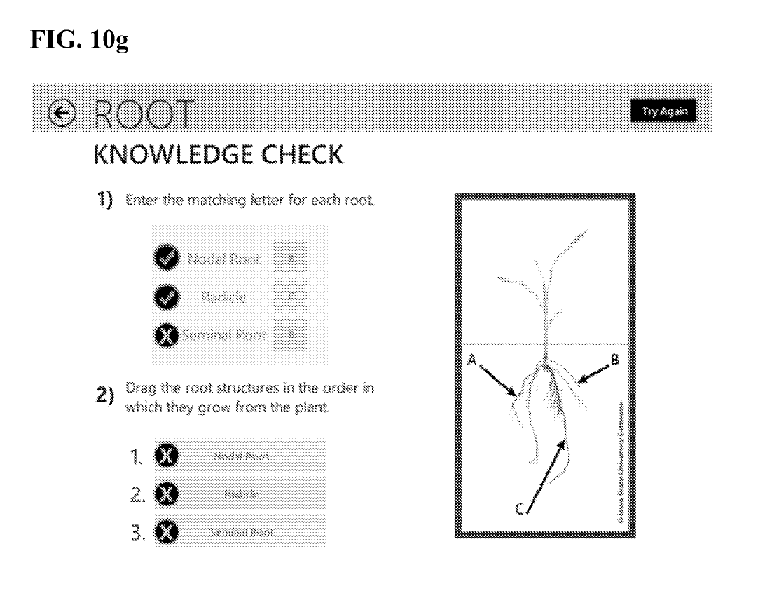

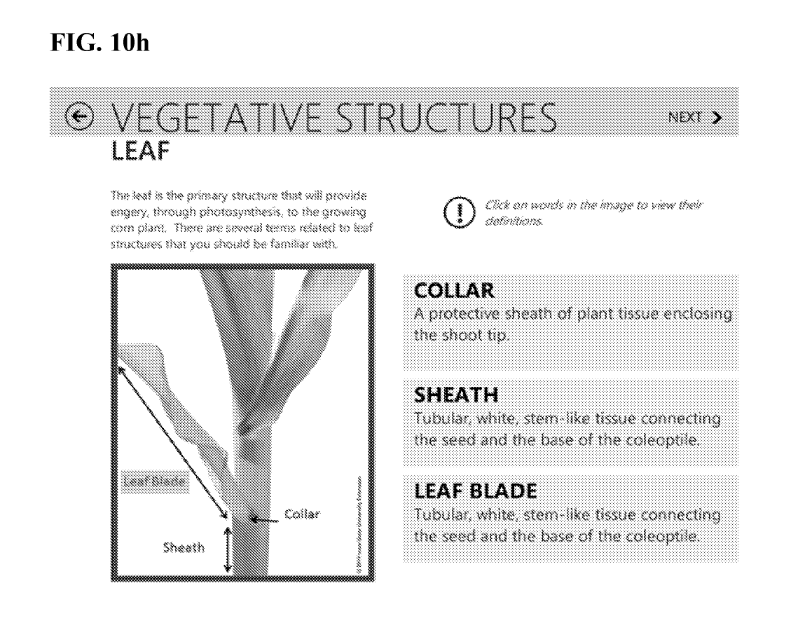

Screenshots of the user interface from different aspects of the educational program are provided in FIG. 10.

### Example 3

### Increasing Consumer Interest in a Plant

A potential consumer is provided with a computer interface that displays a computer animation representing a “growing” anatomically correct virtual three-dimensional maize plant. The computer animation program contains the functionality of allowing the user to focus on specific regions and/or structures on the plant animation, and to observe the animation from different distance perspectives.

Instructions appearing in the computer interface direct the potential consumer's attention to particular attributes of the animated maize plant. Beneficial aspects of the particular attributes may be communicated to the potential consumer through the user interface. The computer interface may be configured to display a plant animation of a second maize plant, such that anatomical differences or differences in growth characteristics between the two plants may be illustrated for the potential consumer.

By obtaining information about the animated maize plant in a manner that is easy to understand and directly comparable to the potential consumer's experience in growing maize plants and/or preparing and/or using products produced from maize plants, consumer interest in the animated maize plant is increased.

What is claimed is:

1. A system for representing plant growth, the system comprising:
a database comprising at least one growth parameter determined for a plant of interest;
a computer readable storage medium comprising the database;
analytical programming for predicting plant growth;
analytical programming for graphically representing the growth of the plant of interest in three-dimensions and over time; and
an interactive user interface that displays the three-dimensional graphical representation of the growth of the plant of interest over time.

2. The system of claim 1, wherein the plant of interest comprises at least one plant growth-related trait of interest.

3. The system of claim 2, wherein the plant growth-related trait of interest has an effect on the at least one growth parameter comprised in the database that is determined for the plant of interest.

4. The system of claim 1, wherein the at least one growth parameter determined for the plant of interest is determined by collecting growth data from the plant of interest.

5. The system of claim 1, wherein the analytical programming for predicting plant growth processes values entered into the database for each of the at least one growth parameter(s), wherein the analytical programming for graphically representing the growth of the plant of interest comprised an initialization program that is operably linked to at least one controller program that predicts the growth a particular component of the plant of interest.

6. The system of claim 1, wherein the plant of interest is an inbred plant variety.

7. The system of claim 1, wherein the plant of interest is selected from the species, Zea mays.

8. The system of claim 7, wherein one of the at least one growth parameter(s) determined for the plant of interest is selected from the group consisting of: the days after planting at which a specific growth stage occurs; stem diameter; rate of internode elongation; total days for which internode elongation occurs; final stem length; the day after planting at which a specific internode starts to elongate; the day after planting at which a specific internode stops elongating; the length at which a specific leaf starts growing; the length of a specific leaf sheath in relation to the specific internode that the sheath will cover; plant height; the day after planting at which a specific leaf collar is visible; growth of a plant silk; growth of a plant stalk; and growth of a plant leaf.

9. The system of claim 8, wherein one of the at least one growth parameter(s) determined for the plant of interest is selected from the group consisting of: the number of leaves that should be visible at a particular time; the specific time at which a particular leaf emerges and becomes visible; the specific time at which a particular internode elongates; the specific time at which a particular leaf wilts; the length of a leaf upon its initial visibility; and the length of a leaf when it is fully mature.

10. The system of claim 7, wherein the analytical programming predicts attributes of a plant internode, a plant ear, a plant leaf, a plant seed, a plant root, and a plant tassel.

11. The system of claim 1, wherein the plant of interest is a genetically modified plant.

12. The system of claim 1, wherein the system comprises:
at least one additional parameter comprised in a database, wherein the additional parameter corresponds to an effect of an environmental factor on one of the at least one growth parameter(s) determined for the plant of interest,
wherein the three-dimensional graphical representation reflects the growth of the plant of interest over time in the presence of the environmental factor.

13. The system of claim 12, wherein the environmental factor is selected from the group consisting of an herbicide, a pesticide, weed infiltration, heat, cold, drought, excessive water, low light, high salt, and low salt.

14. The system of claim 1, wherein the system comprises at least one database-comprised growth parameter determined for a second plant of interest, wherein the interactive user interface displays a three-dimensional graphical representation of the growth of the second plant of interest over time.

15. The system of claim 14, wherein the first plant of interest comprises at least one plant growth-related trait of interest, wherein the plant growth-related trait of interest has an effect on the at least one growth parameter comprised in the database that is determined for the first plant of interest, and wherein the second plant of interest comprises an allelic variant of the plant growth-related trait of interest.

16. The system of claim 15, wherein the interactive user interface is configured such that the three-dimensional graphical representations of the growth of the first and second plants of interest over time illustrate for the user the effect of the plant growth-related trait of interest on plant growth as compared to the effect of the allelic variant.

17. The system of claim 15, wherein the system comprises at least one additional parameter comprised in a database, wherein the additional parameter corresponds to an effect of an environmental factor on the at least one growth parameter affected by the plant growth-related trait of interest, and wherein the three-dimensional graphical representations of the growth of the first and second plants of interest over time are configured to illustrate for the user the growth of the first and second plant of interest over time in the presence of the environmental factor.

18. The system of claim 17, wherein the three-dimensional graphical representations of the growth of the first and second plants of interest over time are configured to illustrate for the user an agriculturally significant difference between the growth of the first and second plant of interest over time in the presence of the environmental factor.

19. The system of claim 17, wherein the plant growth-related trait of interest is selected from the group consisting of herbicide tolerance, pesticide tolerance, weed tolerance, heat tolerance, cold tolerance, drought tolerance, excessive water tolerance, low light tolerance, high salt tolerance, and low salt tolerance.

20. The system of claim 17, wherein the second plant of interest comprises an allelic variant of the plant growth-related trait of interest.

21. A method of increasing consumer interest in a plant or plant product, the method comprising:
providing the system of claim 1; and
utilizing the three-dimensional graphical representation to describe at least one favorable growth characteristic of the plant of interest to a consumer,
thereby increasing consumer interest in the plant of interest or a plant product produced from the plant of interest.

22. A method of increasing consumer interest in a plant or plant product, the method comprising:
providing the system of claim 14; and
utilizing the three-dimensional graphical representation to describe at least one favorable growth characteristic of the first plant of interest to a consumer,
wherein describing at least one favorable growth characteristic of the first plant of interest to the consumer comprises comparing the representations of the growth of the first and second plants of interest.

23. A method for predicting growth of a plant of interest in a season-independent manner, the method comprising:
providing the system of claim 1;
inputting a value for each of the at least one growth parameter(s) into the database, wherein the value(s) have been determined for the plant of interest; and
generating the display of the three-dimensional graphical representation of the growth of the plant of interest over time, thereby predicting the growth of the plant of interest in a season-independent manner.

24. A system for representing plant growth, the system comprising:
a database comprising at least one growth parameter determined for a plant of interest;
a computer readable storage medium comprising the database;
means for predicting plant growth;
analytical programming for graphically representing the plant growth in three-dimensions and over time; and
an interactive user interface that displays the three-dimensional graphical representation of plant growth over time.

25. The system of claim 24, wherein the system comprises:
at least one additional parameter comprised in a database, wherein the additional parameter corresponds to an effect of an environmental factor on one of the at least one growth parameter(s) determined for the plant of interest,
wherein the three-dimensional graphical representation reflects the growth of the plant of interest over time in the presence of the environmental factor.
